(19) United States
(12) Patent Application Publication
(10) Pub. No.: US 2025/0121528 A1
(43) Pub. Date: Apr. 17, 2025

(54) BAMBOO ELEMENTS AS LOAD-BEARING COMPONENTS AND T-BEAM ELEMENT AS CEILING ELEMENT, AND METHOD FOR PRODUCING A BAMBOO BLANK

(71) Applicant: CLB ENTWICKLUNGSGESELLSCHAFT MBH, Leipzig (DE)

(72) Inventor: Harry KNOLL, Berlin (DE)

(73) Assignee: CLB ENTWICKLUNGSGESELLSCHAFT MBH, Leipzig (DE)

(21) Appl. No.: 18/708,404

(22) PCT Filed: Nov. 8, 2022
(86) PCT No.: PCT/EP2022/081062

§ 371 Date: May 8, 2024

(30) Foreign Application Priority Data
Nov. 8, 2021 (DE) 20 2021 106 086.7
Sep. 8, 2022 (DE) 10 2022 003 301.1

(51) Int. Cl. B27J 1/00; B27M 3/00

(52) U.S. Cl. CPC B27J 1/003; B27M 3/0086

(57) ABSTRACT

The invention relates to a bamboo blank, particularly to produce load-bearing structural elements, characterized in that the bamboo blank comprises a plurality of bamboo lamellae arranged parallel to each other and bonded together by an adhesive, wherein the material for the bamboo lamellae originates from a giant bamboo species, the bamboo lamellae are pressed and bonded together by a pressure of 0.05-1.5 N/mm², and the bamboo lamellae have a thickness of at least 5 mm. Furthermore, the invention relates to a bamboo rod, a bamboo layer, a laminated timber element, a sandwich element, and a ceiling or wall element. The invention additionally relates to a method for producing a claimed bamboo blank, bamboo rod, bamboo layer, laminated timber beam, cross-laminated timber element, sandwich element, ceiling element, and/or wall element, combination beam, T-beam, I-beam, and ceiling elements with T-beams and/or I-beams.

The invention relates to bonded bamboo elements. The bamboo elements comprise bamboo blanks, bamboo rods as well as single-layer bamboo layers, multi-layer cross-laminated timber elements, wall, ceiling, and roof elements. The bamboo blanks can be processed by gluing into posts (for example T-posts), beams, and panels of any size. The bamboo elements according to the invention can be used as load-bearing components or as parts of load-bearing components, preferably for the construction of sustainable structures.

BACKGROUND AND PRIOR ART The use of bonded wood elements as load-bearing components in construction as a more ecological alternative to steel or concrete is known. Glued laminated timber (glulam), solid structural timber (SST), and cross-laminated timber (CLT) are examples of such elements.

In addition to glulam and SST, CLT panels have established themselves as a new construction method in timber construction over the past 20 years. Cross-laminated timber (CLT), also known as BSP or X-Lam, is a solid wood panel consisting of at least three layers of sawn timber typically glued together at right angles to each other, with the individual pieces of sawn timber being able to be arranged longitudinally with or without planned lateral spacing from each other along their narrow sides. CLT is currently exclusively made from softwood. Individual layers may also be replaced by wood-based materials such as OSB, insulation foams, and laminated veneer lumber. Due to the crosswise construction, CLT elements are both very dimensionally stable and capable of transferring loads both lengthwise and transversely to the main load direction. CLT was developed in Austria and Germany in the early 1990s and has been used in Europe since the 2000s.

The bonding of CLT elements, as well as GLT and SST, typically occurs using a MUF adhesive. The advantage of this adhesive lies in its fast-curing time and transparent adhesive joints, which are important for visual appearance.

CLT products have gained significance in modern timber construction since the 1990s. They are used as load-bearing components in residential construction as well as in municipal and commercial construction. Cross-laminated timber can be used not only for the construction of exterior and interior walls, roof and ceiling elements, but also for staircases and balcony ceilings. CLT panels are assembled on-site at the construction site or can be used to produce prefabricated components. Insulation, cladding, furniture, and facade elements can be easily attached to cross-laminated timber. Due to its significantly higher stiffness compared to lightweight or frame construction, the number and length of stiffening wall elements can be reduced. In comparison to lightweight timber constructions, where fire protection is achieved through cladding, CLT panels can achieve fire resistance class F90 (“fire-resistant”) without additional fire protection panels.

Similarly, the bamboo industry has experienced dynamic growth for 20 years, especially in Asia and South America. Bamboo as a building material can drive sustainable development in the construction industry. Giant bamboo grows very quickly and due to its high density can store at least double the amount of CO₂ as spruce, thus making an important contribution to combating climate change. Bamboo products have good mechanical properties, including tensile and flexural strength along the fiber direction, and can effectively replace more emission-intensive materials such as cement, steel, and plastic.

So far, bamboo products are known for use as bamboo flooring or scaffolding in construction. Other known applications of bamboo products include interior design, furniture making, or decorative panels. However, such products are not suitable for use in building constructions, especially as load-bearing components, as they do not meet the high requirements for strength, size, and load-bearing capacity until now.

It is known that the properties of wood products can be improved by bonding layers together. Currently used adhesives in the wood industry include aminoplast resins (urea-formaldehyde [UF], melamine-formaldehyde [MF], melamine-urea-formaldehyde [MUF]resins) and phenolic resins (phenol-formaldehyde [PF]and tannin-formaldehyde resins).

Formaldehyde-based adhesives are extremely cost-effective and thus economically suitable for the wood industry. In Germany, approximately 0.75 million tons of adhesive are used annually to produce wood-based materials, of which over 95% are formaldehyde-based aminoplast resins. However, the main problem with commercial adhesives is formaldehyde emissions. Formaldehyde was classified as carcinogenic (category 1B) and mutagenic (category 2) in the EU in 2014 [Regulation 605/2014 on the classification, labeling, and packaging of substances].

Furthermore, insulation of building components is becoming increasingly important to reduce long-term energy consumption of buildings and decrease their CO₂ footprint. These insulation materials are usually non-renewable and often cannot be biodegraded. Therefore, the challenge is to provide building components that leave a low CO₂ footprint during their production and improve the energy efficiency of buildings through their insulation properties. Furthermore, it is desirable for the manufacturing and dismantling process of a building component to avoid formaldehyde emissions.

### OBJECT OF THE INVENTION

The object of the invention is to provide load-bearing components made from renewable raw materials, without the disadvantages of the prior art.

In particular, it was an object of the invention to provide bamboo elements for use as load-bearing components, which are obtained from very rapidly renewable raw materials. Another object of the invention was to provide bamboo elements with sufficient dimensions and material properties for use in construction.

In particular, it was an object of the invention to provide bamboo blanks from which bamboo rods and bamboo layers can be made. Furthermore, it was an object of the invention to provide bamboo rods, bamboo layers, and cross-laminated timber panels. Another object of the invention was to provide more complex ceiling, wall, and roof elements in the form of beams, posts, ribbed panels, hollow core ceilings, ribbed ceilings, ribbed wall elements, trusses for roofs, T-posts, and H-posts.

Another object of the invention was to combine bamboo elements with softwood or hardwood elements into structural elements. Another object was to connect bamboo panels with other elements such as insulation foams and preferably statically set the composite (“sandwich element”).

Another object of the invention was to provide a method for the production of the aforementioned bamboo elements. Furthermore, it was an object of the invention to manufacture the mentioned bamboo elements from as controlled and quality-assured materials as possible with minimal environmental impact.

### SUMMARY OF THE INVENTION

The problem is solved by the features of the independent claims. Advantageous embodiments of the invention are disclosed in the dependent claims and in the description.

In a first aspect, the invention relates to a bamboo blank, particularly for the creation of load-bearing structural elements. The bamboo blank comprises a plurality of bamboo lamellae arranged fiber-parallel next to each other and bonded together with an adhesive. The bamboo lamellae are pressed and bonded together by a pressing pressure of 0.05-1.5 N/mm². The bamboo lamellae also have a thickness of at least 5 mm.

It was completely surprising that by compressing the bamboo lamellae at a pressure of 0.05-1.5 N/mm², the resulting blank exhibited very high strength and durability. Despite the pressure, damage to the bamboo fibers was avoided, thereby preserving the natural strength of the material.

Thus, the blank could withstand forces and weathering that could lead to failure of a component comprising the bamboo blanks.

Surprisingly, it was also found that compressing the bamboo lamellae at 0.05-1.5 N/mm² led to a lower susceptibility of the bamboo blank to insect attacks. Without being bound to any theory, it is suspected that this pressing pressure led to a high absorption of the adhesive into the fibers of the bamboo lamellae. Since the materials of the adhesive tend to be insect-repellent, this resulted in a lower number of insect attacks on the bamboo lamellae.

By using bamboo lamellae with a thickness of at least 5 mm, the natural strength of the bamboo could be utilized, and a more natural product with a surprisingly low amount of adhesives could be produced. With a thickness of at least 5 mm, the bamboo lamellae could also be particularly uniformly dimensionally stable, straight, perpendicular, and stable in shape.

This reduces the proportion of non-bamboo materials in the blank, thereby increasing the environmental friendliness of the blank and other products. The environmental impact during the production of the bamboo blank, for example, through the release of volatile organic components during the application of the adhesive, could surprisingly be minimized. The lower amount of non-bamboo materials required also means, for example, that the bamboo blank is essentially fully biodegradable without complex separation processes for recycling/disposing of its various components being required.

By using uniformly dimensionally stable, straight, perpendicular, and shape-stable bamboo lamellae with a thickness of at least 5 mm, the number and strength of the adhesive joints in the bamboo blank could also be minimized. The resulting bamboo blanks were therefore particularly strong.

Due to the sufficient thickness of the bamboo lamellae, the bamboo blank only had to comprise a few layers of bamboo lamellae to be strong enough for cutting, calibrating, grinding, transportation, and/or further processing into other bamboo elements. The bamboo blank was therefore surprisingly easy to handle. Due to their simple handling, the bamboo blanks could be easily smoothed and processed to create flush surfaces. The need for multiple thinner layers that could potentially separate from each other during further processing was eliminated. Additionally, the bamboo blanks with bamboo lamellae of at least 5 mm thickness were surprisingly impervious to water and invulnerable to mold. Due to the thick, uninterrupted material sections of the bamboo blanks, the bamboo blanks were very uniform, with the continuous fiber increasing their strength. Since they could also be processed to a very smooth surface quality, the number of surface defects where fungal and mold spores or insects could settle was reduced. The lifespan of the bamboo blanks was extended as a result.

Additionally, it was found that bamboo blanks with bamboo lamellae with a thickness of at least 5 mm surprisingly discolored much slower than bamboo blanks formed from thinner pieces of bamboo material. Wood discoloration often occurs due to exposure to UV light and air pollution.

Without being bound to any theory, it is speculated that the use of bamboo lamellae with a thickness of at least 5 mm limited the absorption capacity of the bamboo blanks, so that fewer gaseous pollutants could be absorbed. Since a surprisingly good surface quality could be achieved with a thickness of 5 mm, there was also a lower surface area for degradation by UV light.

Aesthetic deterioration of the bamboo blanks over time could be significantly reduced compared to other natural building products. Additionally, the bamboo blank with bamboo lamellae of at least 5 mm thickness was visually very appealing as it made the uninterrupted natural fiber patterns of the bamboo lamellae visible.

When bamboo lamellae of at least 5 mm thickness were bonded at a pressure of 0.05-1.5 N/mm², the bamboo blank obtained an increased density and any air gaps and voids could be eliminated. In combination with the lower proportion of adhesive, which could contain flammable organic components, the resulting bamboo blank had surprisingly improved fire resistance compared to bamboo blanks that did not combine these features.

By combining bamboo lamellae with a thickness of at least 5 mm and bonding under a pressure of 0.05-1.5 N/mm², the resulting bamboo blanks achieved surprisingly good modulus of elasticity. This means that the modulus of elasticity was low enough for the bamboo blanks not to be brittle and break easily, but also high enough to support high loads without buckling. With the achieved moduli of elasticity, the bamboo lamellae were particularly suitable for use in building products.

In a preferred embodiment of the invention, the bamboo lamellae are steamed and preferably dried before being bonded together. Steaming at a temperature between 70-200° C. is particularly preferred. A surprisingly high durability of the bamboo lamellae against insect and fungal infestation could be achieved by the steaming process (preferably at 70° C.-200° C.) and subsequent drying of the bamboo lamellae. The steaming process resulted in very straight, parallel bamboo lamellae that do not need to be impregnated with environmentally harmful substances.

The material for the bamboo lamellae comes from a giant bamboo species. At least the following species are considered giant bamboo for the purposes of the invention: Bambusa balcooa, Bambusa bambos, Bambusa spinosa, Bambusa blumeana, Bambusa polymorpha, Bambusa textilis, Bambusa tulda, Bambusa vulgaris, Cephalostachyum pergracile, Dendrocalamus asper, Dendrocalamus giganteus, Dendrocalamus latiflorus, Dendrocalamus barbatua, Dendrocalamus brandisii, Dendrocalamus strictus, Dendrocalamus sinicus, Dendrocalamus dianxiensis, Dendrocalamus hamiltonii, Dendrocalamus hookeri, Dendrocalamus sikkimensis, Dendrocalamus xishuangbannaensis, Gigantochloa apus, Gigantochloa levis, Gigantochloa pruriens, Gigantochloa pseudoarundinacea, Guadua angustifolia, Guadua aculeata, Guadua amplexifolia, Guadua superba, Melocanna baccifera, Ochlandra sps., Phyllostachys edulis, Thyrsostachys siamensis, Phyllostachys bambusoides, and Phyllostachys aurea.

The use of Dendrocalamus asper, Phyllostachys edulis (also known as “Moso bamboo”), Dendrocalamus giganteus, and/or Guadua angustifolia (also known as “Guadua”) may be particularly preferred. Even more preferred is the use of Phyllostachys edulis. The giant bamboo species Phyllostachys edulis grows, among other places, in the temperate climate zone and is frost-resistant. Giant bamboo differs from ordinary bamboo in that giant bamboo can reach sizes of up to 40 meters with stem diameters of up to 35 cm. The natural length, physical properties, and splitability of the raw harvested bamboo canes allow for the construction of longer rods (for example, 1-3 m in length) from bamboo lamellae without interruptions or weak points. The lamellae already exhibit high natural strength, making them suitable for construction purposes. By gluing them under high pressure first into blanks, then into rods, layers, and panels, various dimensions and formats for construction are possible.

During the growth phase, the daily length growth of giant bamboo can reach up to 70 cm/day. Giant bamboo species are mainly found in the tropics and subtropics. Due to the short period of three to five years between planting and harvesting, giant bamboo plantations have the potential to provide very cost-effective, CO2-saving, and CO2-storing raw materials to produce building materials. After 3 to 5 years of growth, the lignification process in the bamboo plant is sufficiently completed that the bamboo culms have achieved a strength and elasticity that allows them to be harvested and processed into building materials.

The increasing lignification of giant bamboo occurs only after the growth phase is complete when the bamboo has reached its final height and culm diameter. Most of the growth in giant bamboo occurs within the first year. After that, the lignification process takes place. After the lignification process is largely completed, giant bamboo is ready for harvest and further processing. This happens as early as 3-10 years. Bamboo with completed lignification is tough and hard. It possesses technical properties like those of domestic and tropical hardwoods. One speaks of a tensile strength that comes close to that of steel. It is advantageous according to the invention that bamboo is not a woody plant but rather a grass that lignifies.

In preferred embodiments of the invention, the material for the bamboo lamellae comes from the first 7-10 meters of the bamboo culms. This means that the bamboo lamellae are preferably made from the 7-10 meters of bamboo that are closest to the ground. This is because bamboo culms have a conical shape along their entire length. Furthermore, the thickness of the walls of the bamboo culms and the number of nodes vary along their length. Surprisingly, it was found that the first 7-10 meters of bamboo culms from the ground were not only nearly cylindrical but also had sufficient wall thickness to harvest bamboo lamellae with adequate strength. Additionally, the bamboo lamellae harvested from this section were more continuous and consistent in their material properties.

It is preferred that the bamboo used originates from a specific geographical region. Preferably, only one species of bamboo is used in a single bamboo element.

Preferably, Dendrocalamus asper from the state of Sao Paulo, Brazil, is used. The fact that this species of bamboo from this region grows very quickly and abundantly (height, diameter, wall thickness) supports local ecosystems and improves the ecological impact of the product. Due to the climate and soil conditions, the bamboos in this region grow rapidly to large dimensions, enabling the harvest of advantageously thick and long bamboo lamellae. Once the cultivation region and/or species of bamboo change, reapproval is necessary.

Construction timber from giant bamboo achieves a significantly higher Brinell hardness (9.5 kg/mm²) than oak, whose growth phase until harvest takes about 120 years. The timber from giant bamboo is therefore not only stronger but can reach all standard formats and dimensions in timber construction through gluing and high pressure.

A bamboo lamella is preferably manufactured from a bamboo raw lamellae through a calibration and/or surface improvement process. A calibration process may, for example, be a pre-planing or planing process (also referred to as “finish planing” within the scope of the invention).

Within the scope of the invention, a bamboo raw lamellae is preferably split as an uninterrupted part from a bamboo plant and not formed from smaller components such as wood chips or isolated fibers that have been bonded together. Preferably, a bamboo raw lamellae is consistent and uniform in its material.

By using bamboo raw lamellae, which are cut directly from the bamboo canes and not composed of thinner components, the bamboo blank became particularly strong and invulnerable to mold and insect infestation. The number of glue joints and the amount of non-bamboo materials in the bamboo blanks could also be kept particularly low, making the bamboo blanks and bamboo elements easily recyclable.

In a preferred embodiment of the invention, bamboo canes are split into bamboo raw lamellae. Preferably, the splitting is done using a star-shaped splitting knife. This allows the bamboo raw lamellae to be manufactured quickly and uniformly.

In a preferred embodiment of the invention, the bamboo canes are split into bamboo raw lamellae using knives. Preferably, the bamboo canes are then pre-planned on both sides, steamed, and/or dried. Before steaming and drying, the bamboo raw lamellae has a moisture content of 30-50%. After the drying process, the bamboo raw lamellae is preferably finish-planed on all four sides and is ready for gluing. The finished bamboo lamella has a residual moisture content between 3% and 12%+/−2%. Due to the steaming process, the bamboo raw lamellae has a reduced sugar and starch content, preferably <5%. This is particularly advantageous for reducing fungal infestation and insect damage.

By using bamboo lamellae that were steamed, dried, and planed, the strength of the glue joints in the bamboo blank was reduced. Since delamination, fractures, or shearing tend to occur first along such glue joints, these effects could be surprisingly greatly reduced.

The use of such bamboo lamellae, as opposed to fibers, also resulted in the bamboo blank having a surprisingly high diffusion resistance. This reduces the risk of mold and insect infestation. Additionally, the product was more ecological since it had a low proportion of adhesive compared to bamboo material.

The maximum thickness and/or width of the bamboo lamellae may be limited, for example, by the circumference and/or wall thickness of the bamboo raw lamellae. Likewise, the thickness and/or width of the bamboo lamellae may result from how much thickness the cross-section of the bamboo lamella loses through pre-planing, steaming, drying, and finish planing. Preferably, after the preceding processing steps, the finished bamboo lamellae have a thickness of 5-40 mm and a width of 15-50 mm. It may be particularly preferred for the bamboo lamellae to have a thickness between 7-35 mm, more preferably 10-30 mm, or 15-20 mm. Similarly, it may be particularly preferred for the bamboo lamellae to have a width between 20-40 mm, more preferably 20-30 mm.

At these thicknesses and widths, the bamboo lamellae could be essentially free from the natural curvature of the bamboo walls as well as the outer bamboo skins and could be essentially rectangular in cross-section. At the same time, the bamboo lamellae could essentially utilize the cross-section of the bamboo raw lamellae with minimal waste.

Surprisingly, it was found that the bamboo lamellae were stable enough at these thicknesses to be processed to have a uniform, rectangular cross-section. Thinner bamboo lamellae less than 5 mm are not satisfactory for processing because at these thicknesses, planing machines can no longer work accurately and the resulting amounts of adhesive are not economical. The bamboo lamellae could also be transported and processed into bamboo blanks that were stable enough to be pressed and glued to produce more complex bamboo elements.

The bamboo canes are preferably sorted automatically with scanning devices according to diameter and wall thickness to maintain high production capacity. In another preferred embodiment of the invention, both cane lamellae and finished bamboo lamellae with defects such as wood beetle infestation, fractures, and lack of dimensional stability (for example, a conical or non-rectangular shape) are sorted out.

The scanning device can be used as part of a production line. Preferably, the scanning device has an inlet and an outlet for the bamboo lamellae. The inlet and outlet may include or be connected to a conveyor belt or other continuous means of transporting the bamboo lamellae. For example, the scanning device can operate on the principle of tomography to reconstruct the internal structure of each bamboo raw lamellae and bamboo lamella. Such a scanning device can use X-ray emitters and sensors positioned around the bamboo lamella, or it can allow rotation of the bamboo lamella so that it can be analyzed from multiple angles. This is particularly useful for sorting out bamboo lamellae with internal defects.

As another example, the scanning device may include levitation means such as air dispensers and vibration means. This can be particularly useful for investigating the characteristic resonance of the bamboo lamella, which can improve the safety of a structure made with the bamboo lamella, such as a bridge frame.

As a further example, the scanning device may include means for measuring the strength of the bamboo lamellae. Such means may include an optical laser interferometer and/or a high-performance laser vibrometer. Preferably, the scanning device also includes a processor with an algorithm that calculates important strength parameters such as the dynamic modulus of elasticity of the bamboo lamellae and decides whether a bamboo lamella is of acceptable quality and should be forwarded to further processing stations or sorted out.

Preferably, the scanning device also includes means for detecting thickness, width, length, curvature, density, and/or surface quality of the bamboo lamella. For example, color, laser, and X-ray emitters and/or sensors can be combined to detect these features.

Preferably, the scanning device also includes a processor with a decision-making algorithm to decide whether a bamboo lamella is of acceptable quality and should be forwarded to further processing stations or sorted out.

In preferred embodiments of the invention, the bamboo lamellae are pressed and bonded together with a pressing pressure of 0.05-1.5 N/mm², preferably 0.15-1 N/mm², more preferably 0.2-0.3 N/mm². At a pressing pressure of 0.15-1 N/mm², especially 0.2-0.3 N/mm², a balance between the integrity of the bamboo fibers and the strength of the connection between the bamboo lamellae was achieved. At this pressing pressure, the bamboo material was surprisingly not deformed, and its strength remained intact. Meanwhile, the adhesive bonded sufficiently with the bamboo fibers to ensure a long-term, high-strength connection with high resistance to material failure such as fracture or shearing under load or water diffusion. In bonding, cold pressing methods have proven to be particularly efficient, with the application of high-frequency pressing methods being even more preferred.

The inventive blanks are preferably further processed into bamboo elements.

In this process, the bamboo blanks can be interconnected. Preferably, the bamboo blanks are connected to endless lengths by finger joint bonding.

In further preferred embodiments of the invention, the endless blanks are glued fiber-parallel and preferably with offset finger joints to form beams or layers. By bonding beams or layers, larger and more complex structural elements can be produced.

The bamboo blanks or bamboo elements can be interconnected by connections such as adhesives, screws, nails, dowels, finger joints, corner connections, fingers, overlapping joints, tongue and groove connections, and/or mortise and finger joints. Preferably, the bamboo blanks or bamboo elements are joined to structures and structural systems. It is understood that these connections can be combined. In particular, both adhesive and force-locking connections can be used.

It was completely surprising that by connecting bamboo blanks, structural elements, composite materials, and more complex structural elements could be produced that had more advantageous properties than the sum of the individual blanks themselves. The bamboo elements, comprising multiple bamboo blanks, surprisingly showed improved specific strength, higher modulus of elasticity, and higher modulus of rupture. Moreover, due to the larger dimensions achieved by the combination of bamboo blanks, the ratio of surface area to volume of the resulting bamboo elements decreased. Consequently, the bamboo elements were surprisingly impervious to moisture, mold, and insects.

It was completely surprising that the bamboo layers could also be processed into more complex structural elements in cross-layers. This allows panel-shaped and hybrid components made of panels and rods to be produced. This is schematically illustrated in FIGS. 41-45. FIG. 41 schematically illustrates the connection of two bamboo blanks using a finger joint at their end faces to create a longer (“endless”) bamboo blank. FIG. 42 schematically illustrates the connection of multiple endless bamboo blanks along their elongated side surfaces to create a bamboo rod of any cross-section. FIG. 43 schematically depicts the connection of multiple bamboo rods through an adhesive bond along their elongated side surfaces (narrow sides) to create a bamboo layer.

Surprisingly, it was found that the bamboo blanks themselves can be arranged into a variety of shapes with practically unlimited dimensions using simple connection mechanisms. Due to the special properties of bamboo, it could not only be successfully bonded over long dimensions but also withstand bending and twisting forces as its dimensions increased. This reduced the risk of material failure due to deformations such as fracture, shearing, twisting, or delamination. Instead, the elements could be expanded in all dimensions, making them thicker, longer, or wider. This outcome is particularly promising for construction purposes, where large structural elements are advantageous as they require less manual labor (e.g., compared to bricks) and have fewer weak points.

Bamboo cells tend to be arranged longitudinally. Unlike most woods that have ray cells present in the transverse direction, bamboo does not have them. Therefore, bamboo has very limited lateral tissue porosity and permeability compared to wood. This poses a challenge in selecting a suitable adhesive, especially when applying the adhesive in the direction of the bamboo fibers.

In a preferred embodiment of the invention, the adhesive used is a one-component adhesive comprising polyurethane adhesive (PUR). The use of PUR as an adhesive is particularly advantageous due to its high strength and easy application. It is also advantageous that no high-frequency or infrared process is required for the curing of PUR, making the manufacturing process for producing the structural elements less energy-intensive and more environmentally friendly. When applied or disposed of, PUR does not release climate-damaging formaldehydes. Unlike many adhesives, PUR can be synthesized from renewable materials such as castor oil and does not need to be based on petroleum products, making the bamboo elements overall more ecological.

Unlike two-component wood adhesives, PUR is a so-called prepolymerized adhesive. That is, it comprises longer molecular chains that give it high elasticity. PUR reacts with the residual moisture in dried bamboo lamellae, so it cures very quickly and forms an excellent bond. It was completely surprising that PUR, in combination with the pressure of 0.05-1.5 N/mm², reacted with the moisture from the fibers deeper than the surface of the bamboo lamellae, making the bamboo blanks more resistant to fracture, shearing, deformation, and delamination along the joint. To achieve this advantageous combination, the prejudice had to be overcome that the long chains of PUR would excessively restrict its absorption into the bamboo surface. In combination with the particularly flexible bonds formed by PUR, the resulting bamboo blank was able to withstand stresses from swelling or shrinking, leading to a particularly long-lasting connection.

Additionally, the long polymer chains of PUR and their deep penetration into the bamboo wood successfully created a barrier against the diffusion of moisture in the end product, further improving the product's durability.

In an alternative preferred embodiment of the invention, the adhesive is a two-component adhesive, preferably comprising melamine-urea-formaldehyde adhesive (MUF). Unlike PUR, MUF is a so-called “in-situ polymerized” adhesive. MUF consists of monomers that crosslink during the curing process. Due to the small size of the monomers, MUF penetrates deeply into the bamboo lamellae, resulting in a broad adhesive layer. It was particularly surprising that MUF generated very strong bonds regardless of the moisture content of the bamboo lamellae. The bamboo lamellae could be joined with particularly small amounts of MUF, improving the ecological nature of the end product.

A “one-component adhesive” in the context of the invention is preferably an adhesive with a predetermined composition that is essentially not changed during application. Preferably, the one-component adhesive is delivered directly from a storage unit to an application unit without being mixed with additional components. That is, in situ mixing is preferably not necessary for a one-component adhesive. This can lead to a simplified and more efficient process.

A “two-component adhesive” in the context of the invention is preferably an adhesive that can be applied by in situ mixing of two predetermined compositions. Preferably, the two compositions are delivered from two separate storage units to an application unit, so that mixing of the two compositions occurs during or immediately before application. It was surprisingly found that two-component adhesives led to unexpectedly high-strength bamboo elements.

In a preferred embodiment of the invention, bamboo canes are separated into bamboo lamellae with a moisture content of 30-50% using star-shaped splitting knives. In a preferred embodiment of the invention, the bamboo lamellae are planed on both sides so that the bamboo outer skin is removed, and two straight and parallel sides are planed.

In another preferred embodiment of the invention, the bamboo lamellae are planed before calibration and before steaming and drying. Preferably, the outer layer of the bamboo lamella is removed by planing. This layer has an increased oil and wax content and can hinder adhesion. By removing this layer, the bamboo lamellae can be bonded together more effectively. During planing, the intermediate floors (i.e., the diaphragms) are preferably removed from the inner side (i.e., the concave hollow side) of the bamboo lamellae. This makes it easier to plane and/or calibrate the bamboo lamellae after drying. This process is depicted in FIGS. 46 (fifth step) and 47. It was particularly found that storing the intermediate floors during drying accelerated the degradation of the tools used for planing. To avoid rapid dulling of these tools, it has proven advantageous to remove these layers during planing before drying. This allows planing to be surprisingly wear-free.

Preferably, the planing step provides a higher degree of uniformity and better surface quality than the pre-planing step. The planing step may require the use of sharper and/or more specialized tools.

In a preferred embodiment of the invention, the pre-planed bamboo lamellae are steamed, preferably in an autoclave, for at least 3 hours at temperatures of 70° C. 200° C. The steaming process reduces the starch and sugar content of the bamboo lamella to preferably <5%. Without being tied to any specific theory, it is believed that the steaming process reduces the starch and sugar content of the bamboo, which attracts insects and microorganisms. Additionally, it has been found that the bamboo lamellae can be made more uniform, dimensionally stable, and straight. Furthermore, it has been found that the bamboo lamellae are even more precise and dimensionally stable when the steaming process is repeated.

In another preferred embodiment of the invention, the bamboo lamellae are dried in a drying chamber, preferably a vacuum drying chamber, for at least 6 hours at temperatures of 55°−130° C. Preferably, the dried bamboo lamellae have a wood moisture content between 3-12%, with the wood moisture content preferably deviating up to +2% from these preferred minimum and maximum wood moisture levels. It may be preferred that the temperature for drying does not exceed 100° C., preferably not more than 90° C., particularly preferably not more than 80° C. Particularly preferred is a temperature between 70-80° C.

It was completely surprising that the bamboo lamellae retained their elasticity and strength at this moisture content without becoming brittle. At the same time, the bamboo was dry enough to be planed or sanded and showed significantly increased resistance to mold and insect infestation. Without being bound to any specific theory, it is presumed that this is due to a reduction in the starch and sugar content of the bamboo, which attracts insects and microorganisms. Furthermore, the bamboo lamellae retained their shape and dimensions permanently after drying and were not susceptible to shrinkage or swelling due to fluctuating moisture levels during storage or use.

In another preferred embodiment of the invention, the bamboo lamellae are planed. Preferably, the bamboo lamellae are planed from all four sides—top, bottom, right, and left. The distance between two opposing planed sides, i.e., a width and a thickness of the bamboo lamellae, is preferably calibrated and standardized by planing.

Preferably, two parallel longitudinal surfaces of each bamboo lamella are planned to be perfectly parallel. This aids in stacking the bamboo lamellae side by side to form an element of uniform thickness. Possible irregularities on the remaining sides of the bamboo lamellae can be compensated for by a layer of adhesive. Surprisingly, it was found that adhesives interact better with the slightly rough, unplaned sides of the bamboo lamellae, thereby reducing the risk of delamination. It was also completely surprising that a very uniform and calibrated end product with planed surfaces could be produced.

It was also completely surprising that the bamboo lamellae were easy to press due to the described process steps while reducing adhesive consumption since the surface of the bamboo lamellae was very smooth.

In a more preferred embodiment, the bamboo lamellae are planned on all four sides and at right angles, so that all bamboo lamellae have a uniform cross-section. This allows the lamellae to be tightly packed together in subsequent processes, resulting in a final product with more predictable and uniform properties. All bamboo lamellae used for a particular blank can have a rectangular cross-section with identical dimensions. Calibration can also be used to provide each bamboo lamella with a smooth outer surface. It may also be preferred to calibrate all six sides of the bamboo lamellae. The dimensions of the end product produced in this way can be surprisingly accurately predetermined.

The bamboo lamellae preferably have a thickness between 5-40 mm, especially 7-35 mm, particularly preferably 10-30 mm, and a width between 20-70 mm. It may be preferred that the bamboo lamellae have an average length between 1000-6000 mm. The preferred method for producing the bamboo lamellae is explained in detail in the description with reference to the drawings.

Preferably, after the preceding processing steps, the finished bamboo lamellae have a thickness of 5-40 mm and a width of 15-50 mm. It may be particularly preferred for the bamboo lamellae to have a thickness between 7-35 mm and a width of 20-40 mm, even more preferably 10-30 mm or 15-20 mm and a width of 20-30 mm.

The wood chips generated during the planing process can be used to produce chipboard, MDF boards, wood foam, or other insulation products, Terra Preta (fertilizer), and for bioethanol production. Such an insulation layer made of wood foam can form part of a sandwich panel, where the outer layers preferably consist of 1-3-layered layers of bamboo lamellae and the core layer preferably consists of wood foam panels. Particularly preferred are outer layers consisting of layers of bamboo lamellae and the insulation layer consisting of bamboo wood foam. A resulting composite product could have a particularly low carbon footprint and at the same time be surprisingly easy to recycle, as it encompasses the same materials across layers that can be disposed of in a similar manner.

It was found that the bamboo lamellae of the sandwich panel bond remarkably well with the insulation material, thus forming a highly efficiently insulated, strong, shock-absorbing, and durable element. It was also completely surprising that the construction process could be dramatically simplified by providing prefabricated insulated building elements.

In another preferred embodiment of the invention, the bamboo lamellae are sorted according to strength and appearance before being glued together. Sorting can be done visually, mechanically, or electronically. bamboo lamellae for surface layers should preferably be sorted according to stricter criteria. They should preferably have higher strength as well as better visual quality. During sorting, unsightly growth deviations, non-dimensional, non-right-angled, or insect-infested lamellae can be completely sorted out or the defective areas can be cut off The finished bamboo lamellae are preferably sorted automatically with scanning devices according to criteria such as beetle infestation, dimensional accuracy, parallelism, and/or perpendicularity. As described above, such a scanning device may have various configurations and functions.

In another preferred embodiment of the invention, the bamboo lamellae are pressed into blanks using a pressing device. Preferably, a cold pressing process can be applied. Alternatively, a high-frequency process can be utilized.

In another preferred embodiment of the invention, after sufficient curing of the adhesive, the press can be released.

In a further preferred embodiment of the invention, following optical sorting, the bamboo blank is calibrated to be perpendicular. This calibration can also be carried out by a planing machine, for example, a four-sided planing machine. This ensures that the blanks used to manufacture a specific element all have a smooth surface and a rectangular cross-section with identical dimensions.

Although the width of the bamboo lamellae may only be limited by the circumference of the bamboo tube, bamboo lamellae with a width of 20-70 mm have been found to be optimal. Alternatively, the bamboo tube can be cut in half, which can then be smoothed using a heated roller press, resulting in significantly wider bamboo lamellae. However, at the chosen width, bamboo lamellae could be harvested from the bamboo tube without exhibiting significant curvature that needs to be eliminated through flattening. It has been found that the flattening process introduces undesirable cracks into the material. On the other hand, bamboo lamellae with a width of 20-70 mm could be surprisingly made uniformly rectangular through planing without compromising the integrity of the material. The width has also proven to be sufficient for producing bamboo blanks with a low density of adhesive joints, where delamination may occur. The resulting blank proved to be surprisingly strong.

The length of the bamboo lamellae is essentially only limited by the length of the giant bamboo tube from which they are harvested. However, up to a length of 6000 mm, the bamboo lamellae can exclusively be harvested from the first 7 meters of the bamboo tube, which comprises the perfectly cylindrical and most heavily lignified material. At this length, bending due to the inherent flexibility of the bamboo material could also surprisingly be avoided. By using bamboo lamellae with a length of at least 2000 mm, the material of the bamboo lamellae could be present in the blanks as continuously as possible, thereby keeping the number of finger joints low. This is surprisingly advantageous for the overall strength of the resulting bamboo elements, as the elements tend to fail first along the finger joints.

Unless otherwise specified, “thickness” refers to the shorter dimension of a rectangular cross-section of a part. “Width” refers to the longer or equally long side of a rectangular cross-section of the part unless otherwise specified. “Length” refers to the longest dimension of a part—usually in the fiber-parallel direction.

In the context of the invention, an element or dimension referred to as “endless” is an element or dimension that can be arbitrarily large. Preferably, such an element comprises multiple interconnected subunits, where the number of subunits is limited only by transportation and/or the desired final application. For example, the size of an endless element and the number of subunits may be limited only by the size of a transport container.

In another preferred embodiment of the invention, the bamboo lamellae are glued together longitudinally and/or fiber-parallel. This is preferably done through an adhesive joint, which is elongated between two bamboo lamellae. The width of the adhesive joint is preferably up to 0.3 mm and is preferably transparent. The adhesive joint preferably comprises a pollutant-free adhesive, especially a formaldehyde-free adhesive. It was completely surprising that an adhesive joint of up to 0.3 mm could compensate for surface defects in the adjacent bamboo lamellae while being very flexible at the same time. In some embodiments, it was preferred that the adhesive joint be at least 0.05 mm. There is a demand for renewable, pollutant-free products that offer the required quality at reasonable costs. Particularly, reducing formaldehyde emissions poses a major challenge for the global wood-based panel industry. Therefore, it may be preferred to use bio-based, formaldehyde-free adhesives.

In another preferred embodiment of the invention, the adhesive comprises one of the following formaldehyde-free, bio-based adhesives: amino resins based on glycolaldehyde, a lignin-based adhesive, a tannin-based adhesive, a starch-based adhesive, a soy protein-based adhesive, a furfural-based adhesive, a natural phenol-based adhesive, a polyvinyl acetate-based adhesive, a sugar derivative-based adhesive, an epoxy resin adhesive based on epoxidized plant oils, and/or a hydroxy functional polyester-based adhesive. Surprisingly, the bio-based adhesives produced a very strong bond with the dried bamboo lamellae and provided a much more ecological product compared to products with traditional adhesives.

The preferred adhesives suitable for bamboo can be used between bamboo lamellae, bamboo blanks, finger joints, bamboo rods, bamboo layers, and/or cross-laminated timber elements. As a mere example, Purbond HB 110 1K Pur can be mentioned.

In another preferred embodiment of the invention, the bamboo lamellae are bonded together by a pressing pressure of 0.05-1.5 N/mm². Preferably, this pressing pressure is between 0.15-1 N/mm². The pressure in this and other process steps can preferably be applied for a pressing duration between 5 and 300 minutes. Particularly preferred, the pressure is applied for a pressing duration of 5-120 minutes, more preferably approximately 60 minutes. It is also preferred to reduce pressing times to less than 10 minutes in embodiments to ensure high production output. Especially with the use of high-frequency presses, a pressing duration of 5-10 minutes can lead to particularly strong and thin adhesive joints. Surprisingly, it was found that at the preferred pressure values and durations, a particularly strong and durable product is produced without compromising the material properties of the bamboo. Additionally, sufficient absorption of the adhesive into the surface of the bamboo could be achieved. It was also completely surprising that the adhesive cured sufficiently with a pressing duration of approximately 120 minutes to enable handling of the bamboo blanks without excessive squeezing out of adhesive from the bamboo. The preferred adhesive joints of 0.05-0.3 mm could be produced.

In another preferred embodiment of the invention, an endless bamboo blank comprises a first and a second bamboo blank, wherein the first and second bamboo blanks each have two end faces. The first bamboo blank is preferably butted at its end face to one end face of the second bamboo blank by a finger joint connection with a pressing pressure between 0.05-0.3 N/mm².

In another preferred embodiment of the invention, a plurality of bamboo lamellae, preferably at least five bamboo lamellae, are glued and pressed together along their wide sides to form blanks A using a pressing process. This is preferably done under a pressing pressure between 0.05-1.5 N/mm², particularly preferably under a pressing pressure between 0.15-1.0 N/mm². As an example, Purbond HB 110 1K Pur can be used as adhesive. A preferred thickness of blank A is 20-60 mm. A preferred width of blank A is 60-300 mm. In this orientation, the bamboo lamellae surprisingly adhered well to each other. Due to these dimensions, blank A was also surprisingly easy to handle and transport. The bamboo blanks A also had a high density of adhesive joints, making them particularly resistant to moisture, mold, and insect infestation.

In the context of the invention, the term “longitudinal direction,” unless otherwise stated, refers to the direction of the bamboo fibers. A transverse direction is oriented orthogonal to these fibers.

In another preferred embodiment of the invention, the bamboo rod comprises a plurality of blanks. The bamboo blanks can be stacked and/or arranged end to end to form the bamboo rods. Preferably, the blanks are longitudinally joined and connected by frictional connections, preferably by finger joints, with each blank comprising a plurality of bamboo lamellae arranged side by side and bonded together with an adhesive, with a distance of at least 0.3 m between each successive frictional connection, so that the bamboo rod has a preferred length between 2000-30000 mm.

It was surprisingly found that finger joints are particularly effective in creating a stable, long-lasting connection between longitudinally successive bamboo lamellae or bamboo blanks. Particularly compared to hook and leaf joints, the finger joints were able to withstand much greater loads. However, since the bamboo rods tended to fail first along the finger joints, separating these joints by at least 0.3 m resulted in surprisingly stable bamboo rods. Particularly surprising was that the bamboo rods could be extended to lengths of 2000-30000 mm by frictional connections without deformation due to loads (such as simulated traffic loads, wind) or the weight of the bamboo rods.

In another preferred embodiment of the invention, a bamboo rod comprises two or more bamboo blanks, wherein the bamboo blanks include finger joints and are glued and pressed together along one or more of their elongated sides with an adhesive and a pressure of 0.05-0.3 N/mm², with the finger joints of adjacent bamboo blanks being staggered longitudinally to each other.

In another preferred embodiment of the invention, two or more blanks A are glued and pressed together longitudinally by finger joints. These are finger-shaped frictional connections between two correspondingly shaped ends of the blanks. The finger lengths are preferably between 5-40 mm in the longitudinal direction of the blanks. It was completely surprising that finger lengths of 5-40 mm could provide sufficient surface area for adhesive absorption as well as for generating sufficient friction between the joined bamboo blanks, thus resulting in a very long-lasting connection.

The resulting “endless” bamboo blanks preferably have a length between 1000-18000 mm. It was also completely surprising that stable bamboo blanks of up to 18000 mm length could be produced using such connections. At this length, even the single-layer bamboo blanks A were surprisingly stable and could withstand high loads. Due to the enormous potential for length expansion through these finger joints, the resulting parts are referred to as “endless.” A distance between two longitudinally successive finger joints is preferably at least 0.3 m. At this minimum distance, the processing of the parts during manufacturing is particularly reliable.

The blanks A or the endless blanks A are considered as the final product. In this case, it is preferred to subject the parts to a finishing process including calibration, grinding, and/or moisture, insect, and fungus impregnation. This is especially important for surfaces that will be visible in a final product.

In another preferred embodiment of the invention, two or more blanks A, preferably at least five blanks A, are glued and pressed together along their thickness to form bamboo layers A.

In another preferred embodiment of the invention, two or more blanks A are glued and pressed together longitudinally by finger joints. This is preferably done under a pressing pressure between 0.05-1.5 N/mm², particularly preferably under a pressing pressure between 0.15-1 N/mm².

Suitable adhesives are used for this purpose. Currently, various suitable adhesives are being used for the approval process, preferably one-component and two-component adhesives, particularly preferred are bio-based formaldehyde-free adhesives. A width of the bamboo layers A is preferably 200-4000 mm. A thickness of the bamboo layers A is preferably 10-400 mm. Finger joints can make the layers “endless” as well. A distance between two longitudinally successive finger joints is preferably at least 0.3 m.

The bamboo layers A have proven to be particularly suitable for use as board stack covers. Additionally, they surprisingly found use in flooring and wall cladding. Due to their low density, high insulating ability, and good aesthetic appearance, they were particularly suitable for use in buildings, where they could replace traditional elements such as brick walls for room separation and heavy, high-maintenance wooden floors. In another preferred embodiment of the invention, a bamboo layer comprises a plurality of bamboo blanks, wherein the bamboo blanks are glued together along one or more of their elongated sides by means of an adhesive and a pressing pressure of 0.05-0.5 N/mm², wherein the finger joints of the adjacent bamboo blanks are arranged longitudinally offset from each other.

In another preferred embodiment of the invention, the bamboo layers are glued as visible cover layers on plywood panels made of softwood.

In another aspect of the invention, a bamboo rod is provided, in particular for use as a load-bearing structural element. The bamboo rod comprises a plurality of blanks. The blanks have four elongated sides and two end faces, wherein a plurality of blanks are glued together along one or more of their elongated sides by means of an adhesive and a pressing pressure of 0.05-1.5 N/mm². Preferably, when gluing the blanks, the finger joint seams are staggered. Surprisingly, the beams then have an even higher load-bearing capacity.

It was completely surprising that these bamboo rods were extremely strong while still exhibiting enough elasticity and flexibility to serve various purposes in the construction industry. The strength resulting from the connection of multiple bamboo blanks was much greater than expected when considering the strengths of the individual parts. Completely surprising was also that these bamboo rods were strong enough to replace steel and wooden sticks in buildings, as illustrated below with experimental data. This is particularly advantageous, as these traditional materials are not only expensive and less environmentally friendly, but also because the bamboo rods have comparatively slimmer dimensions, are very light, and allow for statically smaller construction heights and widths in components made from bamboo rods. This opened new possibilities in the construction industry, such as the construction of multi-story buildings, bridges, and the like, without having to resort to traditional building materials. This solves one of the most urgent sustainability challenges, as building materials are essentially non-renewable and non-recyclable. The bamboo rods, on the other hand, could be obtained from very rapidly renewable sources and would essentially be free of foreign materials such as concrete and steel, so they could be surprisingly easily recycled in the event of demolition.

In another preferred embodiment of the invention, two or more blanks A, preferably at least two blanks A, are glued and pressed together along their width to form bamboo rods A. This is preferably done under a pressing pressure between 0.05-1.5 N/mm², particularly preferably 0.15-1 N/mm². HB 110 1K Pur can be used as an adhesive. A width of a bamboo rod A is preferably 40-1000 mm, particularly preferably 60-400 mm. A thickness of the bamboo rod A is preferably 40-400 mm, especially 40-300 mm. These dimensions synergistically interacted with the density and material properties of the bamboo rods, resulting in stable bamboo rods that were easy to transport and assemble while also being surprisingly well suited for construction purposes, especially for use as load-bearing beams. Preferably, when bonding the blanks, the finger joints are staggered. Surprisingly, the beams then have an even higher load-bearing capacity. It was completely surprising that such beams could replace much heavier traditional materials such as steel or wood.

Two or more bamboo rods A can be glued and pressed together along their end face by means of finger joints. The finger lengths are preferably 5-40 mm in the longitudinal direction, and the resulting endless bamboo rods A preferably have a length between 2000-30000 mm. A pressing process is preferably carried out under a pressing pressure of at least 0.03 N/mm², preferably under a pressing pressure between 0.05-0.3 N/mm². Purbond HB 110 1K Pur can be used as an adhesive. A distance between two longitudinally successive finger joints is preferably at least 0.3 m.

In this way, practically any length of continuous beams can be produced. It was completely surprising that such bamboo rods could form particularly strong building structures, especially as a replacement for timber frame construction, wood framing, roof trusses, ceiling and wall elements, practically without visual or mechanical interruptions due to the use of metal connectors or similar. The result was not only visually appealing design but also a very stable structure without weak points caused by additional connections.

Blanks A as well as the rods and layers formed from blanks A can be planed and calibrated at any stage of the process. Alternatively or additionally, the rods and layers formed from blanks A can be subjected to surface treatment. The surface treatment preferably includes treatment by grinding and/or moisture impregnation.

In another preferred embodiment of the invention, blanks B are prepared from bamboo lamellae. A plurality of bamboo lamellae, preferably at least five bamboo lamellae, are glued and pressed together along their narrow elongated side in a pressing process to form blanks B. A pressing process is preferably carried out under a pressing pressure between 0.05-1.5 N/mm², particularly preferably under a pressing pressure between 0.15-1 N/mm². Purbond HB 110 1K Pur can be used as an adhesive. The blank B preferably has a width between 60-300 mm. The blank B preferably has a thickness between 5-40 mm.

The bamboo blanks B were thinner and had a lower density of adhesive joints than bamboo blanks A. It was surprising that stable bamboo blanks could form at these dimensions. The bamboo blanks B were very light per square meter and therefore particularly suitable for processing into bamboo layers, from which multi-layer panels such as plywood or two- or three-layer panels can be manufactured. They were also surprisingly easy to work with, without splintering or breaking, allowing bamboo blanks in various shapes to be used as building blocks for larger components. Furthermore, the bamboo layers are perfect for being glued to visible cover layers in plywood panels made of softwood. Thanks to the thin adhesive joints, the bamboo blanks were aesthetically very appealing, making them suitable for use as outer layers for more complex bamboo elements.

In another preferred embodiment of the invention, two or more blanks B are glued and pressed together along their end face through finger joints. The finger lengths are preferably 5-40 mm in the longitudinal direction, and the resulting endless blanks B preferably have a length between 2000-18000 mm, especially 2000-12000 mm. At this length, the blanks could fit in a freight container. At the same time, these lengths were particularly suitable for covering a length from floor to ceiling of a building without interruption. A distance between two longitudinally successive finger joints is preferably at least 0.3 m.

In another preferred embodiment of the invention, two or more, preferably at least five, blanks B or endless blanks B are glued and pressed together along their thickness (their narrower elongated side) to form bamboo layers B. This is preferably done under a pressing pressure between 0.1-1.5 N/mm², particularly preferably under a pressing pressure between 0.15-1 N/mm². Purbond HB 110 1K Pur can be used as an adhesive. A width of the bamboo layers B is preferably 200-4000 mm. A thickness of the bamboo layers B is preferably 5-400 mm. Through finger joints, the layers can also become “endless”. A distance between two longitudinally successive finger joints is preferably at least 0.3 m. Bamboo layers made from bamboo blanks B could be made thin, making them suitable for coverings such as floor and wall cladding. It was surprising that the bamboo layers were very stable at these dimensions and could withstand high loads. At the same time, the flexibility of the bamboo layers could be exploited to produce bamboo layers that could seamlessly cover slight deformations, such as those occurring over time in a floor.

In another preferred embodiment of the invention, the bamboo layers are glued as visible cover layers on plywood panels made of softwood.

In another preferred embodiment of the invention, two or more bamboo layers B are glued and pressed together longitudinally through finger joints. The finger lengths are preferably between 5-40 mm in the longitudinal direction of the blanks. The resulting endless bamboo layers B preferably have a length between 2000-30000 mm. A pressing process is preferably carried out under a pressing pressure of at least 0.03 N/mm², particularly preferably under a pressing pressure between 0.1-1.5 N/mm².

In another preferred embodiment of the invention, two or more, preferably at least five blanks B or endless blanks B are stacked and glued and pressed together to form bamboo rods B. A pressing process is preferably carried out under a pressing pressure between 0.1-1.5 N/mm², particularly preferably under a pressing pressure of 0.3-1 N/mm². A bamboo rod B preferably has a width between 50-400 mm and a thickness between 50-400 mm.

In another preferred embodiment of the invention, two or more, preferably at least five bamboo rods B are glued and pressed together longitudinally through finger joints. These connections are finger-like force-fitting connections between two correspondingly shaped ends of the bamboo rods B. The finger lengths are preferably between 5-40 mm in the longitudinal direction of the blanks. The resulting endless bamboo rods B preferably have a length between 2000-30000 mm. A distance between two longitudinally successive finger joints is preferably at least 0.3 m. A pressing process is preferably carried out under a pressing pressure of at least 0.03 N/mm², particularly preferably under a pressing pressure between 0.05-0.3 N/mm². With such bamboo rods, framework walls, beam layers, and roofs can be constructed. This applies to framework constructions, timber frame constructions, but also special structures with even larger spans and loads, such as in hall or bridge construction and wind turbine tower construction.

The blanks B as well as the rods and/or layers formed from blanks B can be planed and calibrated at any stage of the process. Alternatively or additionally, the rods and/or layers formed from blanks B can undergo surface treatment. The surface treatment preferably includes treatment by grinding and/or moisture, insect, and fungus impregnation.

In another preferred embodiment of the invention, the edges of the bamboo rods and/or the bamboo layers are shaped and/or trimmed with saws or milling machines for the creation of recesses and openings or for connection with components.

In preferred embodiments of the invention, two or more blanks are connected by force-fitting connections, preferably by finger joints, through their end faces. Preferably, a distance in the longitudinal direction between each two successive force-fitting connections is at least 0.3 m. Preferably, in the bonding of the blanks, the finger joint offsets are to be set. Surprisingly, the beams then have an even higher load-bearing capacity. Preferably, the bamboo rod has a length between 2000-30000 mm.

The blanks, especially the blanks A and B, can serve as basic elements for the following components: bamboo rods, bamboo layers, softwood plywood panels, hollow-core ceilings, ribbed ceilings, ribbed wall elements, T-posts, H-posts, wall and ceiling elements. bamboo rods can be connected to each other parallel to the grain direction of the bamboo lamellae depending on the embodiment. The bamboo rods can be joined and connected with finger joints. Preferably, when bonding the blanks, the finger joints are staggered. Surprisingly, the beams then have a higher load-bearing capacity. Additionally, the bamboo rods can be processed into bamboo layers and then into cross-laminated panels for more complex components. As is evident in this application, the processing possibilities of the bamboo rods into components are numerous and diverse. This processing is schematically illustrated in FIGS. 41-46. By layering the bamboo elements with alternating fiber directions and parallel fiber directions, the strength of the individual elements could be synergistically combined to produce extremely strong, lightweight components with large dimensions. These could greatly simplify construction as they are prefabricated and can be used to create building structures without the need for additional connections and complex in-situ joining processes. The result is extremely strong, uniform, environmentally friendly, and aesthetically pleasing buildings made from bamboo-based construction methods.

In another preferred embodiment of the invention, bamboo rods are glued to glulam beams at the narrow sides to form beams. Surprisingly, the load-bearing capacity of the beams is higher than that of pure glulam with the same height.

In another preferred embodiment of the invention, two bamboo rods are glued to form T-beams. A first bamboo rod forms the lower flange and a second bamboo rod forms a web. Surprisingly, the load-bearing capacity of the beams is higher than that of pure glulam with the same height.

In another preferred embodiment of the invention, a bamboo rod and a laminated veneer lumber beam (LVL) are glued to form T-beams. A bamboo rod forms the lower flange and a laminated veneer lumber beam (LVL) forms a web. Surprisingly, the load-bearing capacity of the beams is higher than that of pure glulam with the same height.

In another preferred embodiment of the invention, three bamboo rods are glued to form double T-beams. A first bamboo rod forms the lower flange, a second bamboo rod forms the web, and a third bamboo rod forms the upper flange. Surprisingly, the load-bearing capacity of the beams is higher than that of pure glulam with the same height.

In another preferred embodiment of the invention, two bamboo rods and a laminated veneer lumber beam (LVL) are glued to form double T-beams. A first bamboo rod forms the lower flange, a laminated veneer lumber beam (LVL) forms a web, and a second bamboo rod forms the upper flange. Surprisingly, the load-bearing capacity of the beams is higher than that of pure glulam with the same height.

In another preferred embodiment of the invention, T-beams and chipboard, plywood, or three-layer panels are used as ceiling elements. In addition, chipboard, plywood, or three-layer panels are connected to the lower flange with adhesive, nails, staples, or screws.

In another preferred embodiment of the invention, double T-beams and chipboard, plywood, or three-layer panels are used as ceiling elements. In addition, chipboard, plywood, or three-layer panels are connected to the lower flange with adhesive, nails, staples, or screws.

In another aspect, the invention relates to a bamboo layer, particularly for use as a load-bearing structural element. The bamboo layer comprises a plurality of bamboo blanks. The bamboo blanks are arranged parallel to each other and bonded together with an adhesive under a pressing pressure of 0.15-1.5 N/mm². Preferably, the bamboo layer has a width of 1000-3000 mm and a preferred length of 2000-30000 mm. With these dimensions, entire wall or ceiling elements can be formed smoothly and without interruption. This greatly simplifies the construction process and reduces the number of mechanical joints, which can be weak points in a building. Furthermore, due to their continuous nature, such elements surprisingly provide a good barrier against the spread of fire, particularly because there are no oxygen-containing spaces in their material. The absence of gaps has also contributed to these elements being surprisingly good at thermal insulation. It was completely surprising that air, vacuum, or an intermediate insulation layer could be placed between parallel bamboo layers, further enhancing the thermal and acoustic insulation of a building.

In another preferred embodiment of the invention, engineered bamboo wood panels are constructed from bamboo layers. The bamboo layers are preferably stacked and bonded together with adhesive and pressed. The individual bamboo layers can be “endless”. The fiber direction of each bamboo layer is preferably perpendicular to a fiber direction of the adjacent bamboo layer.

In another aspect, the invention relates to an engineered bamboo wood panel for use as a load-bearing structural element. The engineered bamboo wood panel comprises a plurality of stacked bamboo layers bonded together with adhesive.

In a preferred embodiment of the invention, a fiber direction of the bamboo lamellae of each bamboo layer is perpendicular to a fiber direction of the bamboo lamellae of an adjacent bamboo layer. In further preferred embodiments of the invention, the directional difference between the fibers of successive layers ranges from 250-75°, preferably 300-80°, more preferably 450-90°. Surprisingly, it has been found that the overall strength of the produced bamboo elements was much greater due to the variation of fiber directions between the different layers than the sum of their parts. That means the layers contributed synergistically to the overall strength of the product. By adjusting the relative fiber angles of adjacent layers, laminated coupling effects could also be utilized to predispose a structural element for a desired curvature, twist, or torsion. Particularly for materials exposed to strong winds, such as wind turbine towers, it may be advantageous to predict the behavior of the structural elements in this way.

Adjacent bamboo layers may be directly on top of each other and/or bonded together or separated by a different intermediate layer. The intermediate layer may, for example, be a wood layer or an insulation layer.

In another preferred embodiment of the invention, the bamboo layers are bonded together by a pressure of 0.15-1.5 N/mm². The engineered bamboo wood panel has a preferred thickness of 30-300 mm, a preferred width of 500-5000 mm, and a preferred length of 3000-18000 mm.

It has been found that these dimensions synergize with the effect of using multiple layers and multiple fiber directions to form an engineered bamboo wood panel that is both exceptionally strong and sufficiently elastic. Such engineered bamboo wood panels were particularly useful for use as load-bearing structural elements. Due to their aesthetically pleasing appearance, it was not necessary—but remained an option—to combine them with facing layers. The construction process is significantly simplified by using these prefabricated engineered bamboo wood panels in the preferred dimensions. Furthermore, due to their multifunctionality as load bearers, good fire protection barriers, and aesthetically pleasing finish, they can also make the incorporation of additional materials into the building unnecessary. This makes recycling of building materials much easier when demolishing a building, as separation of the various materials is no longer required.

In another preferred embodiment of the invention, at least one insulation layer is arranged between two adjacent bamboo layers, wherein the insulation layer preferably comprises a wood foam made preferably from bamboo wood residues. This allows for the production of a so-called “sandwich element” (also “sandwich panel” within the meaning of the invention). The insulation layer preferably has a density between 40 and 250 kg/m³. The engineered bamboo wood panel preferably has a length and/or width of 12000-30000 mm.

In another preferred embodiment of the invention, the layers of the sandwich panel are bonded together by a pressure of 0.1-0.5 N/mm².

In another preferred embodiment of the invention, a sandwich panel comprises a bamboo layer and/or an engineered bamboo wood panel. Preferably, the sandwich panel comprises at least one insulation layer between two adjacent bamboo layers, wherein the bamboo layers are bamboo layers, engineered bamboo wood panels, or a combination thereof Preferably, the insulation layer comprises a wood foam, preferably made from bamboo wood residues, wherein the insulation layer has a preferred density between 40 and 250 kg/m³. The sandwich panel has a preferred width between 600-2000 mm, a preferred thickness between 100-400 mm, and a preferred length between 2000-18000 mm.

Such sandwich elements are particularly suitable for multi-story residential construction. Due to their very high strength-to-weight ratio, they could be used in tall buildings and replace traditional materials such as steel. The sandwich elements exhibited surprisingly high static load-bearing capacity with a comparatively low weight. Furthermore, the construction thickness of the sandwich elements could be kept minimal due to the efficient bamboo layers. It was also particularly surprising that the sandwich elements exhibit very high resistance to fire. The sandwich elements further facilitate the construction of a building as they can be delivered in prefabricated form and quickly assembled. Additionally, the aesthetic quality of the sandwich elements is particularly high, making further finishing steps and layers unnecessary (but possible).

In another aspect, the invention relates to a ceiling or wall element (also referred to as “rib elements” within the meaning of the invention), wherein the ceiling or wall element comprises a plurality of bamboo layers and/or engineered bamboo wood panels as components, wherein the bamboo layers or engineered bamboo wood panels are interconnected to define a main plane. The ceiling or wall element comprises one or more ribs, wherein the ribs are arranged parallel to the main plane of the ceiling or wall element. The ceiling or wall element has a preferred width between 600-2000 mm, a preferred thickness between 100-400 mm, and a preferred length between 2000-18000 mm.

It was surprisingly found that the ribs, in combination with three-layer panels, allow the production of large-area wall and ceiling elements with high strength and stability while maintaining low weight. Such ceiling or wall elements are particularly suitable for multi-story residential construction. Also, in the case of the ceiling or wall elements, a surprisingly high static load-bearing capacity was found with relatively low weight and a surprisingly high resistance to fire. Large spans and thus column-free spaces are possible with the wall and ceiling elements. Thanks to the high efficiency of the ceiling or wall elements, the thickness and/or height of the ceiling or wall elements could also be surprisingly kept minimal to save space. The ceiling or wall elements further facilitate the construction of a building as they can be delivered in prefabricated form and quickly assembled. Additionally, the aesthetic quality of the ceiling or wall elements is particularly high, making further finishing steps and layers unnecessary (but possible).

Preferably, the ribs comprise at least one bamboo blank or at least one bamboo rod. However, it is possible for the ribs or panels of the wall and ceiling element to be made of alternative materials such as wood.

In a preferred embodiment of the invention, the ribs, together with the bamboo layers or engineered bamboo wood panels, define a cavity. Such an element is also referred to as a “hollow core element” within the meaning of the invention. Preferably, two parallel engineered bamboo wood panels are separated by at least two ribs to define a right-angled cavity. Such an arrangement proved not only to be surprisingly stable but also exhibited excellent thermal and acoustic insulation properties. By arranging ribs and bamboo layers, the static load-bearing capacity was further increased. Similar benefits outlined above for the sandwich panels and rib elements were also observed for the hollow core element, especially regarding the strength-to-weight ratio, space saving, fire resistance, and aesthetic quality.

In another preferred embodiment of the invention, various other arrangements of bamboo rods are used to form, for example, U, H, and T-posts or larger beams. The blanks can also be combined with other materials to provide more complex structural elements.

In another preferred embodiment of the invention, glulam beams are glued together with bamboo blanks and bamboo rods to create highly efficient beams. Surprisingly, the combined beams have been found to have a higher load-bearing capacity than pure glulam beams of the same dimensions made from softwood.

In another preferred embodiment of the invention, a beam element is provided. The beam element comprises a plurality of bamboo rods, wherein the bamboo rods are glued along their narrow sides with an cross-laminated timber element made of softwood to form the beam element. The beam element has a preferred width between 60-200 mm, a preferred thickness between 100-400 mm, and a preferred length between 3000-18000 mm.

In another preferred embodiment of the invention, a T-beam element is provided. The T-beam element comprises at least one first bamboo rod. The first bamboo rod is glued with another element to form the T-beam element, wherein the first bamboo rod forms a bottom flange and the other element forms a web. The other element is preferably a second bamboo rod or a laminated veneer lumber beam (LVL). The T-beam element has a preferred width between 60-200 mm, a preferred thickness between 100-1000 mm, and a preferred length between 3000-18000 mm.

In another preferred embodiment of the invention, a double-T-beam element is provided. The double-T-beam element comprises a first and a second bamboo rod, wherein the first bamboo rod forms a top flange and the second bamboo rod forms a bottom flange. A web is formed from another element. The other element is preferably a third bamboo rod or a laminated veneer lumber beam (LVL). The double-T-beam element has a preferred width between 60-200 mm, a preferred thickness between 150-1000 mm, and a preferred length between 3000-18000 mm.

In another preferred embodiment of the invention, a ceiling element comprising a plurality of T-beam elements or double-T-beam elements is provided. The T-beam elements or double-T-beam elements are connected with one or more wood-based panels, wherein preferably one or more wood-based panels are connected with adhesive, nails, staples, and/or screws to the bottom flanges of the T-beam elements or double-T-beam elements. The ceiling element has a preferred width between 600-4000 mm, a preferred thickness between 100-1000 mm, and a preferred length between 3000-18000 mm.

The adhesive used for bonding one or more bamboo elements (blanks, rods, layers, etc.) preferably comprises one of the following formaldehyde-free adhesives: amino resins based on glycolaldehyde, a lignin-based adhesive, a tannin-based adhesive, a starch-based adhesive, a soy protein-based adhesive, a furfural-based adhesive, a natural phenol-based adhesive, a polyvinyl acetate-based adhesive, a sugar derivative-based adhesive, an epoxy resin adhesive based on epoxidized plant oils, and/or a hydroxyfunctional polyester-based adhesive. Surprisingly, the bio-based adhesives produced a very strong bond with the dried bamboo lamellae and provided a much more ecological product compared to products with traditional adhesives.

All these elements made of giant bamboo are particularly suitable for load-bearing and non-load-bearing roof, ceiling, and wall components in the construction of:
Single and multi-family houses,
Row houses,
Multi-story residential buildings,
Accommodations,
Multi-story school, commercial, cultural, and religious buildings,
Industrial buildings,
High-rise buildings,
Wind turbine towers,
Bridges,
Sports and event halls, and/or
Tiny houses

The dimensions of the panels are only limited by transportation constraints such as regulations, road widths, or bridge heights. By parallel gluing of blanks A and B and cross-gluing of the bamboo layers, the bamboo elements mentioned above are on the one hand very dimensionally stable and on the other hand, they can bear loads both longitudinally and transversely to the main load direction.

Standard dimensions of the bamboo elements, especially the bamboo blanks, bamboo rods, bamboo layers, and cross-laminated bamboo panels (referred to as “CLB panels” in this description), widths of 1100 mm and lengths of 21000 mm are particularly preferred. In this way, a stack of 2 CLB panels arranged side by side can be positioned and transported in an ISO container (20′-40′ container). At the same time, these dimensions were surprisingly well suited for the construction industry to cover large areas with minimal effort on-site.

The bamboo elements made of giant bamboo are surprisingly airtight, especially in 3-ply CLB panels with a minimum panel thickness of 3 cm or in 5-ply CLB panels with a minimum panel thickness of 5 cm, especially at least 9 cm. CLB panels are also particularly suitable for optional impregnation, especially moisture impregnation. If the rules of constructive wood construction are followed for the preferred bamboo building elements according to the invention, there will essentially be no risk of building damage due to wood-destroying insects or fungal infestation.

Cross-laminated bamboo panels are preferably CLB panels. “CLB” stands for Cross-Laminated Bamboo. The cross-laminated bamboo panels preferably comprise at least three stacked bamboo layers. Preferably, the first and third bamboo layers are endless bamboo layers B. A second bamboo layer is arranged between the first and third bamboo layers and is preferably an endless bamboo layer A. Regardless of the design of the bamboo layers used, the fiber direction of the second bamboo layer is preferably perpendicular to the fiber direction of the first and third bamboo layers. The three bamboo layers are preferably pressed together under a pressure between 0.15-1.5 N/mm². Purbond HB 110 1K Pur can be used as an adhesive. A width of the cross-laminated bamboo panel is preferably 1000-5000 mm, a thickness is preferably 30-300 mm, and a length is preferably 3000-18000 mm.

The combination of different fiber orientations, bamboo lamella orientations, glued layers, and large dimensions resulted in a surprisingly strong composite product that could be prefabricated and used for a very quick, easy construction. Due to the varying properties of the different layers, impacts from different directions could be surprisingly well absorbed, and the material was an excellent load bearer and very thin, preferably <5 cm. Additionally, the different layers prevented the spread of diffusion, mold, and other pollutants. For the achieved strength and durability, the CLB panels were surprisingly light and could be installed on-site with simple machinery.

In another preferred embodiment of the invention, two or more cross-laminated bamboo panels are glued and pressed together in the transverse direction to form endless cross-laminated bamboo panels using finger joint connections. The finger lengths are preferably 10-40 mm. A length of the endless cross-laminated bamboo panel is preferably 12000-30000 mm.

In another preferred embodiment of the invention, the cross-laminated bamboo panel comprises at least three, especially at least five stacked bamboo layers.

In yet another preferred embodiment of the invention, the cross-laminated bamboo panel comprises at least one insulation layer between two adjacent bamboo layers. In another preferred embodiment of the invention, the layers of the sandwich panel are bonded together by a pressure of 0.1-0.5 N/mm². The insulation layer preferably comprises a wood foam, wherein the wood foam preferably comprises bamboo wood residues. The insulation layer has a preferred density between 40 and 250 kg/m³, especially between 60-100 kg/m³. It has been found that the bamboo lamellae of the sandwich panel bond surprisingly well with the insulation material, thus forming a very strong, shock-absorbing, and durable element. It was also completely surprising that the construction process could be dramatically simplified by providing prefabricated insulated building elements.

The invention further relates to a method for producing a bamboo blank, bamboo lamella, bamboo layer, cross-laminated bamboo panel, ceiling element, and/or wall element, the method comprising the following steps:
Providing a plurality of bamboo lamellae from a giant bamboo species, wherein the bamboo lamellae have a thickness of at least 5 mm,
Gluing the plurality of bamboo lamellae fiber-parallel next to each other, wherein the gluing is carried out under a pressure of 0.05-1.5 N/mm²,
Optionally bonding the blanks to larger building elements with finger joint connections, bonding parallel to the fiber direction and/or cross-bonding, preferably with staggered finger joint seams.

In preferred embodiments of the invention, the provision of the plurality of bamboo lamellae includes the following steps:
Separation of a bamboo raw lamellae into a plurality of bamboo raw lamellae, wherein the bamboo raw lamellae comes from a giant bamboo species and the bamboo raw lamellae have a thickness of at least 5 mm, preferably by splitting the bamboo raw lamellae,
Processing the bamboo raw lamellae into bamboo lamellae by rough planing, steaming, drying, and/or fine planing.

In preferred embodiments of the invention, the method further comprises one or more of the following steps:
Removing bamboo skin and/or nodes, preferably by two-sided rough planing of the bamboo raw lamellae,
Optionally steaming the bamboo raw lamellae, preferably in an autoclave, preferably for at least 2 hours at temperatures of 70° C. 200° C.,
Optionally drying the bamboo raw lamellae at a temperature of 55° C. to 130° C., preferably 70° C.-80° C.,
Optionally fine planing the bamboo raw lamellae on at least two parallel surfaces, preferably on four surfaces to produce bamboo lamellae,
Optionally sorting the bamboo lamellae.

In further preferred embodiments of the invention, the method further comprises applying an adhesive to a fiber-parallel surface of a bamboo lamella before bonding with another bamboo lamella.

In another preferred embodiment of the invention, the method includes pressing the bonded bamboo lamellae into bamboo blanks in a cold pressing and/or high-frequency pressing process.

In another preferred embodiment of the invention, the method includes calibrating the bamboo blanks with a four-sided planer.

In another preferred embodiment of the invention, the method includes further processing the blanks with finger joint connections to form endless bamboo blanks.

In another preferred embodiment of the invention, the method includes bonding the endless blanks parallel to the fiber direction to form bamboo lamellae or bamboo layers, preferably with staggered finger joint seams.

In another preferred embodiment of the invention, the method includes bonding the bamboo lamellae and/or layers to larger, preferably refined and more complex components.

Some or all process steps are preferably carried out in an automated production line. The process steps preferably take place at a corresponding station in the production line. The bamboo raw lamellae, bamboo lamellae, bamboo blanks, or other elements are preferably transported between the stations by automated means such as conveyor belts, lifts, and cranes. The processing stations may include state-of-the-art machinery, such as precision cutting machines, rough planers, steam chambers, drying chambers, planers, scanners, sorting machines, glue application machines, and/or high-frequency presses.

A planer machine may be provided at a planing station. This can be configured for an exemplary processing speed of 4-40 m/min. The planer machine is preferably equipped with suction to quickly remove impurities, allowing for optimal glue application later on. As a non-limiting example, a MOULDTEQ M-300 machine (by HOMAG, Dürr Group) can be used.

A glue application station, for example, may be configured to process bamboo lamellae at a speed of 4-40 m/min. The station is preferably equipped with temperature control and air suction, for example, in a fully or semi-enclosed chamber, allowing for fast and secure processing of the bamboo lamellae.

To produce bamboo blanks and more complex bamboo elements, a through-feed press can be used at a pressing station. The through-feed press is preferably a high-frequency press. It is preferably designed for full-area pressing. The through-feed press preferably includes means for compensating for slight size differences in the bamboo lamellae or other elements. The through-feed press is preferably configured to automatically position the bamboo lamella or other elements in the machine. As a non-limiting example, the CABTEQ S-200, CABTEQ S-250, or CABTEQ T-200 (by HOMAG, Dirr Group) can be used.

Preferred process steps are schematically shown in FIG. 46 up to the blank (A and B) and discussed in detail in the exemplary embodiments in the detailed description.

The average person skilled in the art will recognize that technical features, definitions, and advantages of preferred embodiments of the bamboo elements (bamboo lamellae, bamboo layers, etc.) of the invention also apply to the inventive methods, and vice versa.

Terms such as “essentially,” “roughly,” “about,” “approx.,” etc., preferably describe a tolerance range of less than ±20%, preferably less than ±10%, more preferably less than ±5%, and especially less than ±1%, and include the exact value.

### BRIEF DESCRIPTION OF THE DRAWINGS

To illustrate various preferred embodiments of the invention, the following figures are provided. A detailed description of the preferred embodiments follows.

FIG. 1 shows a schematic representation of a cross-section through a bamboo lamella, showing the lamellae-forming regions.

FIG. 2 shows a schematic representation of a cross-section through a bamboo lamella without showing the bamboo raw lamellae.

FIG. 3 schematically illustrates a method for splitting a bamboo lamella into bamboo raw lamellae with radially arranged splitting knives.

FIG. 4 schematically illustrates a cross-section of a series of split pieces, which are processed into split, circular segment-shaped bamboo raw lamellae 4A.

FIG. 5 and FIG. 6 schematically illustrate a two-sided rough planing of the bamboo raw lamellae 4A.

FIG. 7 schematically illustrates that the pre-planed bamboo raw lamellae 4A are sorted by quality.

FIGS. 8A and 8B schematically show, with 16A, an autoclave for steaming bamboo raw lamellae 4A and with 16, a drying chamber, preferably a vacuum drying chamber for drying bamboo raw lamellae 4A.

FIG. 9 and FIG. 10 schematically illustrate a method for at least two-sided planing of bamboo raw lamellae, preferably four-sided planing. After planing, finished bamboo lamellae are produced.

FIG. 11 schematically illustrates a method for gluing and pressing bamboo lamellae arranged side by side along their narrow side (d) into blanks B.

FIG. 12 schematically illustrates a method for gluing and pressing blanks B into endless blanks B through finger joint connections.

FIG. 13 schematically illustrates a method for gluing and pressing stacked blanks B into bamboo lamellae B.

FIG. 14 schematically illustrates a method for gluing and pressing elongated bamboo lamellae B arranged in succession through finger joint connections into endless bamboo lamellae B.

FIG. 15 schematically illustrates a method for gluing and pressing bamboo lamellae arranged side by side into bamboo layers B.

FIG. 16 schematically illustrates a method for gluing and pressing elongated bamboo layers from blanks B through finger joint connections into endless bamboo layers B.

FIG. 17 schematically illustrates a method for gluing and pressing bamboo lamellae arranged side by side along their width (w) into blanks A.

FIG. 18 schematically illustrates a method for gluing and pressing elongated blanks A arranged in succession through finger joint connections into endless blanks A.

FIG. 19 schematically illustrates a method for gluing and pressing bamboo lamellae arranged side by side along their thickness into bamboo layers A.

FIG. 20 schematically illustrates a method for gluing and pressing stacked blanks A into bamboo lamellae A.

FIG. 21 schematically illustrates a method for gluing and pressing elongated bamboo lamellae A arranged in succession through finger joint connections into endless bamboo lamellae A.

FIG. 22A-22C schematically show a method for gluing and pressing endless blanks A into stronger and/or longer bamboo lamellae A. Preferably, the finger joint seams of the blanks A are staggered.

FIG. 23 schematically illustrates a method for gluing and pressing endless bamboo lamellae A arranged side by side into stronger bamboo lamellae and/or bamboo layers. Preferably, the finger joint seams of the bamboo lamellae A are arranged staggered during bonding.

FIG. 24 schematically illustrates a method for gluing and pressing endless blanks A arranged side by side into bamboo layers. Preferably, the finger joint seams of the bamboo lamellae A are arranged staggered during bonding.

FIG. 25 schematically illustrates a method for gluing and pressing a bamboo layer A with a spacer layer stacked below it to form a cross-laminated bamboo (CLB) panel. Preferably, the spacer layer is made with bamboo layers from blanks B.

FIG. 26 schematically depicts a method for gluing and pressing two bamboo layers A with an intermediate spacer layer to form a CLB panel. Preferably, the intermediate layer is made with bamboo layers from blanks B.

FIG. 27 schematically illustrates a method for gluing and pressing two bamboo layers A with an intermediate insulation layer to form a thermally bridging-free, insulated wall or roof element (also known as a “sandwich panel”).

FIG. 28 schematically illustrates a ribbed load-bearing element made of bamboo, particularly as a wall or ceiling element from a two-layer panel and bamboo lamellae, as well as a ribbed load-bearing element made of bamboo, particularly as a wall or ceiling element from a three-layer panel and bamboo lamellae.

FIG. 29 schematically depicts a hollow box element made of bamboo, particularly as a wall or ceiling element from two two-layer panels and bamboo lamellae, and a hollow box element made of bamboo, particularly as a wall or ceiling element from two three-layer panels and bamboo lamellae.

FIG. 30-33 schematically show multiple cross-sections of ribbed bamboo panels and hollow box elements that can be made from the bamboo lamellae and/or bamboo panels of the invention.

FIG. 34 schematically illustrates a method for gluing and pressing elongated bamboo layers A through finger joint connections into endless bamboo layers A.

FIG. 35 schematically illustrates a method for gluing and pressing bamboo layers A (middle layer) and bamboo layers B (outer layers) stacked crosswise and perpendicular to each other to form CLB panels. CLB can be made with bamboo layers A only or bamboo layers B only, optionally.

FIG. 36 schematically depicts a method for gluing and pressing elongated bamboo layers into endless bamboo layers through finger joint connections, using the general finger joint to form endless CLB panels.

FIG. 37 shows a preferred CLB panel comprising five bamboo layers B. Various even and odd numbers of layers are possible.

FIG. 38 depicts a sandwich element with an insulation layer, preferably wood foam, in the middle and two preferred CLB panels, which, by bonding the insulation layer with the CLB panels, form a composite panel.

FIG. 39 illustrates a wood-wood connector, particularly an X-Fix connector®, consisting of two parts. This exemplary technique can be used to connect the cross-laminated bamboo elements (CLB).

FIG. 40 demonstrates the implementation of the wood-wood connectors for connecting bamboo elements.

FIG. 41 schematically illustrates the connection of blanks by finger jointing into endless blanks.

FIG. 42 schematically illustrates the connection of endless blanks along their narrower elongated sides into bamboo lamellae of any cross-section.

FIG. 43 schematically illustrates the connection of bamboo lamellae by adhesive bonding into bamboo layers.

FIG. 44 schematically illustrates the pressing and bonding of multiple (at least two) bamboo layers into cross-laminated bamboo elements (CLB panels).

FIG. 45 schematically illustrates the pressing and bonding of two CLB panels comprising an insulation layer into a sandwich panel.

FIG. 46 schematically depicts preferred steps in processing bamboo into bamboo lamellae, blanks, bamboo lamellae, and other bamboo elements.

FIG. 47 shows the processing of bamboo into split pieces, planed bamboo lamellae, calibrated, and dried bamboo lamellae.

FIG. 48 illustrates an inventive bamboo rod during an edge-wise bending test.

FIG. 49 graphically depicts the results of edge-wise bending tests of a bamboo rod A according to the invention.

FIG. 50, 51, and FIG. 52 show an inventive bamboo rod during an edge-wise bending test with shear failure.

FIG. 53 illustrates an inventive bamboo rod during a flat-wise bending test.

FIG. 54 graphically shows the results of flat-wise bending tests of several bamboo rods according to the invention.

FIG. 55 and FIG. 56 depict an inventive bamboo rod A during a bending test of the finger joint between two blanks A joined at the end faces.

FIG. 57 graphically presents the results of the bending test of the finger joints of several bamboo rods according to the invention.

FIG. 58 schematically illustrates a glulam beam made of bamboo rods 51 and cross-laminated timber (LVL) 55.

FIG. 59 schematically depicts a T-beam made of bamboo rods 51 and cross-laminated timber (LVL) 55.

FIG. 60 schematically illustrates a double-T-beam made of bamboo rods 51 and cross-laminated timber (LVL) 55.

FIG. 61 schematically illustrates a ceiling element made of T-beams and wood composite panels 59.

FIG. 62 schematically illustrates a ceiling element made of double-T-beams and wood composite panels 59.

### DETAILED DESCRIPTION OF PREFERRED EMBODIMENTS

In the following, the invention will be explained in more detail by means of examples and figures, without being limited to these.

The invention relates to several bonded bamboo elements that can either act as load-bearing components themselves or be part of a load-bearing component. These high-performance elements made of giant bamboo can take the form of blanks, rods, layers, or cross-laminated bamboo panels. The components may also comprise a combination of rod-shaped and panel-shaped elements, such as ribbed ceiling, roof, or wall elements, hollow box elements for walls, ceilings, and roofs, or sandwich panels or roof trusses. The preferred inventive components are glued from bamboo lamellae derived from at least one species of giant bamboo. The preferred components are surprisingly well-suited for constructing structures.

Giant bamboo rods are preferably harvested for this purpose. The bamboo rods are cut to a usable and transportable length with saws, such as chainsaws. The length is measured in the direction of the bamboo fibers. It is particularly preferred that the average or uniform length of the cut bamboo rods is at least 2000 mm. Preferably, the length ranges from 1000 to 3000 mm. At this stage, the bamboo rods can already be sorted by bamboo species, diameter, wall thickness, and/or quality. The bamboo canes are preferably sorted automatically with scanners to maintain production capacity.

Bamboo is preferably harvested and processed no earlier than 3 years. The bamboo lamellae are preferably cut from the lower 7-10 m of the bamboo rod.

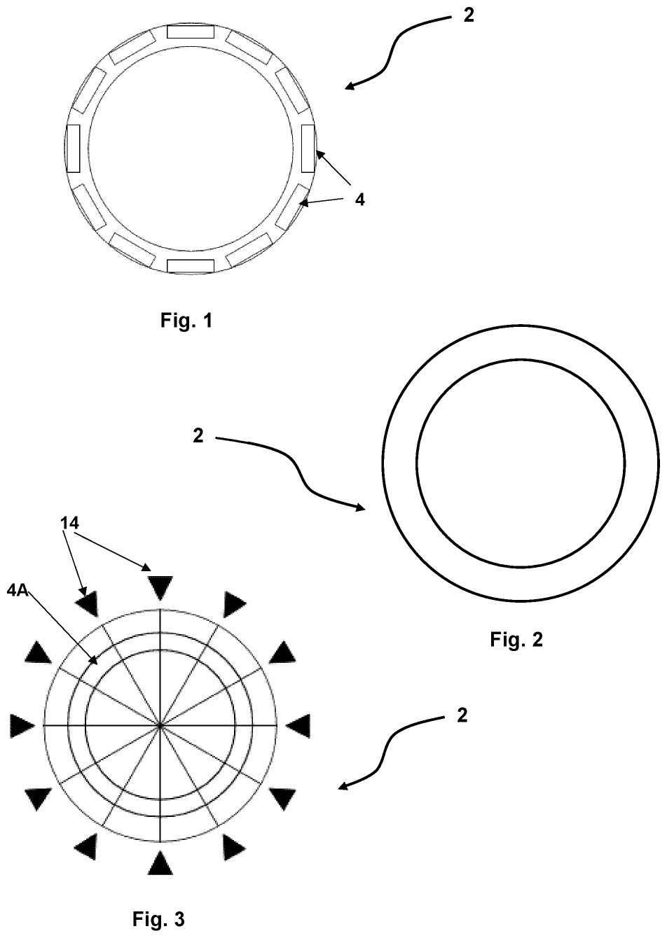

FIGS. 1-10 show the preferred method for separating the bamboo canes and preparing bamboo lamellae for use in the preferred bamboo elements according to the invention. FIG. 1 schematically illustrates a cross-section through a bamboo rod, with the finished bamboo lamellae 4A shown here. In FIG. 2, the cross-section intersects perpendicular to a direction of the fibers in the bamboo rod. FIG. 3: The circumference of the bamboo rod can be divided into twelve bamboo lamellae, 4. Preferably, the bamboo rods are split into 6-20 split pieces with star-shaped splitting knives. The number and size of the bamboo lamellae, 4A, are adjusted according to the diameter and wall thickness of the harvested giant bamboo. The number and size of the bamboo raw lamellae, 4A, can vary depending on the growth size and type of bamboo.

After the process of FIG. 1-10, the bamboo raw lamellae, 4A, are preferably sorted according to strength, defects, dimensional accuracy, and appearance before being pre-planed. Sorting can be done visually, mechanically, or electronically. Bamboo lamellae for visible components are preferably sorted according to stricter criteria. They should preferably have better optical quality. During sorting, unattractive growth variations, defects, non-dimensionally stable, and/or twisted bamboo lamellae can be sorted out.

FIG. 2 shows a cross-section of a bamboo stalk 2. FIG. 3 schematically illustrates a first method for splitting the bamboo stalk 2 into bamboo raw lamellae, 4A. In this method, one or more splitting knives 14 are arranged around the circumference of the bamboo stalk. Preferably, a single star-shaped splitting knife is used for this purpose. The splitting knives 14 are preferably arranged in a star-shaped device and evenly distributed radially. The number of segments of the splitting knives is preferably variable depending on the diameter of the bamboo stalks. The splitting knives divide the bamboo stalks according to a pattern into at least 6, preferably at least 8 slightly curved bamboo raw lamellae, 4A, (also referred to as “split pieces” or “circular segments” within the scope of this invention) of the same size. The number and size of the bamboo raw lamellae per bamboo stalk are only exemplary here.

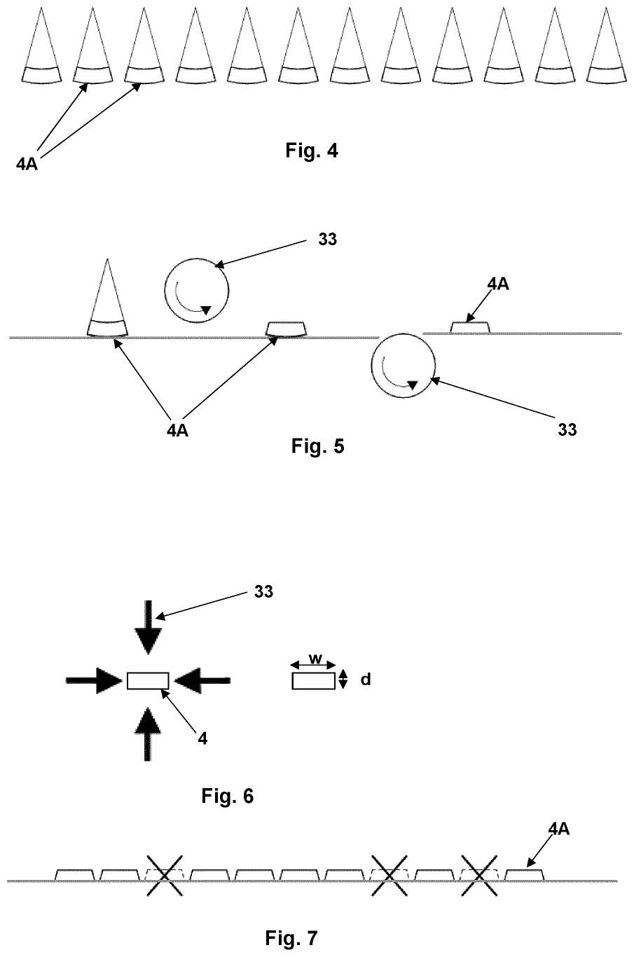

FIG. 4 schematically illustrates (in cross-section) the twelve separated bamboo raw lamellae, 4A. As can be seen, these have a curved shape that can be modified for certain further processing. The freshly separated bamboo lamellae also have a high water content, which affects their structural properties and subsequent processability. Although the curved lamellae depicted here are identical, they may exhibit slight variations in size and shape in reality due to natural variations within and between bamboo plants. It is therefore preferred to subject the bamboo lamellae to various processing and standardization processes before use in the preferred bamboo elements.

FIG. 5 shows a two-sided pre-planing process in which the interlayers and outer skin of the bamboo raw lamellae are removed. The interlayers preferably define the concave inner surfaces of the bamboo lamellae, while the outer skin is defined by the convex, outwardly curved surface of the freshly harvested bamboo lamellae. This process is further illustrated in FIG. 6 schematically, with the thickness d and width w of the pre-planed bamboo raw lamellae also shown. After the pre-planing process, the bamboo raw lamellae has two parallel sides.

FIG. 7 schematically illustrates how the pre-planed bamboo raw lamellae are sorted by quality in an optional step.

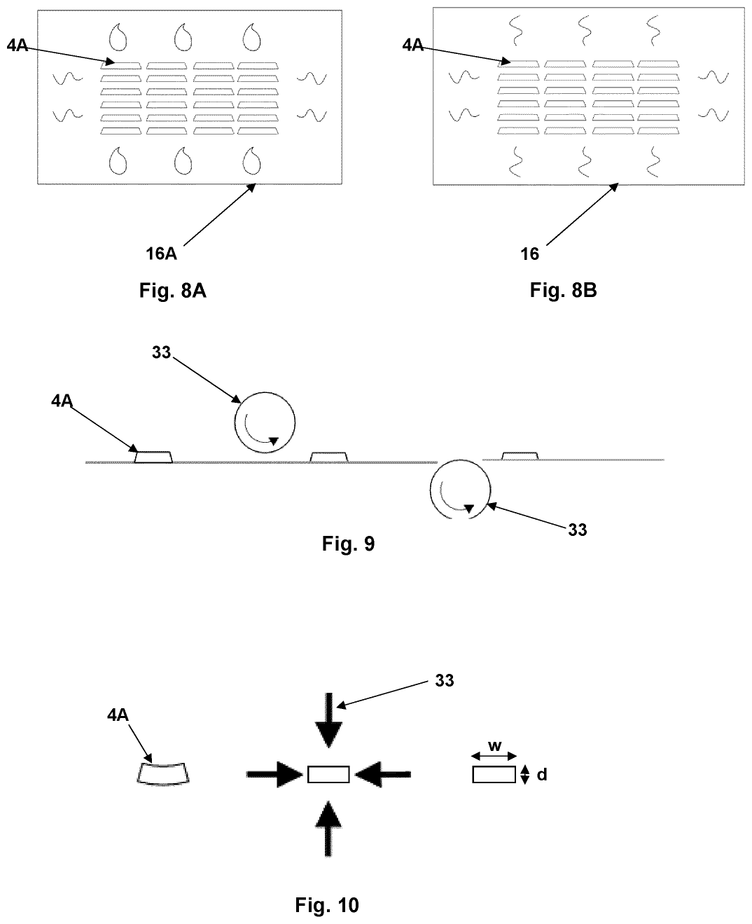

FIG. 8A schematically illustrates an autoclave in which the pre-planed bamboo raw lamellae are steamed at temperatures of 70° C.-200° C. for at least 2 hours. The steaming process reduces the starch and sugar content of the bamboo lamella to preferably <5%. Without being bound to any particular theory, it is believed that the steaming process reduces the nutrient content of the bamboo, attracting insects and microorganisms. Additionally, it has been found that the bamboo lamellae can be made more uniform, dimensionally stable, and straight. Furthermore, it has been found that the bamboo lamellae are even more precise and dimensionally stable when the steaming process is repeated.

FIG. 8B schematically illustrates a drying chamber 16 in which the bamboo lamellae 4 are dried. It is preferred to dry the bamboo lamellae for at least 6 hours at a temperature of at least 55° C., preferably 70° C., to a wood moisture content of 3-12%±2%. A temperature of 100° C. is preferably not exceeded during drying, even more preferably 90° C., and even more preferably 80° C. Therefore, the most preferred temperature for the drying process is 70-80° C. The drying chamber can operate continuously (e.g., as a through dryer) or in batch form. Vacuum drying chambers are preferably used. To avoid cracking or twisting of the bamboo lamellae, the temperature is slowly and evenly raised after introducing fresh bamboo lamellae.

Before use in the bamboo elements, it is preferred to standardize the cross-section of the bamboo lamellae so that they all have a cross-section of the same shape and dimensions. It is particularly preferred that the shape is rectangular. It should also be noted that different cross-sections may be suitable for different elements or different parts of the same component. A production plant should be able to react flexibly to the different wall thicknesses, diameters, and lengths of the bamboo tube 2 in order to maximize the yield of the bamboo lamellae and to be able to produce different cross-sections of bamboo lamellae 4.

In this embodiment, the cross-section is calibrated after drying by planing on at least two sides, parallel to the natural fiber direction, as schematically illustrated in FIG. 9. All bamboo lamellae are given a cross-section with the most uniform thickness, d. The width, w, of the bamboo lamellae is preferably 20-70 mm. The thickness, d, of the bamboo lamellae is preferably 5-40, especially 7-35 mm. The length of the bamboo lamellae can also be standardized to an exemplary length of 1000-3000 mm here. It is also possible and may be preferred to standardize the width of the bamboo lamellae by four-sided planing.

The wood chips and waste generated in this process can be further processed as insulation material, e.g., reused as wood foam layers in a preferred bamboo element according to the invention. The result of the process depicted in FIG. 1-10 is surprisingly dry, stable, uniform, dimensionally accurate, smooth, straight, low-sugar, and low-starch bamboo lamellae that can be used as building blocks in subsequent processes.

The bamboo lamellae resulting from the above-described process are then optionally sorted again to ensure that only bamboo lamellae with the required properties, without defects (fungus and insect infestation), and of the required quality are used in the preferred bamboo elements according to the invention. Sorting can be done visually, mechanically, or electronically. Additional criteria, such as aesthetic criteria, can be applied to bamboo lamellae intended for visible components. Bamboo lamellae with unacceptable natural deformations can be sorted out, cut, and/or recycled. The finished bamboo lamellae can preferably be classified according to their strength and appearance (for visual quality) and then assigned to different layers or parts of bamboo elements as needed. The finished bamboo lamellae are preferably sorted automatically with scanning devices according to criteria such as beetle infestation, dimensional accuracy, parallelism, perpendicularity.

The quality and sorting criteria, especially for cross-laminated timber components, can be established in accordance with or according to EN 13017-1. Several surface qualities are available:
Excellent surfaces,
Visual surfaces,
Industrial visual surfaces, and
Industrial (non-visual) surfaces.

High-performance bamboo components made from blanks A and B have a preferred wood moisture content of 3-10%±2%.

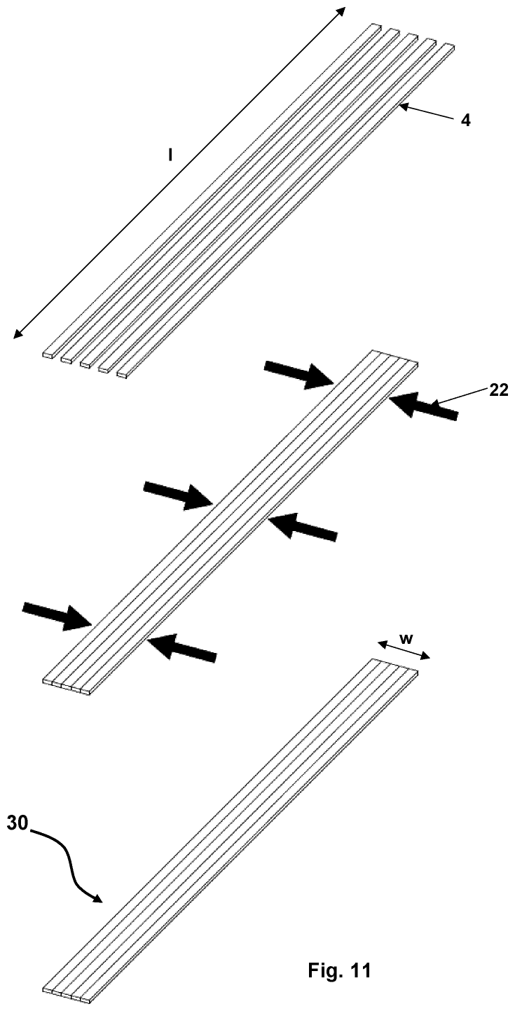

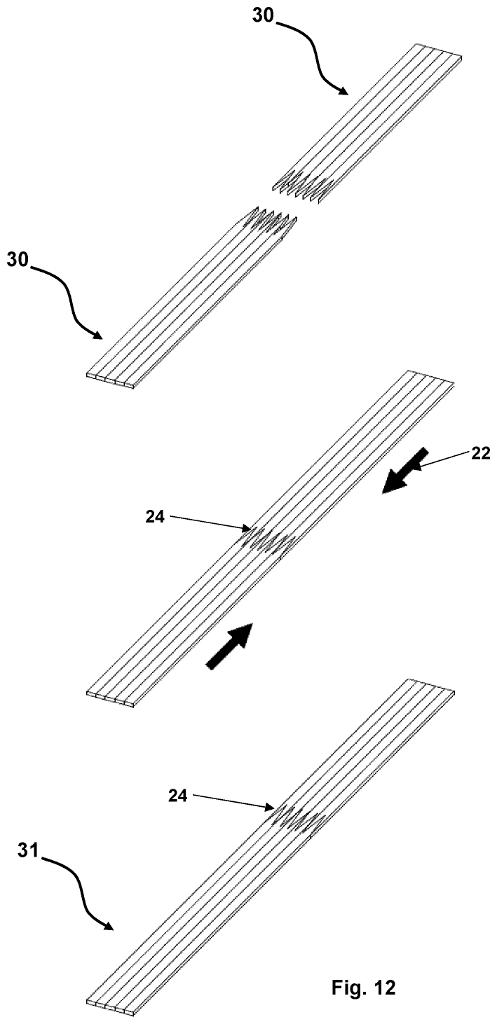

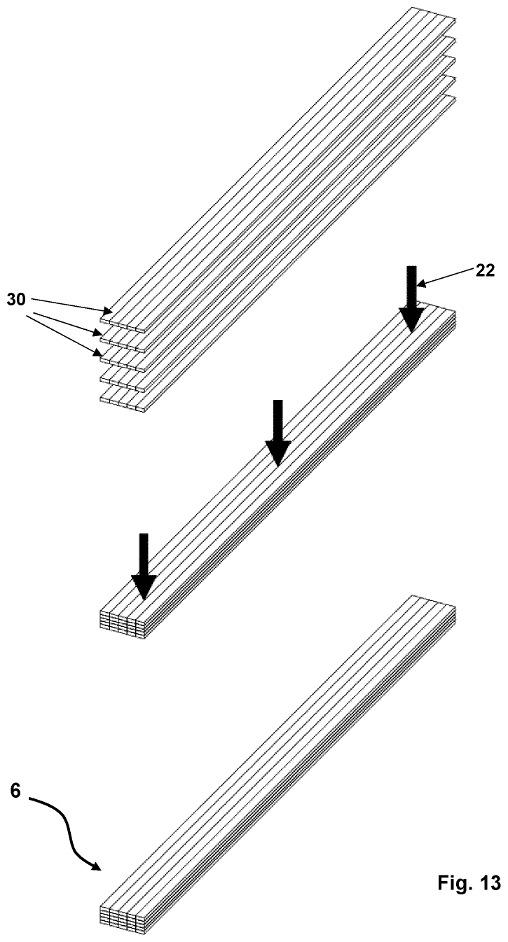

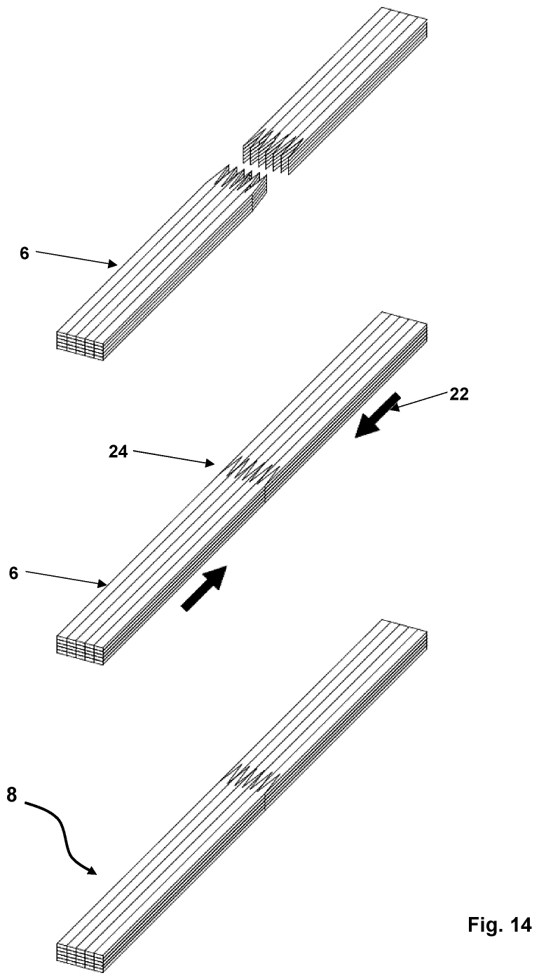

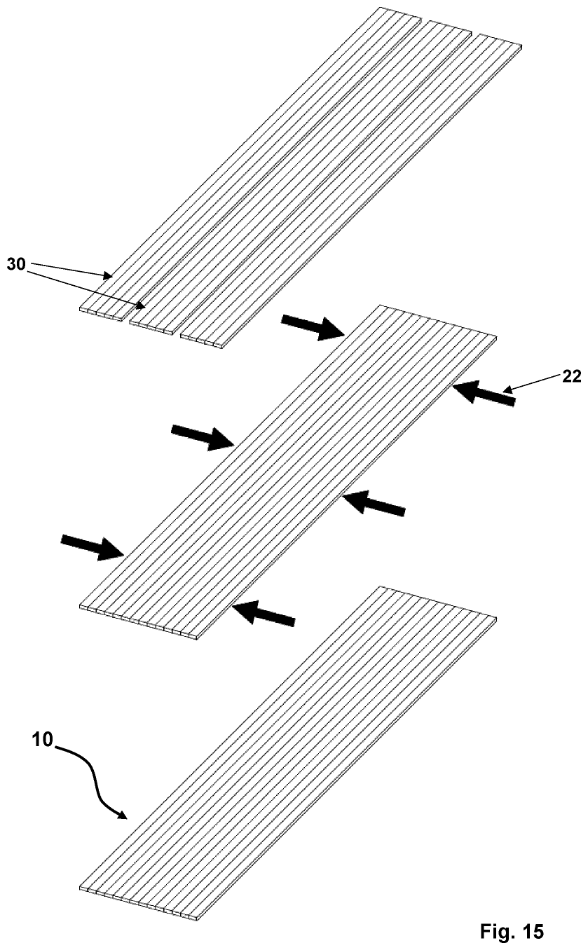

FIG. 11 schematically illustrates a method for producing blanks B, which can function as a component (or subunit) for a more complex bamboo element according to the invention. Here, a plurality of bamboo lamellae, preferably at least five, are provided and arranged side by side. An adhesive suitable for bamboo is then applied along the narrow sides of the bamboo lamellae. The quantity and type of adhesive should be selected so that a transparent adhesive joint of preferably up to 0.3 mm can form between the bamboo lamellae. The adhesive Purbond HB 110 1K Pur has proven to be effective here. Adhesives such as MUF and melamine resin have also proven to be suitable. However, a bio-based formaldehyde-free adhesive is particularly preferred.

It is preferred that a glue joint thickness of up to 0.3 mm be achieved between bonded blanks, bamboo rods, bamboo layers, and/or cross-laminated timber components.

The bamboo lamellae are pressed together in the directions of the thicker arrows of FIG. 11 by means of a pressing force 22. The pressing process can be carried out in a pressing device. A pressing pressure between 0.15-1 N/mm² is preferably used. The resulting part 30 is referred to as blank B. It is preferred to use a pressing pressure between 0.15-1 N/mm². The resulting part 30 is referred to as blank B. Blank B has a preferred thickness between 5-40 mm, especially 7-35 mm, and a preferred width between 60-300 mm.

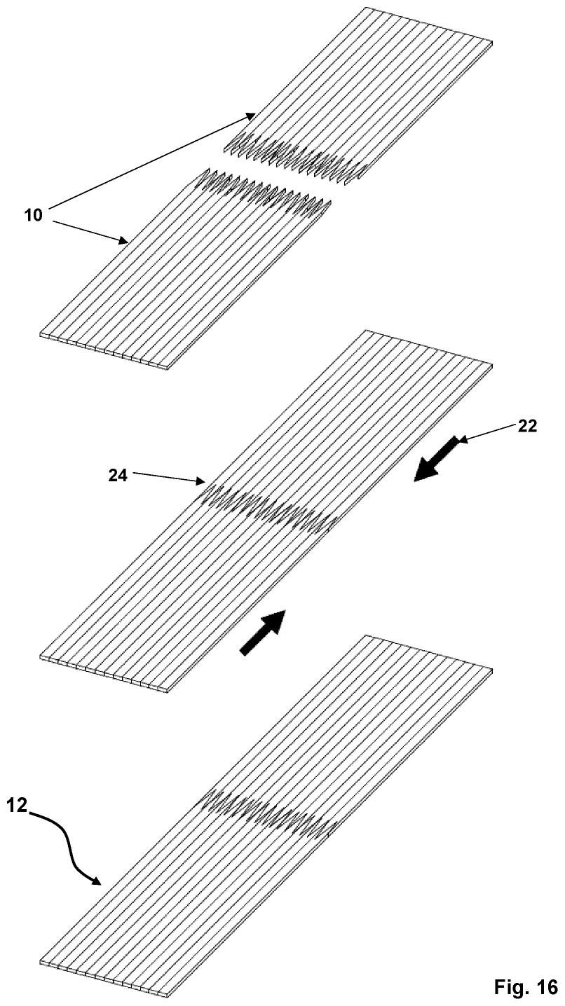

FIG. 12 illustrates a method for connecting multiple longitudinally aligned blanks B 30 to endless blanks B. In the context of the invention, the term “endless” refers to any length, especially a length of at least 500 mm, at least 1000 mm, at least 2000 mm, at least 10000 mm, or more.

These endless blanks are connected by means of the finger joints 24 using adhesive and a pressing force 22 to form a cohesive bond. To produce the finger joints, a finger-like edge is cut into or at the ends (the smallest surfaces) of the blanks B. These cuts run essentially longitudinally, i.e., in the direction of the grain. The formed finger-like protrusions may have a preferred length between 10-40 mm, preferably at least 15 mm.

The adhesive used and the pressure applied can be the same as in the production of blanks from bamboo lamellae or another suitable adhesive. The same adhesive or another suitable adhesive, pressure, and dimensions of the finger joints can also be used when joining bamboo rods, bamboo layers, cross-laminated timber elements, etc. The resulting “endless” blank B preferably has a length between 2000-18000 mm.

Blank B or the “endless” blank B may represent a preferred bamboo element according to the invention. If this is to be the end product, a finishing process is also preferred. This may include one or more steps such as planing, surface treatment by grinding, surface treatment by moisture impregnation, and/or quality control.

FIG. 13 illustrates a method for connecting multiple, preferably at least five, stacked (optionally endless) blanks B 30 to form a bamboo rod B 6. An adhesive is preferably applied between the blanks B 30. A pressing force 22 is also preferably applied in the direction of the thicker arrows. This results in a cohesive bond between the blanks 30. The resulting bamboo rod B preferably has a width between 50-400 mm and a thickness between 50-400 mm.

Multiple bamboo rods B can also be connected, as shown in FIG. 14, to form endless bamboo rods using finger joints. The (optionally endless) bamboo rod B can also be considered a preferred end product according to the invention. In this case, a finishing process as described above is still preferred. It is preferred that the finger joints of the bamboo rods B be staggered when glued together, as shown in FIG. 22A-C.

FIG. 15 illustrates a method in which multiple blanks B 30 are glued and pressed together along 5 their narrow side (their narrower elongated surface) to form bamboo layers B. A pressing force 22 is preferably applied in the direction of the thicker arrows. The resulting bamboo layers 10 preferably have a width between 200-4000 mm and preferably a thickness between 10-400 mm. A suitable press can be used for this process.

FIG. 16 shows how multiple bamboo layers B 10 can be joined together by finger joints 24 to form endless bamboo layers with larger dimensions and measurements. An adhesive and a pressing force 22 are also used here. The resulting endless bamboo layer B 12 preferably has a length between 2000-30000 mm.

Both the bamboo layer B 10 and the endless bamboo layer B 12 are considered preferred inventive end products. A finishing process as described above is also preferred here. The edges of the bamboo layers can also be trimmed with saws or mills. Alternatively or additionally, the bamboo layers can be constructed into cross-laminated timber elements, rib elements, and/or hollow box elements.

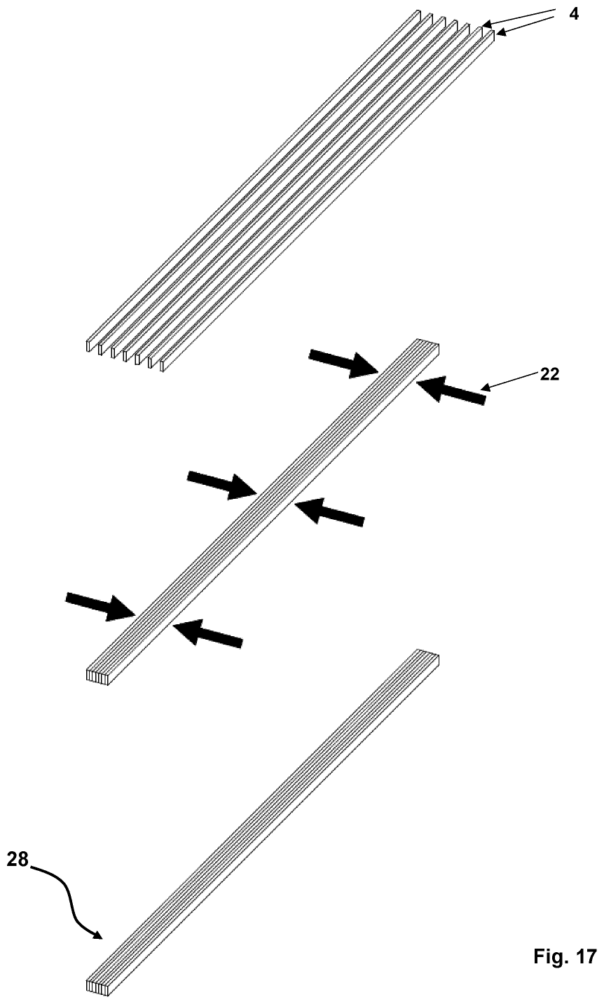

FIG. 17 illustrates a method for producing blanks A from a plurality, preferably at least five, of bamboo lamellae 4. The bamboo lamellae are glued and pressed together along their wide side w (their wider elongated surfaces). A pressing force 22 as described above is preferably applied here as well. The adhesive joint is preferably also configured according to the criteria mentioned 25 above with a thickness of up to 0.3 mm. The resulting parts 28 are referred to as “blanks A”. The blanks A preferably have a thickness between 20-70 mm and a width between 60-300 mm.

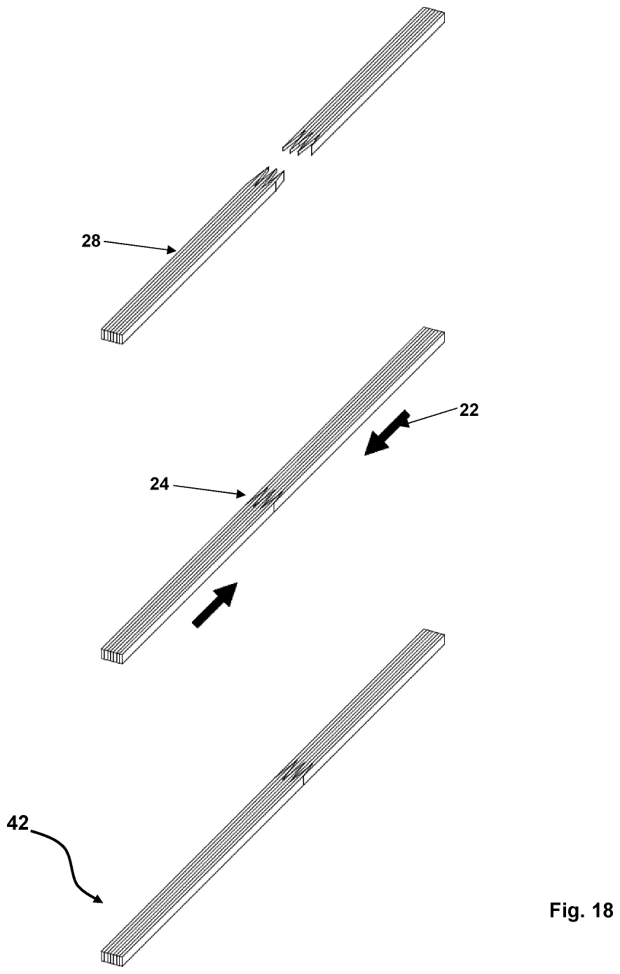

FIG. 18 shows how the blanks A can be connected by finger joints 24 using adhesive and a pressing force 22 to form endless blanks A 42. These endless blanks 42 have a preferred length of 30 2000-18000 mm.

These blanks can also serve as the end product, with a finishing process being preferred. Alternatively, the (optionally endless) blanks A can be further processed as a component of a more complex bamboo element.

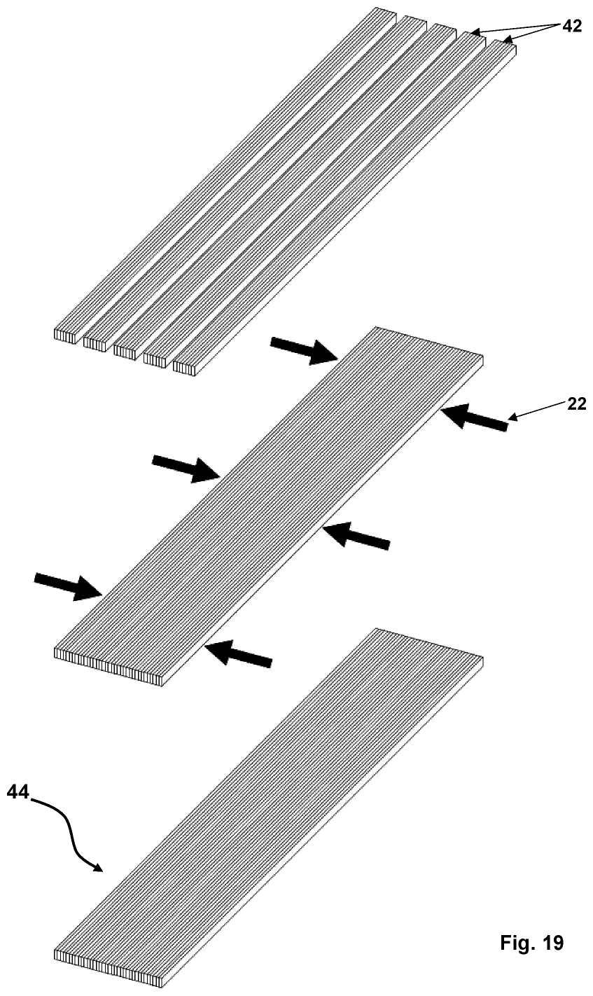

FIG. 19 illustrates the production of a bamboo layer 44 from several, preferably at least five, adjacent blanks A. The blanks A are pressed and glued together along their thicknesses using adhesive and a pressing force 22. The resulting layers preferably have a width between 200-4000 mm and a thickness between 10-400 mm. Analogous manufacturing conditions as described above can also be applied here.

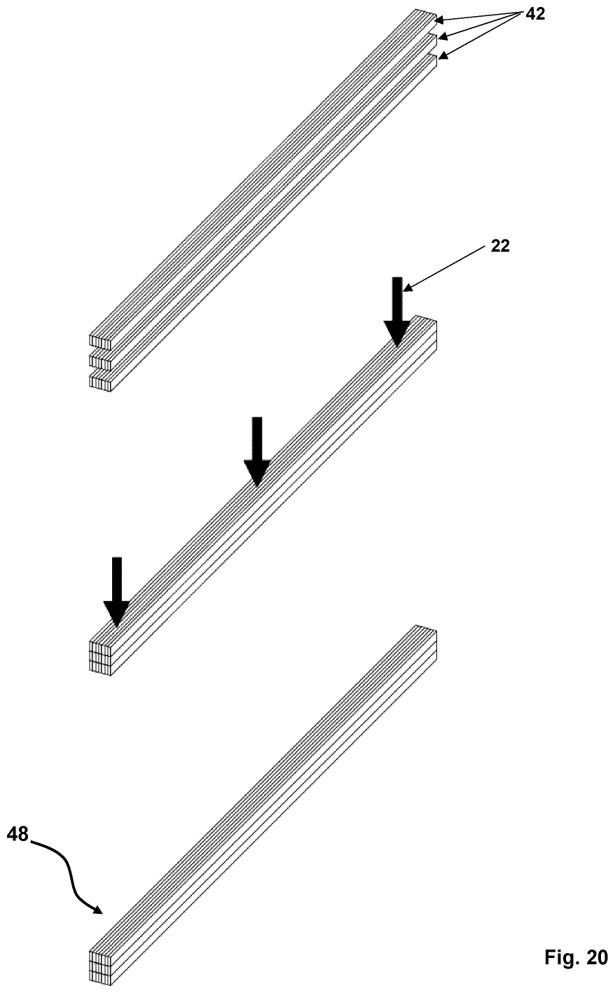

FIG. 20 shows the production of a bamboo rod 48 from several stacked blanks A. The blanks are 5 pressed and glued together using adhesive and a pressing force 22. This produces the bamboo rods A 48. The bamboo rod 48 preferably comprises at least two or at least three stacked blanks A 42. These can be glued and pressed together along their widths w by adhesive. A glue as described above and a pressing force 22 are preferably used here. The bamboo rod 48 has a preferred width between 50-400 mm and a preferred thickness between 50-400 mm.

FIG. 21 illustrates the production of endless bamboo rods A 50. The bamboo rods A 48 are provided with finger joints and connected to each other using a pressing force and adhesive. Both the bamboo rods A 48 and the “endless” bamboo rods A 50 can be considered as end products and subjected to the finishing process described above. The endless bamboo rods A 50 have a 15 preferred length between 2000-30000 mm. It is preferred that the finger joints of the bamboo rods A be staggered when glued together, as shown in FIG. 22A-C.

FIG. 22A shows the production of an endless bamboo rod A 51 from several endless bamboo blanks A 42. The several blanks glued together by fingering can be glued together with the help of a glue press to form an endless, reinforced bamboo rod 51 (referred to as “beam” or “HBB beam” in this text). The finger joints 24 are preferably arranged staggered. The joints of the finger joints of the adjacent blanks should preferably be staggered by half the distance A (the elongated distance between two successive finger joints in an endless blank), as shown in FIGS. 22A and 22B. FIG. 22A is a top view of the width of the bamboo rod 51, while FIG. 22B is a side view showing its thickness.

Staggering the finger joints eliminates the weak point of the finger joint, allowing the rod to be statically set through. An endless rod A, which has homogeneous properties despite the finger joints, is achieved. The bamboo rods produced in this way have surprising advantages over the 30 prior art. Staggering the finger joint to the adjacent layer has proven to be particularly advantageous, preferably applicable to all previous, inventive beams and layers, and increases the load-bearing capacity of the components.

FIG. 23 shows how the endless bamboo rods A 51 are glued together using a glue press to form bamboo rods 51A with larger cross-sections (or bamboo layers or bamboo panels). Here, too, the finger joint seams are preferably arranged staggered. The finger joints of the superposed endless bamboo blanks are preferably offset by half of the elongated distance A between successive finger joints. Staggering the finger joints eliminates the weak point of the finger joint, allowing the rod to be statically set through. An endless rod A, which has homogeneous properties despite the joints, is achieved. Staggering the finger joint to the adjacent layer has proven to be a particularly advantageous feature, which is preferably applicable to all previously described rods, and increases the load-bearing capacity of the components.

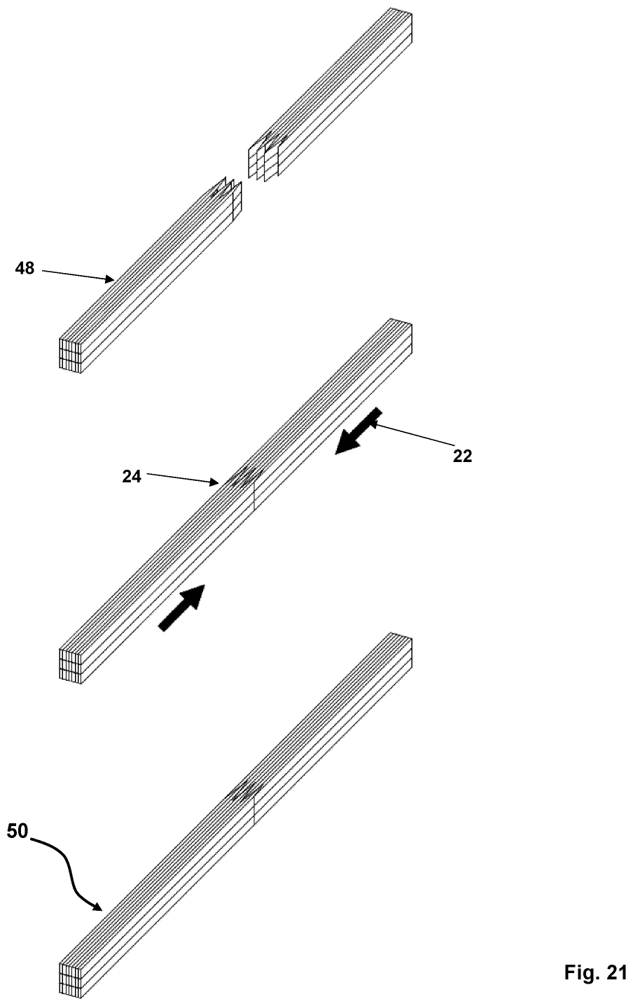

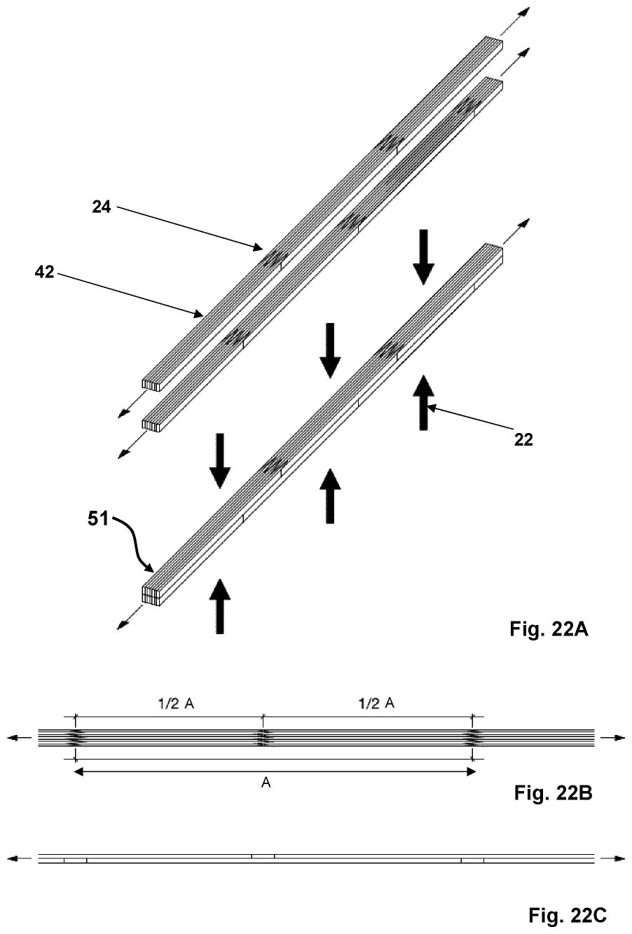

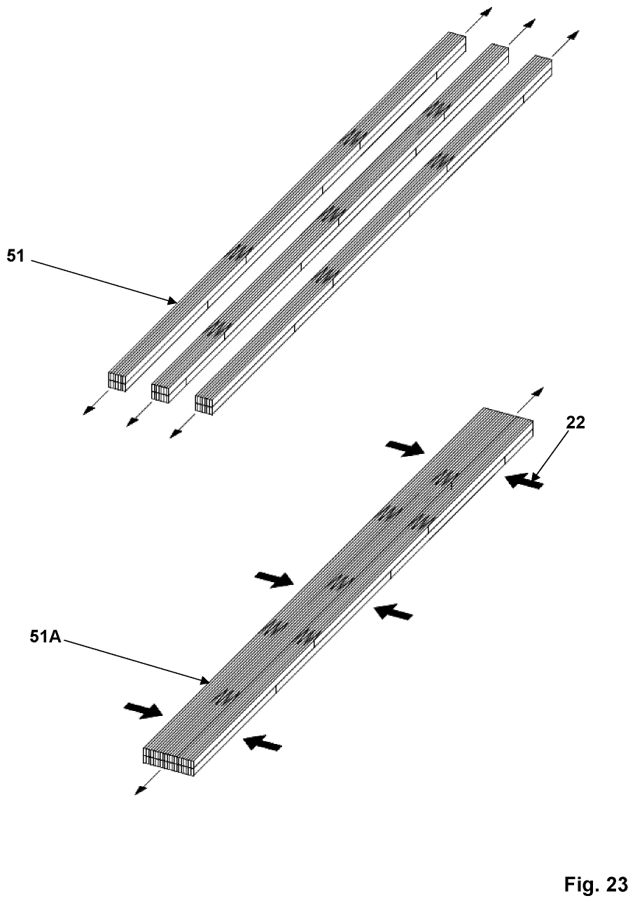

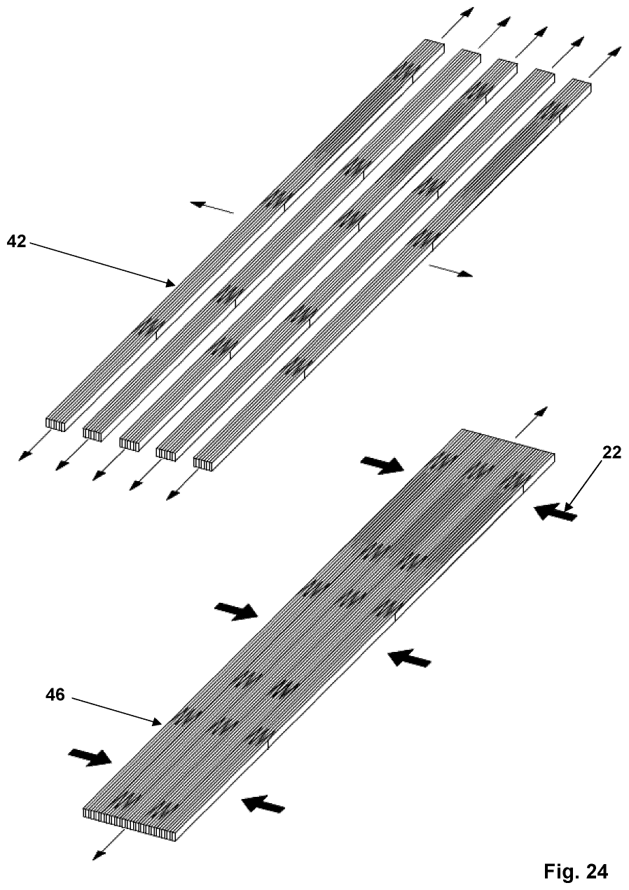

FIG. 24 schematically illustrates how the blanks glued by finger joints (“endless” blanks A 42) are glued together with the help of a glue press to form an endless bamboo layer 46. The finger joints of the adjacent blanks are preferably arranged offset. Preferably, the finger joints of adjacent layers are staggered by half of the elongated distance between successive finger joints. Staggering the finger joints eliminates the weak point of the finger joints, so that the bamboo layers 46 can be statically homogeneous. An endless bamboo layer 46 thus has homogeneous properties despite the joints. Staggering the finger joint to the adjacent endless blanks has proven to be a particularly advantageous feature, which is preferably applicable to all previously described layers and increases the load-bearing capacity of the components.

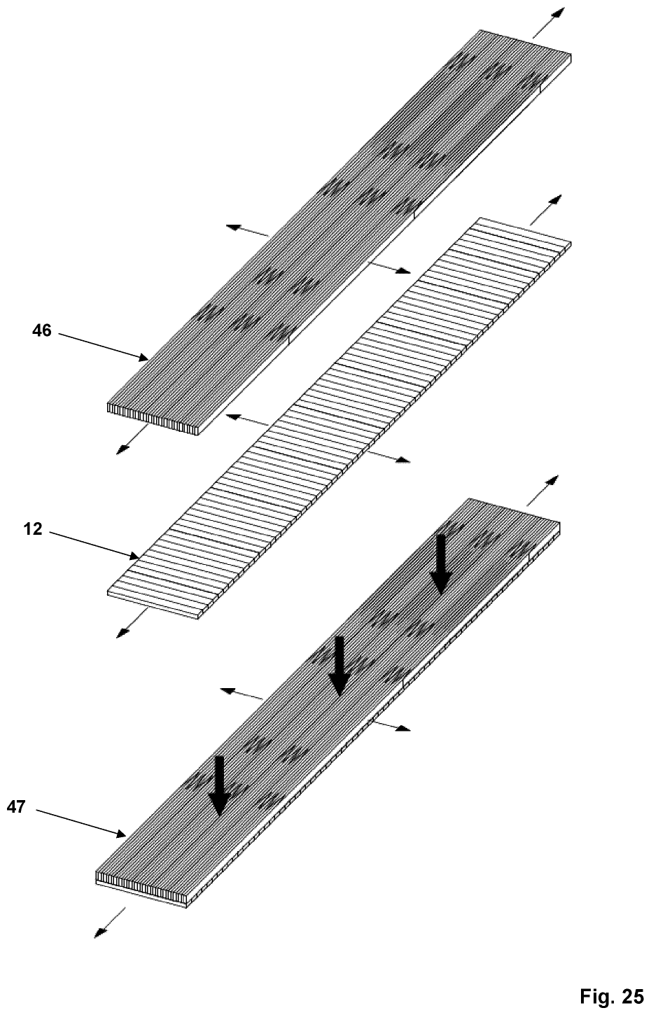

FIG. 25 schematically illustrates the connection of two endless bamboo layers to form a two-layer endless bamboo layer 47. A first endless bamboo layer 46 comprises blanks A, as shown in FIG. 24. A second underlying endless bamboo layer 12 is a barrier layer and comprises several blanks B. The bamboo lamellae of the barrier layer are connected to each other along their narrow sides, while the bamboo lamellae of the first layer are connected along their broad sides. This allows bamboo layers of different thicknesses and fiber directions to be combined. The fiber direction of the bamboo lamellae of the barrier layer is orthogonal to the fiber direction of the bamboo lamellae of the first layer. In an alternative embodiment not shown, the bamboo lamellae of the barrier layer may be connected to each other along their widths (blanks A). Preferably, the two layers are connected with a glue press, a similar pressing force, and a similar adhesive as described above for connecting blanks. Staggering the finger joints eliminates the weak point of the finger joints, so that the bamboo layer 46 can be statically homogeneous. An endless bamboo layer 46 thus has homogeneous properties despite the joints. Staggering the finger joint to the adjacent endless blanks has proven to be a particularly advantageous feature, which is preferably applicable to all previously described bamboo layers and increases the load-bearing capacity of the components.

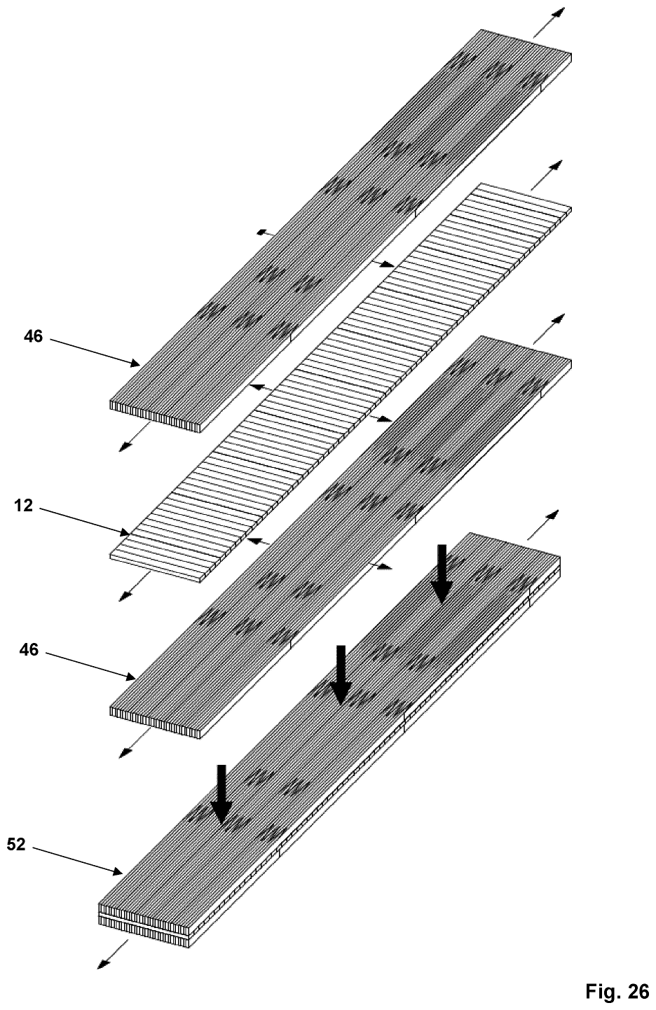

FIG. 26 schematically illustrates the connection of three bamboo layers 46, 12, 46 to form a three-layer cross-laminated timber element made of giant bamboo (CLB panel) 52. The three-layer CLB panel 52 is produced analogously to the two-layer endless bamboo layer 47 of FIG. 25, with a third layer 46 arranged below the barrier layer 12. The third layer is preferably constructed analogously to the first layer 46. Preferably, the three layers are connected with a glue press, a similar pressing force, and a similar adhesive as described above for connecting blanks. Staggering the finger joints eliminates the weak point of the finger joints, so that the bamboo layers 46 can be statically homogeneous. An endless bamboo layer 46 thus has homogeneous properties despite the joints. Staggering the finger joint to the adjacent endless blanks has proven to be a particularly advantageous feature, which is preferably applicable to all previously described bamboo layers and increases the load-bearing capacity of the components.

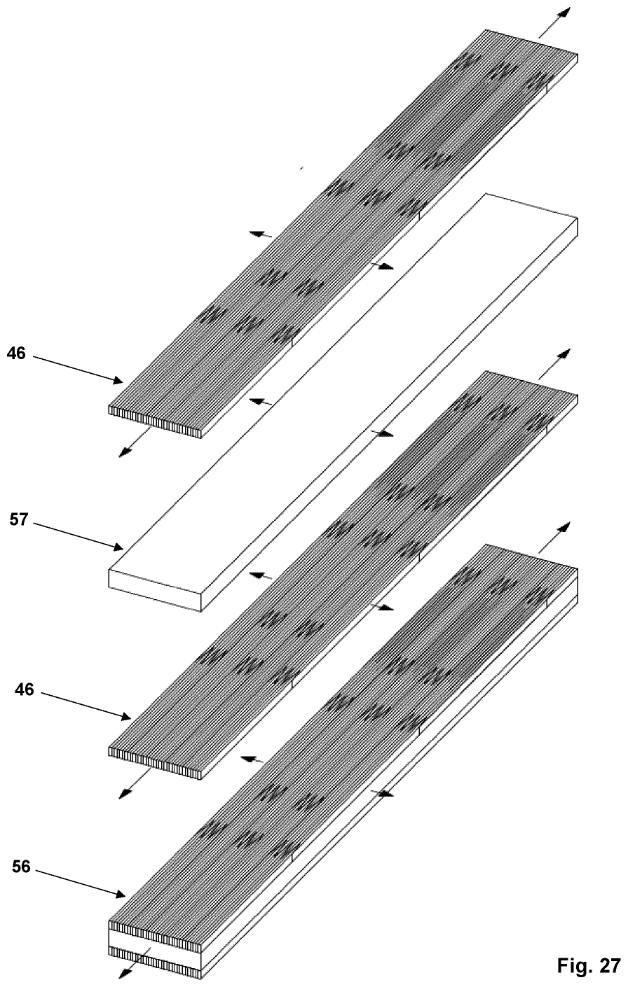

FIG. 27 schematically illustrates the connection of two endless bamboo layers A 46 with an intermediate insulation panel 57 to produce a sandwich panel 56. By arranging a rigid insulation panel 57 as the middle layer, a sandwich panel 56 is preferably produced using a glue press. Preferably, the three layers are connected with a similar pressing force and adhesive as described above for connecting blanks. Staggering the finger joints eliminates the weak point of the finger joints, so that the bamboo layers 46 can be statically homogeneous. An endless bamboo layer 46 thus has homogeneous properties despite the joints. This is a key highlighting feature of the invention. Staggering the finger joint to the adjacent endless blanks has proven to be a particularly advantageous feature, which is preferably applicable to all previously described bamboo layers and increases the load-bearing capacity of the components.

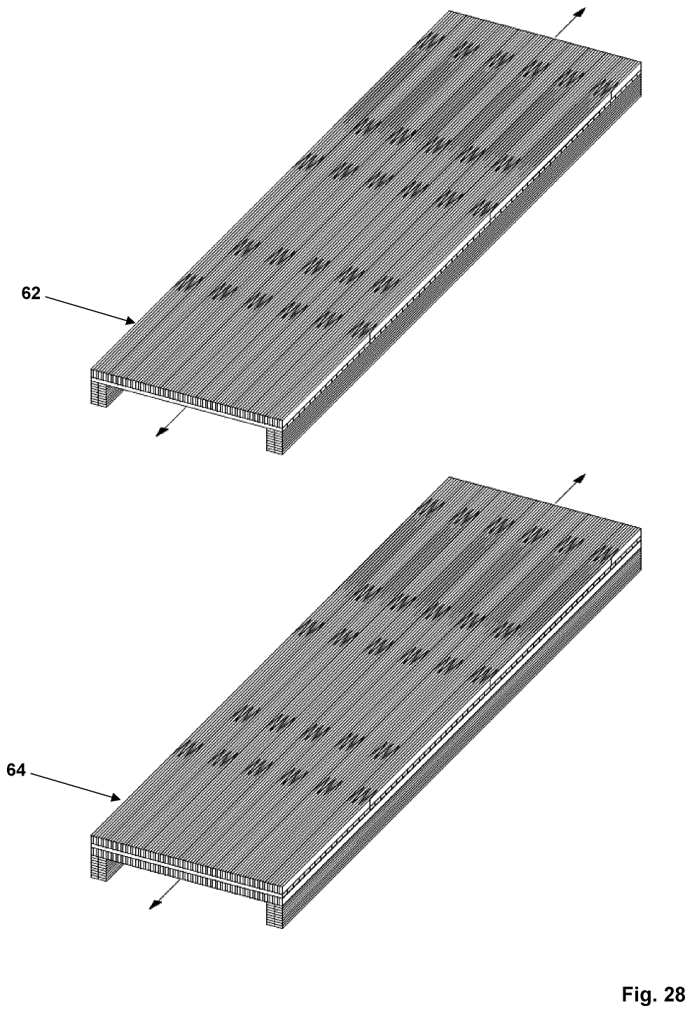

FIG. 28 schematically illustrates the production of another bamboo element 62, referred to herein as a “rib element,” “rib panel,” or “ribbed ceiling” according to the invention. By crosswise gluing a two-layer bamboo panel 47 (preferably analogous to FIG. 25) with an orthogonally arranged bamboo rod (e.g., bamboo rod A 48) using a glue press, the ribbed panel can be produced. A main plane of the bamboo rod, which runs along the aligned bamboo fibers and passes through several of its bamboo lamellae, is preferably orthogonal to a main plane of the bamboo panel. This results in a bamboo element with a U-shaped cross-section. The dimensions of the U-shaped cross-section may depend on the desired application. The example shown depicts relative dimensions suitable for use as a reinforced wall or ceiling. Alternatively, a bamboo panel with a narrower width can be used to form a U-shaped support post. Alternative rib arrangements can also be used to form T-shaped, H-shaped, or other posts.

In some embodiments of the ribbed panel, it may be preferred for the panel and the bamboo rods (the “ribs”) to be made of different materials. For example, the two-layer panel may be made of softwood or hardwood, while the ribs are made of giant bamboo. The reverse may also be preferred. Likewise, the panel may be single-layered, double-layered, triple-layered, or more. FIG. 28 also shows an embodiment where the panel is triple-layered. As shown in FIG. 28, another bamboo layer can be applied to form a triple-layered ribbed panel 64. The triple-layered plate 64 preferably comprises at least one layer constructed from bamboo blanks as the base element. Another layer may include an insulating material or another material such as hardwood. It may be preferred for an outer layer to include hardwood or softwood to aesthetically mimic a more traditional building product.

FIG. 29 schematically illustrates the production of another bamboo element referred to herein as a “honeycomb element” 66 according to the invention. The honeycomb element 66 is produced analogously to the ribbed plate 62. However, in the honeycomb element 66, two parallel plates are separated by at least two ribs arranged orthogonal to the plates. In one embodiment of the honeycomb element 68, the plates are triple-layered plates. Preferably, the plates and ribs define a cavity 70. In some embodiments of the invention, the cavity 70 is filled with air. In other embodiments of the invention, the cavity 70 is filled with an insulating material. In some embodiments, the cavity 70 is additionally sealed by plates covering its two ends. In such embodiments, the sealed cavity 70 may have a lower air pressure than the ambient air. This is surprisingly effective in thermal and sound insulation.

As described above in FIG. 28, both the plates and ribs of the honeycomb elements 66, 68 may be made of giant bamboo. Alternatively, the plates and ribs may be made of different materials, with at least a portion of one of the plates or ribs being made of giant bamboo. It may be preferred for one or both of the plates or ribs to combine layers of different materials, such as insulating layers and aesthetic layers. The number of layers can be determined by a person skilled in the art according to the desired application.

It has been surprisingly found that by providing ribs either as parts of ribbed plates or honeycomb elements, components of extraordinarily high strength and excellent aesthetic, thermal, and acoustic properties can be produced.

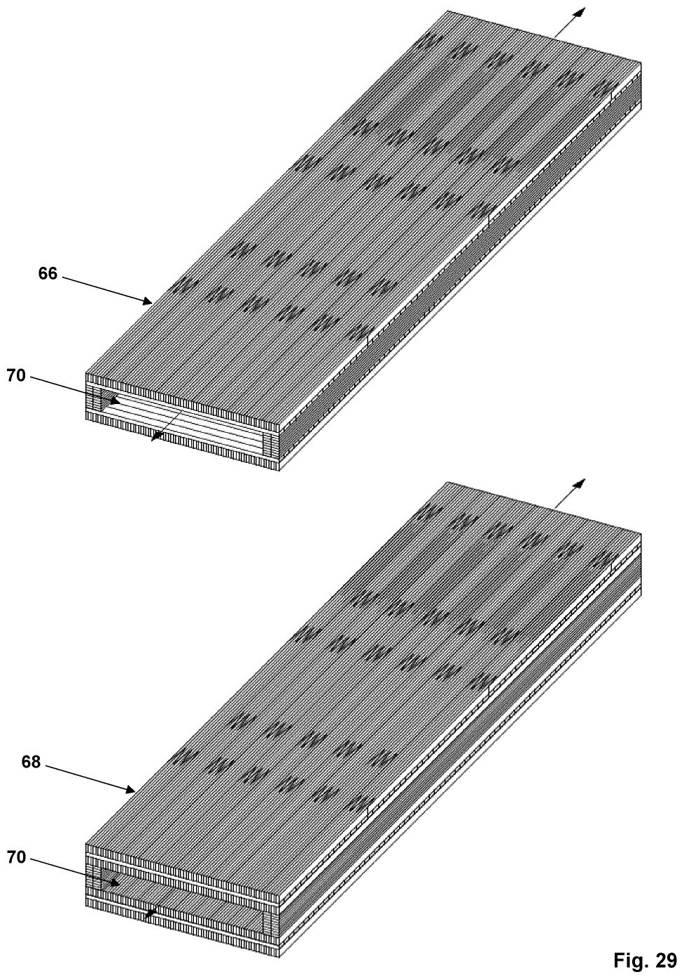

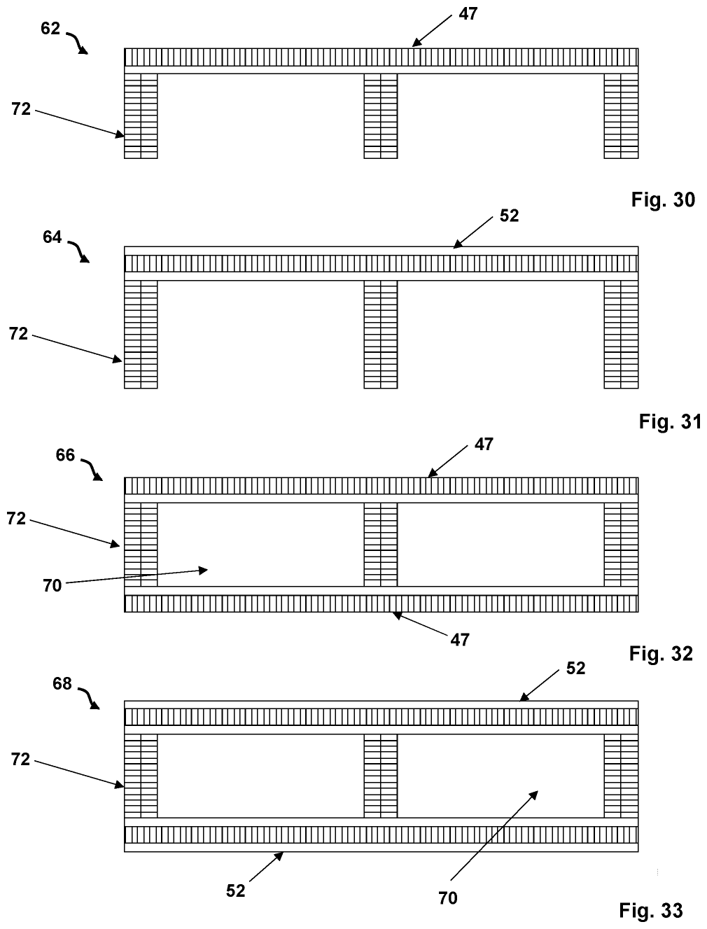

FIGS. 30-33 show further preferred embodiments of building elements made of giant bamboo, comprising ribs 72. The type and number of ribs depicted, as well as the type and number of plates or layers, are of course exemplary only. One skilled in the art understands that various combinations of blanks A/B can be combined to form different, unillustrated ribbed plates and honeycomb elements.

FIG. 30 schematically illustrates a cross-section of a ribbed plate 62 comprising a two-layer bamboo plate 47 and three bamboo rods A as ribs 72. This ribbed plate is particularly suitable for use in the walls and ceilings of a building. The ribbed plate can also be made with at least two ribs 72.

FIG. 31 schematically illustrates a cross-section of another ribbed plate 64 comprising a three-layer bamboo plate 52 and three bamboo rods A as ribs 72. This ribbed plate is also particularly suitable for use in the walls and ceilings of a building. The ribbed plate can also be made with at least two ribs 72.

FIG. 32 schematically shows a cross-section of a honeycomb element 66 comprising two parallel two-layer bamboo plates 47 and three bamboo rods as ribs 72. This honeycomb element 66 is particularly suitable for use in the ceilings of a building. The cavity of the box element allows for surprisingly successful combination of high flexural strength with high degrees of thermal and acoustic insulation and low weight. The use of such elements therefore enables the construction of buildings that are visually appealing and at the same time more sustainable in terms of the materials used and heating requirements. The honeycomb element can also be made with at least two ribs 72.

FIG. 33 schematically shows a cross-section of a honeycomb element 68 comprising two parallel three-layer bamboo plates 52 and three bamboo rods as ribs 72. This honeycomb element is also particularly suitable for use in the ceilings of a building. The honeycomb element can also be made with at least two ribs 72.

One skilled in the art knows that the number of layers in the various components, the number of ribs, the number of plates, and the presence of additional materials can be selected without departing from the spirit of the invention.

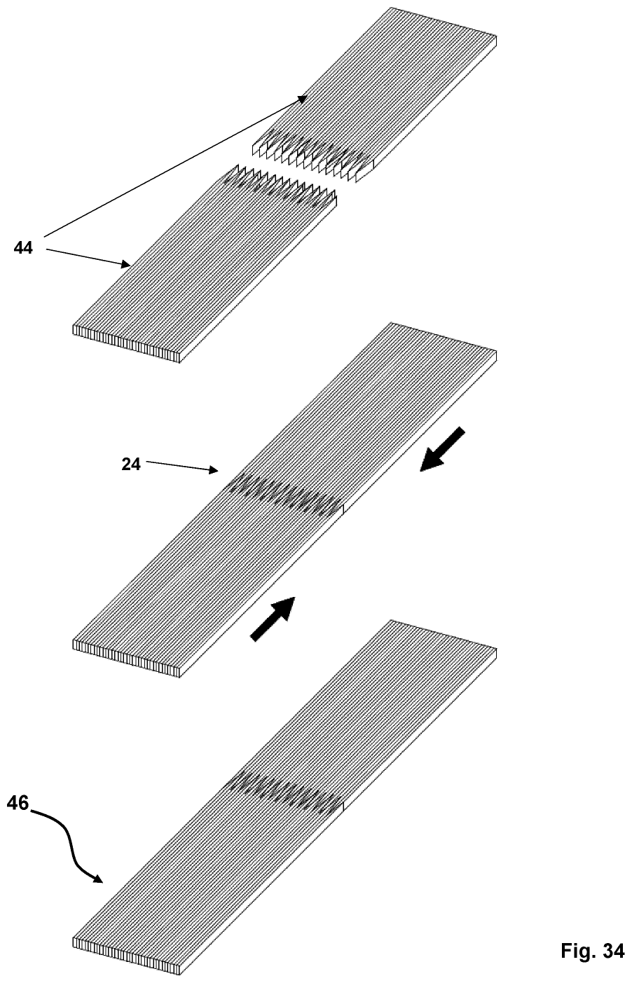

FIGS. 34-38 show in further detail the production and construction of several bamboo plates including cross-laminated bamboo panels (CLB panels) and sandwich panels. The following embodiments of plates can of course be combined with ribs to form variations of the ribbed plates shown in FIGS. 28-33.

FIG. 34 shows how several bamboo layers 44 made from blanks A can be connected to form endless blanks A 46. Here, finger joints 24 are preferably applied using an adhesive and a pressing force 22. The endless bamboo layers 46 have a preferred length between 2000-30000 mm.

The (optionally endless) bamboo layers made from blanks A are also considered preferred final products according to the invention. The finishing processes mentioned above can also be applied here as well as an improvement process (e.g., calibration by grinding, planing, and milling) for the edges of the bamboo layers.

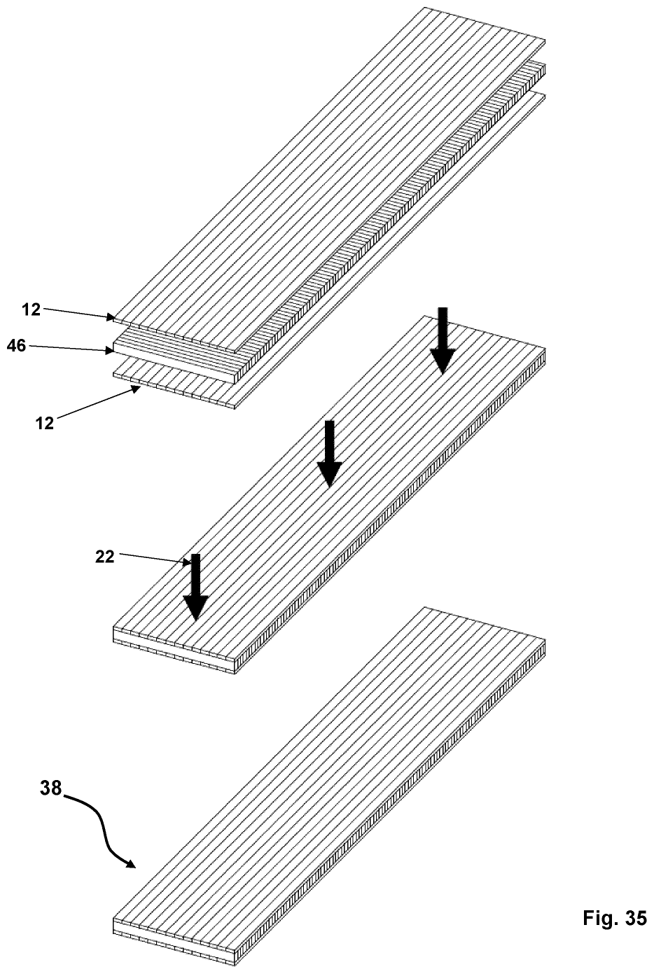

Cross-laminated bamboo panels (CLB or CLP) can optionally be made only with layers of blanks of type A or layers of blanks of type B. Although a single type of bamboo layer can be used to form a cross-laminated bamboo panel, it is preferred for bamboo layers A and B to be combined, as shown in the example of FIG. 35.

FIG. 35 shows a method for producing a cross-laminated bamboo panel 38 according to a first preferred embodiment. In this embodiment, at least three bamboo layers 12, 46, 12 are glued and pressed together in stacked form. The first and third bamboo layers 12 can be made from blanks of type B, while the second bamboo layer 46 is a bamboo layer made from blanks of type A.

Conversely, the first and third bamboo layers 12 can also be of type blank A, while the second bamboo layer 46 is a bamboo layer of blank type B. The second bamboo layer is located between the first and third bamboo layers. It is also preferred for a fiber direction of the bamboo blanks of each bamboo layer to be perpendicular to a fiber direction of the bamboo blanks of an adjacent bamboo layer. In this case, the fiber direction of the second bamboo layer is arranged perpendicular to the fiber direction of the first and third bamboo layers, resulting in a CLB panel 38.

The three bamboo layers are glued and pressed together by an adhesive and a pressing force 22. It is particularly preferred to apply a pressing pressure between 0.15-1.5 N/mm² for this purpose. The pressing process can be carried out in a suitable pressing device. The resulting CLB panel 38 has a preferred width between 1000-5000 mm, a preferred thickness between 30-300 mm, and a preferred length between 3000-18000 mm.

The CLB panel 38 is a cross-laminated bamboo panel according to the invention. It can be considered as a final product or further processed into endless CLB panels 52 through finger joints.

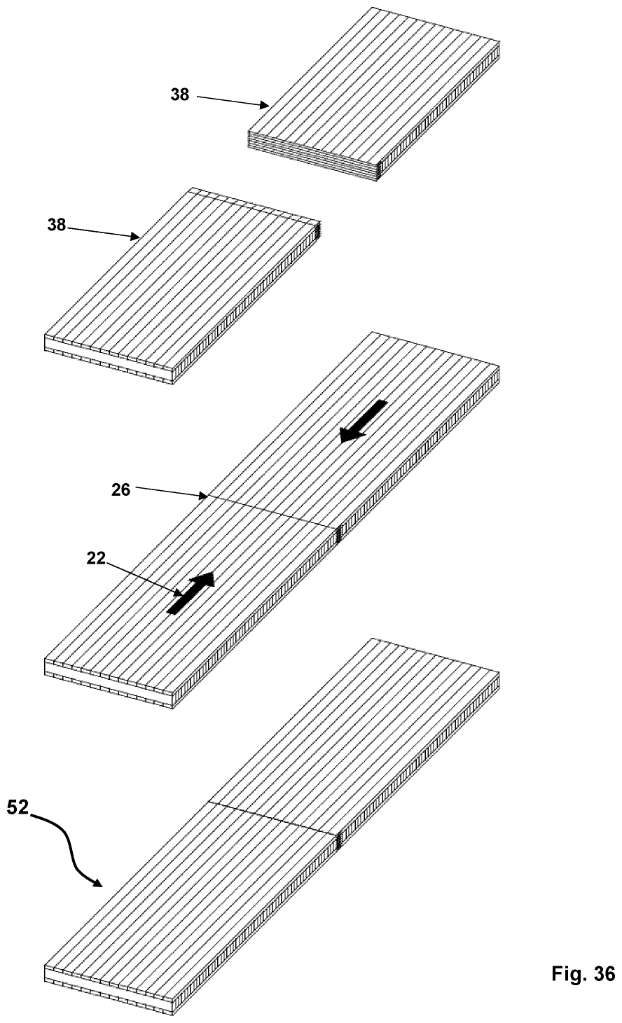

FIG. 36 shows a method for connecting two or more CLB panels 38. For this purpose, finger joints or general finger joints 26 are preferably used in the transverse direction of the panel. These finger joints comprise a deep zigzag pattern at the ends of the individual CLB panels to be connected to each other. The deep grooves of the zigzag pattern preferably have a length of 10-40 mm. In this preferred embodiment, the grooves and corresponding protrusions run along the edge of the CLB panel substantially orthogonal to the fiber direction of the bamboo rods of the first and third layers. The resulting endless CLB panels 52 have a preferred length between 2000-30000 mm, especially 10000-18000 mm.

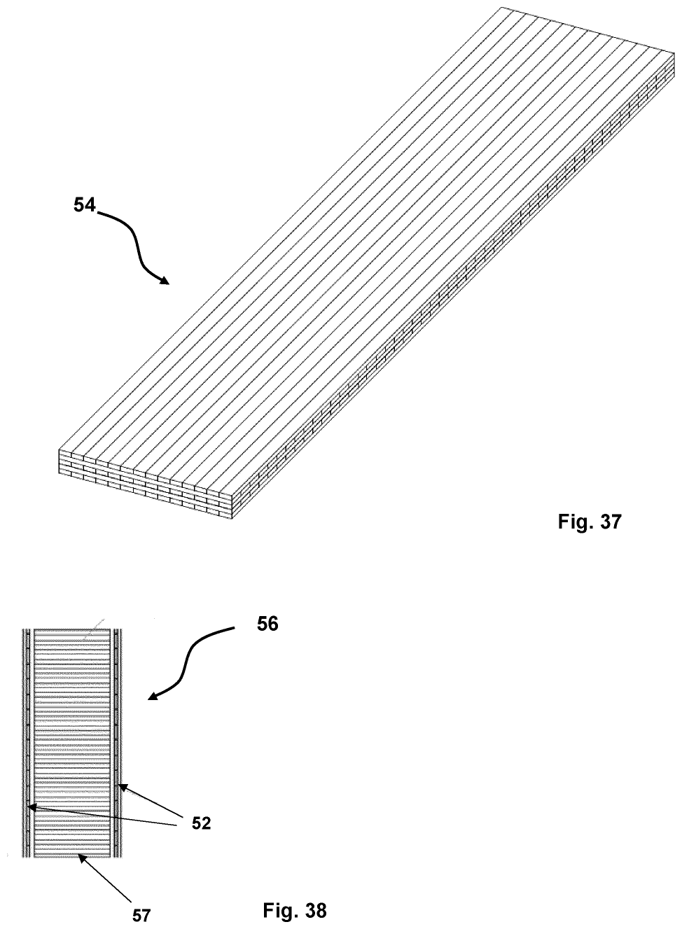

FIG. 37 shows another preferred embodiment of the invention, where a CLB panel 54 is provided with five bamboo layers. In this embodiment, all five bamboo layers are of the same type, namely bamboo layer B 12. The fiber directions alternate between adjacent bamboo layers, so that the fiber directions of two directly adjacent bamboo layers are preferably always orthogonal to each other. Alternative embodiments of the invention include CLB panels with a greater number of bamboo layers. For example, CLB panels with seven, nine, and eleven bamboo layers can be created. It is particularly preferred for a CLB panel to have an odd number of bamboo layers. The types can be combined if necessary. Alternatively, a CLB panel may contain only layers of the same type.

FIG. 38 shows another preferred embodiment of the invention, where a CLB panel 56 includes an insulation layer 58. In this embodiment, the insulation layer 58 is formed of bamboo foam, preferably made from bamboo residues from a previous process step. The outer layers themselves can be a CLB panel. In this case, the CLB panels 52 according to FIG. 36 or 37 are applied.

Both the three-layer CLB panel of FIG. 35, the endless three-layer CLB panel of FIG. 36, the five-layer CLB panel of FIG. 37, and the CLB panel comprising the insulation layer of FIG. 38 are considered engineered wood building elements according to the invention. All can serve as final products and are suitable for load-bearing purposes.

It is preferred to subject these final products to a finishing process. The edges or openings (e.g., for windows, doors) of the engineered wood building elements are preferably calibrated and/or smoothed by sawing or milling. The cross-laminated bamboo elements can also be sanded and surface treated.

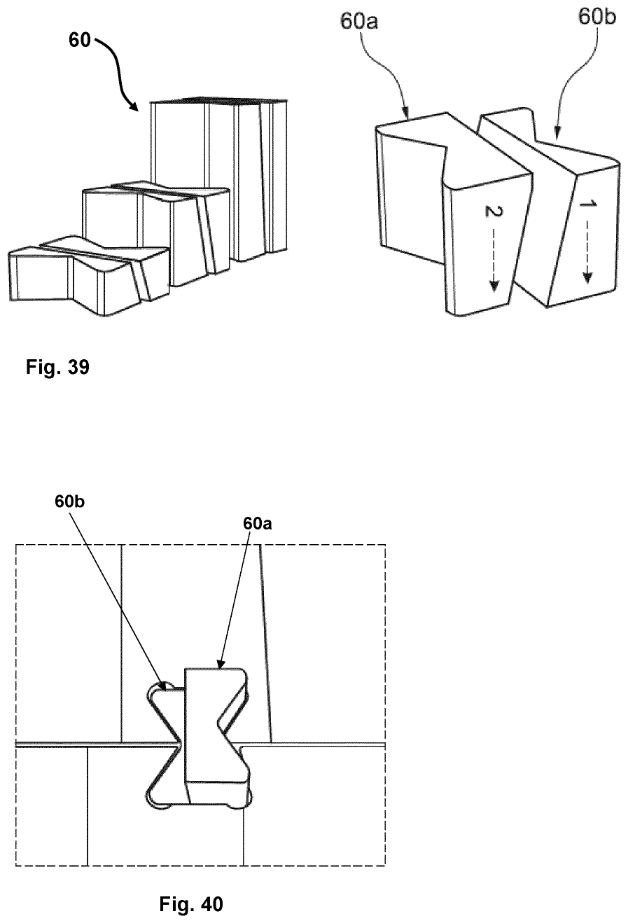

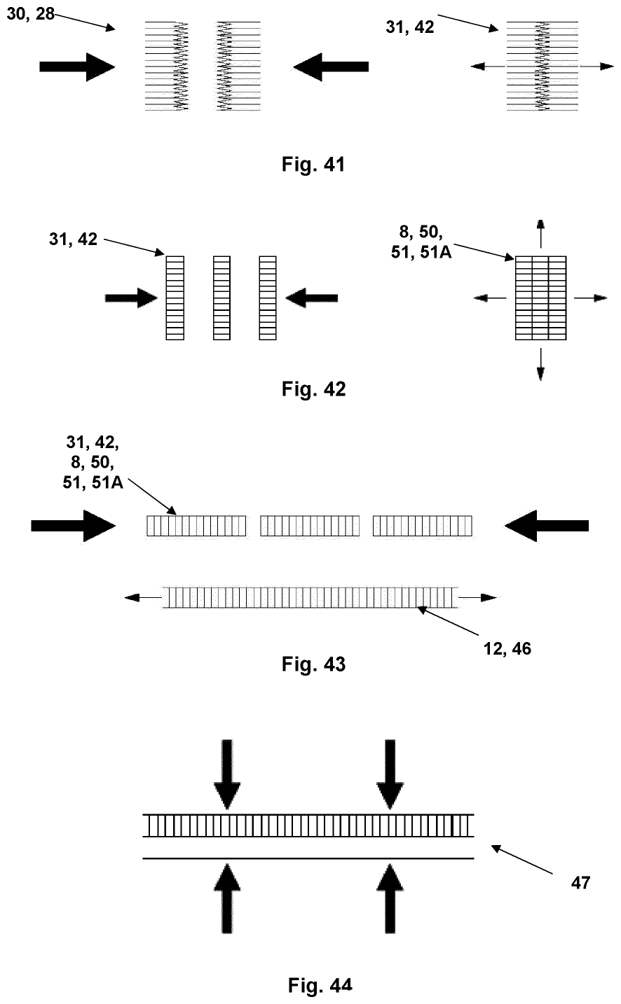

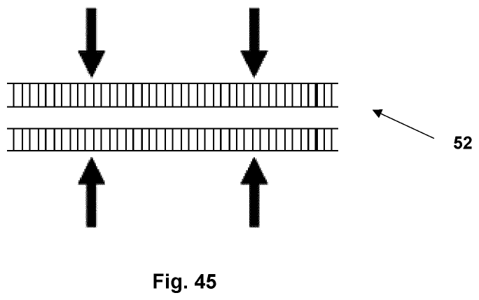

In all embodiments, one or more wood-to-wood connectors 60 can be used instead of the finger connection, as shown in FIGS. 39 and 40. The wood-to-wood connectors take into account the fact that the bamboo elements to be created are difficult to connect with metal screws due to their hardness. The wood-to-wood connectors are an additional element, preferably made of bamboo wood, which has a particularly advantageous shape. The additional element preferably has a so-called finger shape, which, like the fingers and/or grooves of the finger joints, provides tensile and flexural strength. Preferably, the finger shape comprises several acute-angled projections. It is particularly preferred for the wood-to-wood connections to comprise two opposing lower parts 60a and 60b. The wood-to-wood connection is frictionally engaged at the ends of the parts to be joined together, optionally manually inserted with heavy hammering, and remains in position thereafter. Preferably, the connectors and the recesses provided for them are machined by milling and sawing to form a complementary precise shape, creating a force-fit connection. The use of adhesive is optional but may be preferred.

The preferred engineered wood elements according to the invention can be prefabricated and transported to construction sites within Europe as special transports, where they can be screwed together to form complete wall-ceiling-roof units. For overseas projects, it is preferred to reduce the maximum dimensions to container dimensions. The elements can then also be screwed together to form complete wall-ceiling-roof units at overseas construction sites.

These assembly works are very time-consuming and require a large number of screws. An X-shaped insert (X-fix) as a self-tightening, force-locking wood-to-wood connection system can greatly simplify the assembly process. The X-fix connection system can withstand approximately three times the load compared to screw systems.

The X-fix connection system preferably consists of two finger-shaped, oppositely tapered wedges made of birch veneer plywood, which can be hammered into finger-shaped connection grooves milled into the CLB panels. This way, the components are firmly and force-lockingly connected to each other.

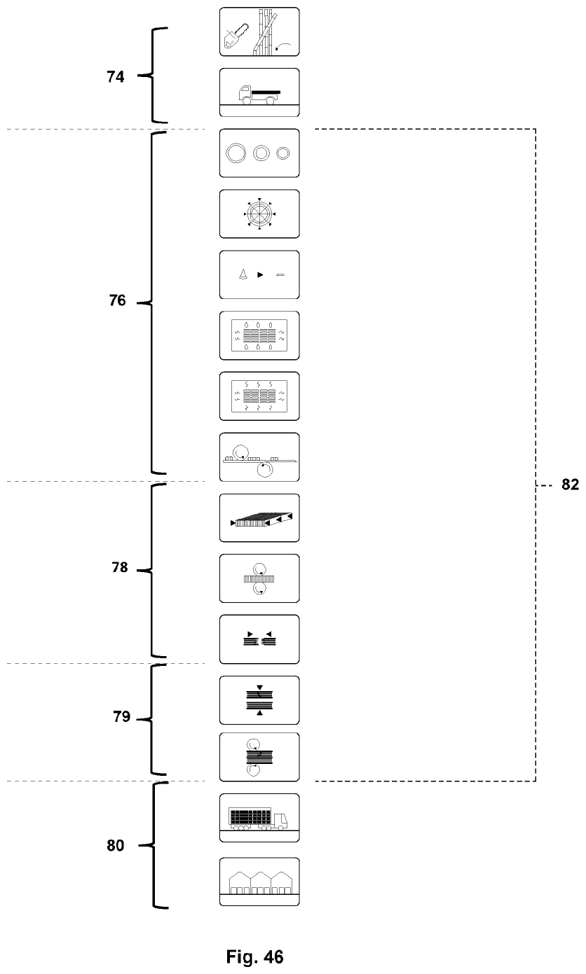

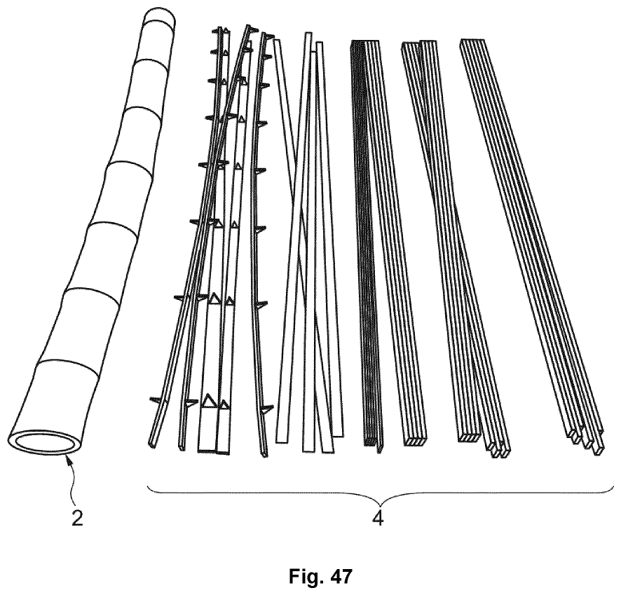

FIG. 46 schematically illustrates an exemplary method for processing giant bamboo to produce the bamboo elements described here. A first phase 74 of the process takes place on a bamboo plantation and preferably involves fertilizing, watering, felling, and/or cutting the bamboo.

Preferably, the bamboo canes are cut to a convenient length of up to 7-10 meters, facilitating transport and handling. The bamboo canes are preferably at least 3 years old at the time of harvest. The lowermost 7-10 meters of the bamboo tube are preferably harvested, as this part can be used to produce uniform bamboo lamellae. The bamboo preferably belongs to species such as Dendrocalamus asper, Dendrocalamus Giganteus, Phylostachys edulis, or Guadua angustofolia. Phylostachys edulis is particularly preferred. It is disclosed non-exclusively that giant bamboos are preferably grown and harvested in Central or South America, preferably in Brazil, particularly preferably in the São Paulo province.

A second phase 76 of the process concerns the production of bamboo lamellae and preferably takes place in one or more production facilities. The harvested bamboo canes are transported to a sorting station and preferably cut to 1-3 meters there. The bamboo canes are optionally sorted according to criteria such as diameter and wall thickness. The bamboo canes are preferably sorted automatically with scanners to maintain production capacity. The bamboo canes can then be split into 6-20 splits. The splits are preferably double-planed, with the outer skin preferably removed. The bamboo lamellae are then preferably steamed at temperatures of up to 200° C., preferably between 80° C.-120° C., and dried at temperatures of up to 100° C., preferably between 70° C.-80° C. Subsequently, the bamboo raw slats are preferably four-sided planed. Alternatively, this could involve one-sided, two-sided, three-sided, or four-sided planing. The finished bamboo lamellae are preferably automatically sorted with scanners based on criteria such as beetle infestation, dimensional accuracy, parallelism, perpendicularity.

A third phase 78 of the process concerns the production of bamboo blanks 28, 30, endless bamboo blanks 31, 42, and other bamboo elements. In this phase, multiple bamboo lamellae are arranged fiber-parallel next to each other and glued together under pressure. After hardening, they are calibrated. This process creates bamboo blanks as basic elements, which are then processed into endless bamboo blanks 31, 42 through finger joints. The bamboo blanks 28, 30, 31, 42 can serve as end products or be processed into more complex elements. The end products are preferably calibrated by planing, milling, and/or surface treatment, etc.

In a fourth phase 79, bars with offset finger joints are made from at least two endless blanks. The finished end products are then packaged and transported or preferably further processed. In this phase, multiple bamboo blanks are arranged fiber-parallel next to each other, glued together under pressure, and calibrated after hardening.

A fifth phase 80 of the process concerns the optional use of bamboo elements in a construction process and/or further processing into even more complex elements.

FIG. 47 illustrates the harvested bamboo canes, the splits, the pre-planed bamboo lamellae, the dried bamboo lamellae, the planed bamboo lamellae, the sorted and surface-treated bamboo lamellae, and blanks.

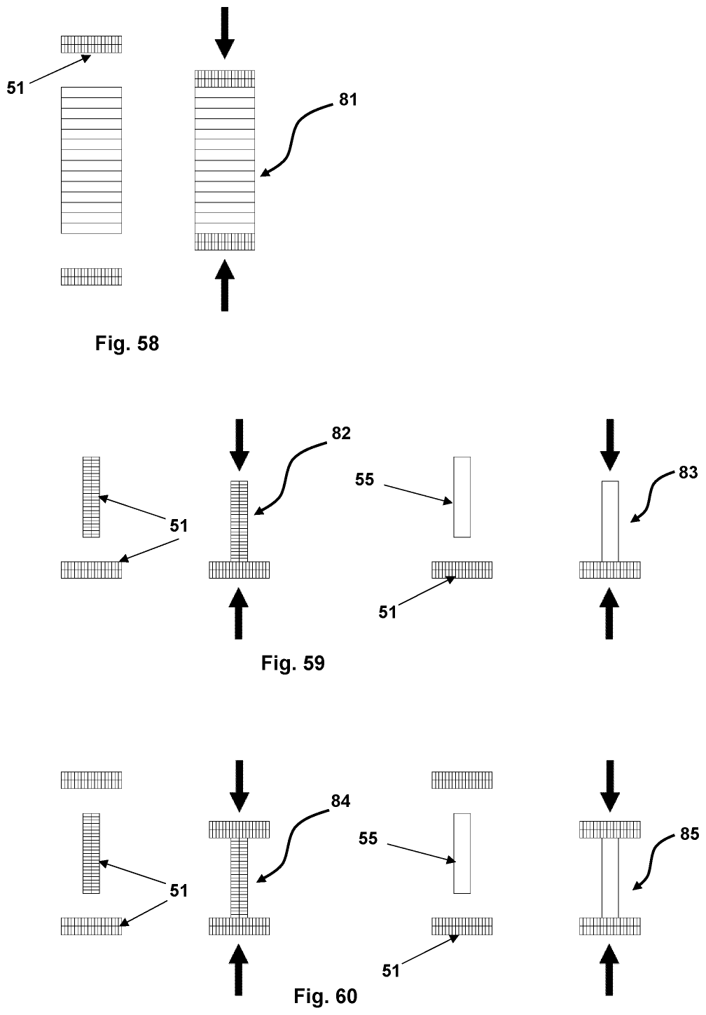

FIG. 58 schematically shows a laminated beam made of bamboo rods and BSH softwood.

Bamboo rods 51 are glued to laminated timber beams made of softwood on the narrow sides to form beams FIG. 58. The resulting laminated beam 81 has a preferred width between 60-200 mm, a preferred thickness between 100-400 mm, and a preferred length between 3000-18000 mm.

FIG. 59 schematically shows a T-beam made of bamboo rods 51. In this case, two bamboo rods 51 are glued together to form T-beams (FIG. 59). One bamboo rod 51 forms the bottom flange, and one bamboo rod 51 forms a web. Surprisingly, the load-bearing capacity of the beams 59 is higher than pure glulam with the same height. Optionally, a bamboo rod 51 and a laminated veneer lumber beam (LVL) 56 are glued together to form T-beams (FIG. 59). A bamboo rod 51 forms the bottom flange, and a laminated veneer lumber beam (LVL) 55 forms a web. Surprisingly, the load-bearing capacity of the beams 59 is higher than pure glulam with the same height. The resulting T-beam 82 and 83 has a preferred width between 60-200 mm, a preferred 5 thickness between 100-1000 mm, and a preferred length between 3000-18000 mm.

FIG. 60 schematically shows a double T-beam made of bamboo rods. In this case, three bamboo rods 51 are glued together to form double T-beams (FIG. 60). One bamboo rod 51 forms the bottom flange, one bamboo rod 51 forms the web, and one bamboo rod 51 forms the 10 top flange. Optionally, two bamboo rods 51 and one laminated veneer lumber beam (LVL) 56 are glued together to form double T-beams (FIG. 60). One bamboo rod 51 forms the bottom flange, one laminated veneer lumber beam (LVL) 55 forms the web, and one bamboo rod 51 forms the top flange. The resulting double T-beam 84 and 85 has a preferred width between 60-200 mm, a preferred thickness between 150-1000 mm, and a preferred length between 3000-18000 mm.

FIG. 61 schematically shows a ceiling element made of T-beams (FIG. 59) and wood-based panels 58. Ceiling elements are constructed from T-beams (FIG. 59) and chipboard, plywood, or three-layer panels 58 (FIG. 61). Chipboard, plywood, or three-layer panels 59 are connected to the bottom flange 51 with glue, nails, staples, screws. The resulting ceiling element from T-beams 86 has a preferred width between 600-4000 mm, a preferred thickness between 100-1000 mm, and a preferred length between 3000-18000 mm.

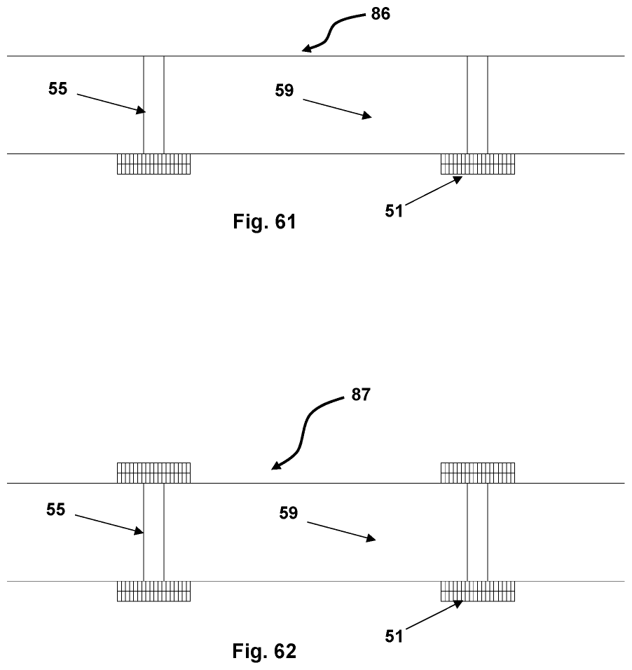

FIG. 62 schematically shows a ceiling element made of double T-beams (FIG. 60) and wood-based panels 58. Ceiling elements are constructed from double T-beams (FIG. 60) and chipboard, plywood, or three-layer panels 58 (FIG. 62). Chipboard, plywood, or three-layer panels 58 are connected to the bottom flange 51 with glue, nails, staples, screws. The resulting ceiling element from double T-beams 87 has a preferred width between 600-4000 mm, a preferred thickness between 150-1000 mm, and a preferred length between 3000-18000 mm.

Various tests were conducted to investigate the material properties of bamboo elements according to the invention. The tests comprised two groups, the first consisting of bamboo lamellae from Giant Bamboo (“Dendrocalamus giganteus”) and the second consisting of bamboo lamellae from Moso Bamboo (“Phylostachys edulis”). The sample bamboo elements from Giant Bamboo (or Dendrocalamus giganteus) had dimensions of 40×100×1900 mm (bamboo rods) and 80×80×80 mm. Sample bamboo rods from Moso Bamboo (or Phylostachys edulis), on the other hand, had dimensions of 42×102×1900 mm. For surface bonding, a polyurethane adhesive and for finger bonding, a gap-filling melamine resin adhesive were used. In accordance with EN 408, the parameters bulk density, bending strength, as well as shear and compressive strength of the sample bamboo elements were determined. The bending strength of the finger joints was determined according to the specifications of EN 14080 by means of flat-edge bending tests. For this purpose, the sample bamboo elements were installed as four-point bending tests on the TIRA 500 kN universal testing machine (PIVN 16001). Deformations in the center of the beam were additionally documented using inductive displacement sensors. The compression tests on the test specimens with dimensions of 80×80×80 mm were carried out on an Amsler 5000 kN machine (PIVN 15002). A calculation of the characteristic values was carried out according to the specifications of EN 14358. The following Table 1 summarizes the results briefly.

Summary of Test Results for Giant Bamboo and Moso Bamboo

| | | | Result | Characteristic |
|---|---|---|---|---|
| Test specimen | | Parameters | (Mean) | Value |
| Giant Bamboo | Bending edge- | f_{m,ew} [N/mm²] | 124.3 | 97.3 |
| | on | | | |
| | Bending flat- | f_{m,fw} [N/mm²] | 175.4 | 151.3 |
| | wise | | | |
| | Bending finger | f_{m,fj} [N/mm²] | 70.6 | 60.0 |
| | joint | | | |
| | Parallel shear | f_{v,0} [N/mm²] | 5.1 | 4.0 |
| | Parallel | fc_{,0} [N/mm²] | 83.6 | 75.3 |
| | compression | | | |
| | Flexural | E_{0,mean} | 26636 | 25228 |
| | modulus edge- | [N/mm²] | | |
| | on | | | |
| | Flexural | E_{c,0} [N/mm²] | 7683 | 7424 |
| | modulus | | | |
| | parallel | | | |
| | compression | | | |
| | Bulk density | ρ [kg/m³] | 834 | 824 |
| Moso bamboo | Bending edge- | f_{m,ew} [N/mm²] | 121.9 | 104.1 |
| | on | | | |
| | Parallel shear | f_{v,0} [N/mm²] | 5.2 | 4.4 |
| | Flexural | E_{0,mean} | 14142 | 13994 |
| | modulus edge- | [N/mm²] | | |
| | on | | | |

The difference between the characteristic edge-on bending strength and the flat-wise bending strength demonstrates a significant volume effect or influence of the orientation of the bamboo slats' fibers. Furthermore, it is evident that the various blanks, when Joined together, contribute synergistically to the overall strength of the bamboo rod. The experiments and results are further illustrated below.

In the compression tests on bamboo elements made of Giant Bamboo (Dendrocalamus giganteus), the bulk density was determined to be 824 kg/mm³ assuming a normal distribution. The characteristic value of the compression strength was approximately 75 N/mm², and the compression modulus was around 7400 N/mm². The compression modulus was limited by transverse shear failure of the adhesive joints. The results of the compression tests on bamboo elements made of Giant Bamboo with dimensions of 80×80×80 mm are detailed in the following Table 2.

TABLE 2
Results and Statistical Analysis of Compression
Tests for Cubic Bamboo Elements from Giant Bamboo

| | | K_{m, global} | b, h, l | | E_{m, c, 0} | |
|---|---|---|---|---|---|---|
| Probe ID | Fₘₐₓ [N] | [N/mm] | [mm] | fc_{, 0} [N/mm²] | [N/mm²] | ρ [kg/m³] |
| 1 | 557917 | 638720 | 80 | 87.17 | 7984 | 824 |
| 2 | 537014 | 638437 | 80 | 83.91 | 7980 | 832 |
| 3 | 532939 | 441383 | 80 | 83.27 | 5517 | 836 |
| 4 | 554696 | 636300 | 80 | 86.67 | 7954 | 834 |
| 5 | 516070 | 604358 | 80 | 80.64 | 7554 | 812 |
| 6 | 526755 | 728697 | 80 | 82.31 | 9109 | 845 |
| 7 | 522463 | 549886 | 80 | 81.63 | 6874 | 841 |
| 8 | 571831 | 709403 | 80 | 89.35 | 8868 | 848 |
| 9 | 513086 | 514219 | 80 | 80.17 | 6428 | 833 |
| 10 | 520740 | 685080 | 80 | 81.37 | 8563 | 832 |

| | | | |
|---|---|---|---|
| Pieces | 10 | 10 | 10 |
| Minimum | 80.17 | 5517 | 812 |
| Maximum | 89.35 | 9109 | 848 |
| Mean Value | 83.65 | 7683 | 834 |
| Standard Deviation | 3.10 | 1126 | 10 |
| COV | 3.7% | 14.6% | 1.2% |
| Quantil Factor kₛ | 2.088 | 0.230 | 0.230 |
| m_{0, 05}, mₘₑₐₙ acc. to EN 14358 | 75.31 | 7424 | 824 |

For sample bamboo rods made of Giant Bamboo (Dendrocalamus giganteus), edge-on and flat-wise bending tests were also conducted. In the edge-on bending test, the strength of the bamboo rods was limited by the occurrence of combined fractures from bending and shear. Partial failure in the tension zone was observed, which then transitioned into sudden shear failure.

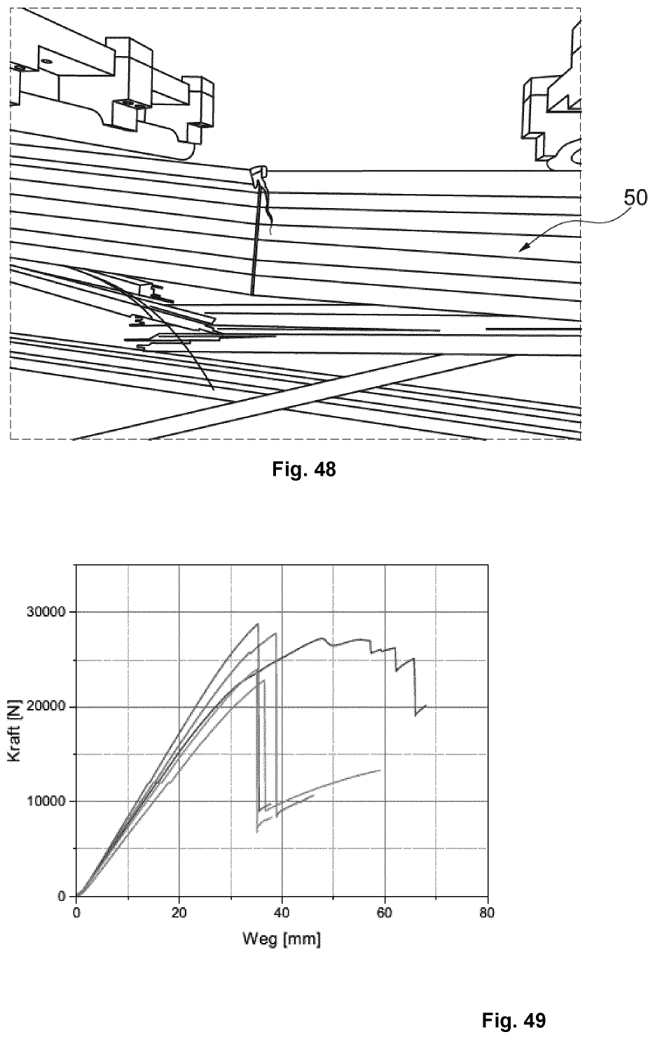

FIG. 48 shows a sample bamboo rod 50 made of Giant Bamboo according to an embodiment of the invention during an edge-on bending test. The bamboo rod 50 was arranged in the edge-on position known to those skilled in the art. The width w of the bamboo rod was arranged vertically, so that the thickness d (the narrower elongated surface) was arranged horizontally. The upper, narrower, elongated surface (thickness d), left free, is referred to as edge-on. A load was applied orthogonally (in the direction of gravity) to the edge-on until the bamboo rod broke. The figure shows a typical failure mode for this bamboo rod.

FIG. 49 graphically depicts the results of the edge-on bending test for several bamboo rods according to the invention. For all bamboo rods, a force of at least 22000 N was required to break the bamboo rod. For some tested bamboo rods, the minimum force for fracture was at least 32800 N.

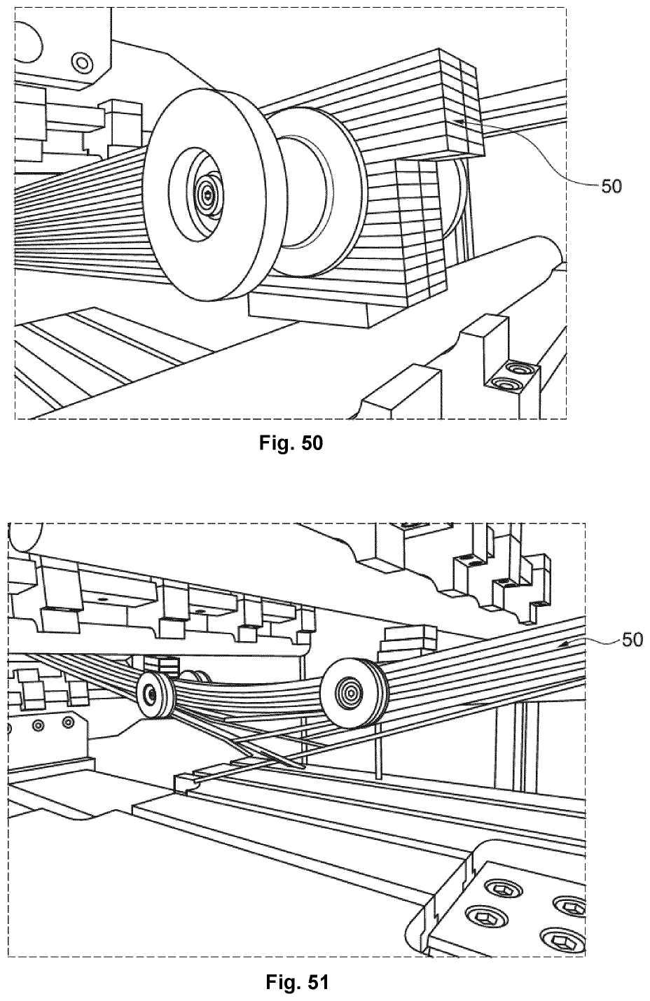

FIGS. 50-51 show a bamboo rod 50 according to an embodiment of the invention during another edge-on bending test with shear failure testing. The displacement of the various layers of the bamboo rod against each other was measured. The results are summarized quantitatively in Table 3. Table 3 shows that from the experimental data, an average shear strength fv of 3.71 MPa was calculated. This is a surprisingly high value and exceeds that of commonly used woods.

TABLE 3
Quantitative Results of Edge-on Bending Tests for Giant Bamboo Rods

| Probe | Fₘₐₓ | K_{m, global} | K_{m, local} | b | h | l₁ | fₘ | fᵥ | E_{m, g} | E_{m, l} |
|---|---|---|---|---|---|---|---|---|---|---|
| ID | [N] | [N/mm] | [N/mm] | [mm] | [mm] | [mm] | [N/mm²] | [N/mm²] | [N/mm²] | [N/mm²] |
| 1 | 27238 | 741 | 8838 | 40 | 100 | 500 | 122.57 | 5.11 | 23004 | 24858 |
| 2 | 27781 | 754 | 9179 | 40 | 100 | 500 | 125.01 | 5.21 | 23418 | 25817 |
| 3 | 28815 | 828 | 10254 | 40 | 100 | 500 | 129.67 | 5.40 | 25711 | 28840 |
| 4 | 23958 | 745 | 8503 | 40 | 100 | 500 | 107.81 | 4.49 | 23130 | 23914 |
| 5 | 22853 | 669 | 12102 | 40 | 100 | 500 | 102.84 | 4.28 | 20765 | 34037 |
| 6 | 6329 | 95 | 1279 | 40 | 50 | 400 | 113.92 | | 23526 | 18422 |
| 7 | 8071 | 105 | 2122 | 40 | 50 | 400 | 145.28 | | 25977 | 30564 |
| 8 | 32831 | 769 | | 40 | 100 | | 147.74 | 6.16 | 23877 | |
| 9 | 28621 | 718 | | 40 | 100 | | 128.79 | 5.37 | 22297 | |
| 10 | 24246 | 731 | | 40 | 100 | | 109.11 | 4.55 | 22710 | |
| 11 | 26651 | 742 | | 40 | 100 | | 119.93 | 5.00 | 23033 | |
| 12 | 30885 | 735 | | 40 | 100 | | 138.98 | 5.79 | 22816 | |

| | | | | |
|---|---|---|---|---|
| Pieces | 12 | 10 | 12 | 7 |
| Minimum | 102.84 | 4.28 | 20765 | 18422 |
| Maximum | 147.74 | 6.16 | 25977 | 34037 |
| Mean Value | 124.30 | 5.14 | 23355 | 26636 |
| Standard Deviation | 14.61 | 0.59 | 1399 | 5062 |
| COV | 11.8% | 11.4% | 6.0% | 19.0% |
| Quantil Factor kₛ | 2.029 | 2.088 | 0.209 | 0.278 |
| m_{0, 05}, mₘₑₐₙ acc. to EN 14358 | 97.35 | 4.02 | 23063 | 25228 |

For the aforementioned samples 1-12, all tested bamboo rods have a length L of 1800 mm and a distance a of load application to support of 600 mm (not listed in the above table due to space constraints).

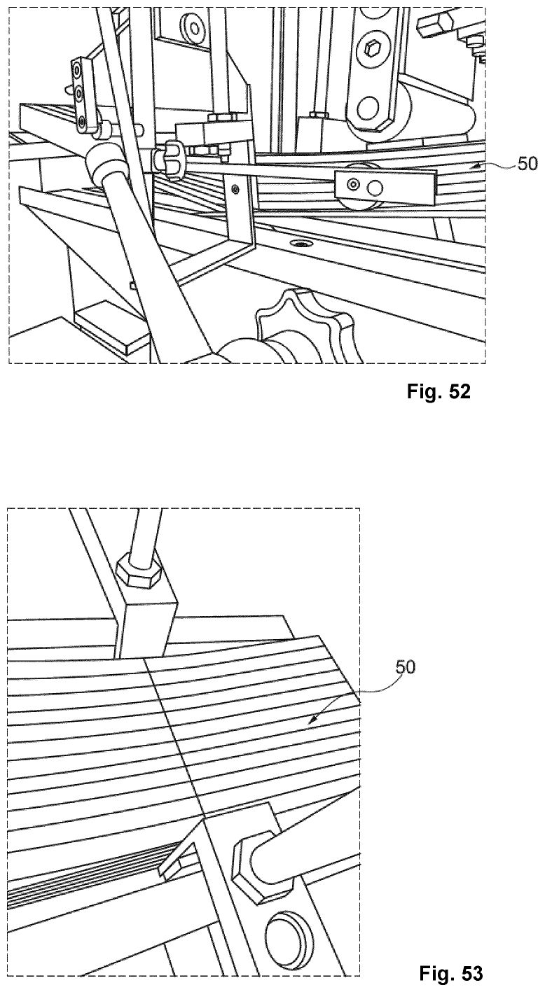

FIGS. 52-53 depict a bamboo rod 50 made of Giant Bamboo (Dendrocalamus giganteus) according to an embodiment of the invention during a flat-wise bending test. The bamboo rod 50 was arranged in the flat-wise position known to those skilled in the art. This means that the width w of the bamboo rod 50 was arranged horizontally, leaving an upper width surface (the flat edge) free. A load was applied orthogonally (in the direction of gravity) to the flat edge until the bamboo rod broke. As evident in the figures, due to the high tensile strengths of the tested bamboo rods, there was increased ductile compressive failure in the bending compression zone.

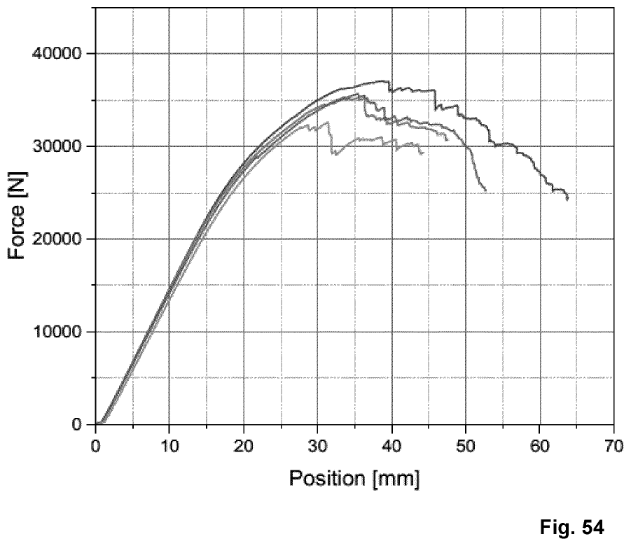

FIG. 54 graphically represents the results of the flat-wise bending test for several bamboo rods according to the invention. For all bamboo rods, a force of at least 32000 N was required to break the bamboo rod. For some bamboo rods, the required force was over 37000 N. These results are quantitatively presented in Table 4. All samples 1-4 from Table 4 had a length L of 800 mm (not listed due to space constraints). The table shows that from the raw data, an average bending strength of 151 N/mm² and an average modulus of elasticity of 23332 N/mm² were calculated.

TABLE 4
Quantitative Results of Flat-wise Bending Tests for Giant Bamboo Rods

| | Fₘₐₓ | K_{m, global} | K_{m, local} | b | h | a | L₁ | fₘ | E_{m, g} | E_{m, l} |
|---|---|---|---|---|---|---|---|---|---|---|
| ID | [N] | [N/mm] | [N/mm] | [mm] | [mm] | [mm] | [mm] | [N/mm²] | [N/mm²] | [N/mm²] |
| 1 | 37047 | 1441 | 23538 | 100 | 40 | 266 | 200 | 184.77 | 24517 | 29349 |
| 2 | 35354 | 1415 | 19826 | 100 | 40 | 266 | 200 | 176.33 | 24069 | 24720 |
| 3 | 35677 | 1350 | 19252 | 100 | 40 | 266 | 200 | 177.94 | 22957 | 24005 |
| 4 | 32582 | 1350 | 21582 | 100 | 40 | 266 | 200 | 162.50 | 22966 | 26910 |

| | | | |
|---|---|---|---|
| Pieces | 4 | 4 | 4 |
| Minimum | 162.50 | 22957 | 24005 |
| Maximum | 184.77 | 24517 | 29349 |
| Mean Value | 175.38 | 23627 | 26246 |
| Standard Deviation | 9.34 | 790 | 2410 |
| COV | 5.3% | 3.3% | 9.2% |
| Quantil Factor kₛ | 2.712 | 0.374 | 0.374 |
| m_{0, 05}, mₘₑₐₙ acc. to EN 14358 | 151.30 | 23332 | 25345 |

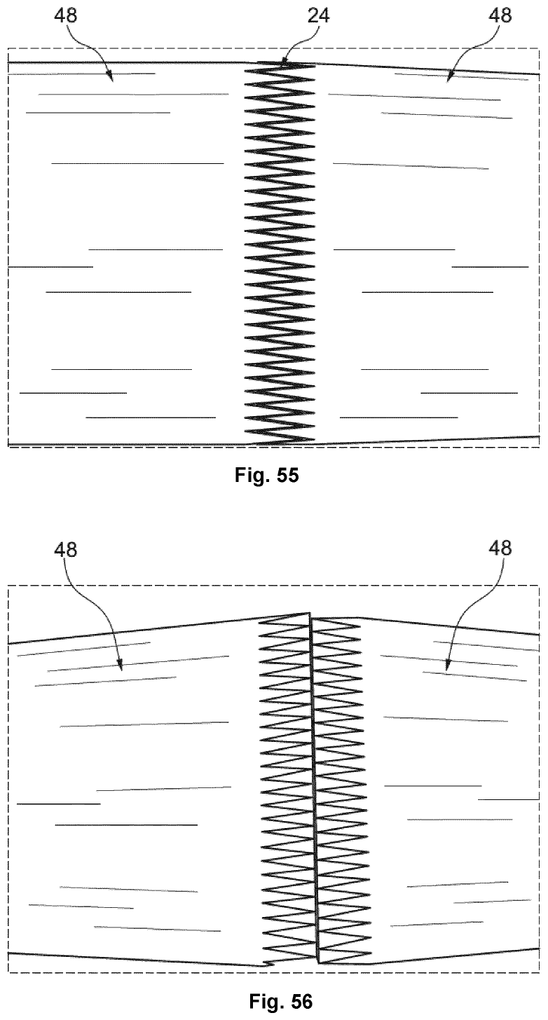

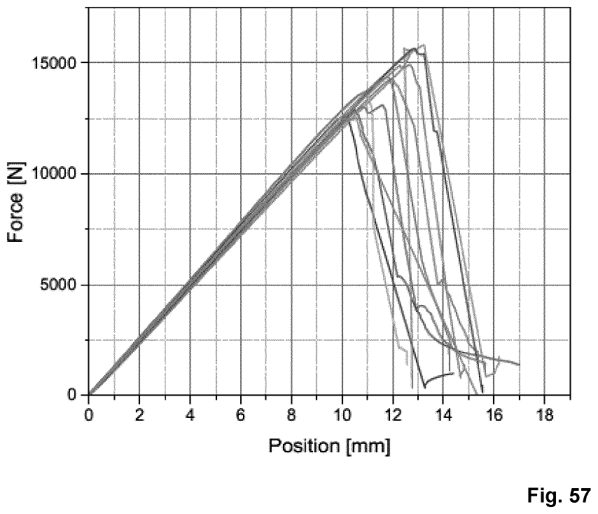

FIGS. 55-56 depict a bamboo rod made of Giant Bamboo (Dendrocalamus giganteus) according to the invention during a dovetail bending test between two bamboo rods 48. The results of testing several bamboo rods 50 according to the invention are shown in FIG. 57. It is evident that for all tested bamboo rods, a force of at least 12535 N was required for the dovetail joint to fail. These results are also quantitatively presented in Table 5. The modulus of elasticity calculated from the experimental raw data is provided in the last column of Table 5. Despite the presence of the finger joints, an average modulus of elasticity of 21380 MPa was determined.

TABLE 5
Quantitative Results of Finger Joint Testing

| Probe | Fₘₐₓ | K_{m, global} | b | h | L | a | L₁ | fₘ | E_{m, g} |
|---|---|---|---|---|---|---|---|---|---|
| ID | [N] | [N/mm] | [mm] | [mm] | [mm] | [mm] | [mm] | [N/mm²] | [N/mm²] |
| 1 | 12642 | 1277 | 100 | 40 | 800 | 266 | 200 | 63.05 | 21718 |
| 2 | 13135 | 1249 | 100 | 40 | 800 | 266 | 200 | 65.51 | 21242 |
| 3 | 12938 | 1245 | 100 | 40 | 800 | 266 | 200 | 64.53 | 21171 |
| 4 | 15691 | 1223 | 100 | 40 | 800 | 266 | 200 | 78.26 | 20807 |
| 5 | 14313 | 1245 | 100 | 40 | 800 | 266 | 200 | 71.93 | 21171 |
| 6 | 15803 | 1283 | 100 | 40 | 800 | 266 | 200 | 78.82 | 21830 |
| 7 | 13721 | 1313 | 100 | 40 | 800 | 266 | 200 | 68.43 | 22329 |
| 8 | 15674 | 1253 | 100 | 40 | 800 | 266 | 200 | 78.18 | 21309 |
| 9 | 14371 | 1292 | 100 | 40 | 800 | 266 | 200 | 71.68 | 21970 |
| 10 | 14950 | 1254 | 100 | 40 | 800 | 266 | 200 | 74.65 | 21331 |
| 11 | 12535 | 1256 | 100 | 40 | 800 | 266 | 200 | 62.52 | 21356 |

| | | |
|---|---|---|
| Pieces | 11 | 11 |
| Minimum | 62.52 | 20806.94 |
| Maximum | 78.82 | 22329.23 |
| Mean Value | 70.63 | 21475.81 |
| Standard Deviation | 6.25 | 436.79 |
| COV | 8.9% | 2.0% |
| Quantil Factor kₛ | 2.056 | 0.219 |
| m_{0, 05}, mₘₑₐₙ acc. to EN 14358 | 59.95 | 21380 |

Bending tests were also conducted on bamboo rods 50 made of Moso bamboo (Phylostachys edulis). The bamboo rods made of Moso Bamboo (Phylostachys edulis) exhibit similar behavior to those made of Giant Bamboo (Dendrocalamus giganteus). The characteristic bending strength value is 108 N/mm², and the shear strength is 4.6 N/mm². The bending modulus of elasticity is approximately 14,000 N/mm². The following Table 6 shows the results and statistical analysis of edge-on bending tests on bamboo rods made of Moso Bamboo (Phylostachys edulis).

TABLE 6
Quantitative Results of Edge-on Bending Tests for Moso Bamboo Rods

| Probe | Fₘₐₓ | K_{m, global} | b | h | l | a | fₘ | fᵥ | E_{m, g} |
|---|---|---|---|---|---|---|---|---|---|
| ID | [N] | [N/mm] | [mm] | [mm] | [mm] | [mm] | [N/mm²] | [N/mm²] | [N/mm²] |
| 1 | 29838 | 526 | 42 | 102 | 1800 | 600 | 122.91 | 5.22 | 14666 |
| 2 | 29505 | 509 | 42 | 102 | 1800 | 600 | 121.54 | 5.17 | 14187 |
| 3 | 29404 | 487 | 42 | 102 | 1800 | 600 | 121.12 | 5.15 | 13571 |

| | | | |
|---|---|---|---|
| Pieces | 3 | 3 | 3 |
| Minimum | 121.12 | 5.15 | 13571 |
| Maximum | 122.91 | 5.22 | 14666 |
| Mean Value | 121.86 | 5.18 | 14142 |
| Standard Deviation | 0.97 | 0.04 | 339 |
| COV | 0.8% | 0.8% | 2.4% |
| Quantil Factor kₛ | 3.148 | 3.148 | 0.436 |
| m_{0, 05}, mₘₑₐₙ acc. to EN 14358 | 104.11 | 4.42 | 13994 |

Table 7 provides a comparison of the mechanical properties of an inventive bamboo rod 48 and 50 with equally dimensioned rods made of Spruce C24, BauBuche, and Steel S235. As the table shows, the properties of bamboo rods 48 and 50 far exceed those of the other types of wood and are comparable to those of steel.

TABLE 7
Quantitative Comparison of Bamboo Rods and Rods
Made of Other Materials

| Property | Bamboo | Spruce C24 | Bau Buche | Steel S235 |
|---|---|---|---|---|
| Bending strength | 125 | 24 | 75 | 235 |
| [MPa] | | | | |
| Shear strength [MPa] | 3.7 | 2.5 | 3.5 | |
| Modulus of elasticity | 21000 | 11000 | 13500 | 210000 |
| [MPa] | | | | |

With a bending strength of 125 MVPa, the bamboo rod's bending strength is at least 5 times higher than that of Spruce C24 (24 MPa) and almost double that of BauBuche (75 Mpa). It is also noteworthy that the bamboo rod's bending strength is more than half that of steel. Furthermore, the modulus of elasticity of the bamboo rod, at 21000 MPa, is almost double that of Spruce C24 and BauBuche (11000 and 13500 MPa, respectively). The bamboo rod according to the invention can therefore safely replace many traditional building materials while offering surprising advantages in terms of sustainability, aesthetics, and earthquake safety. The more complex structural elements according to the invention, such as larger rods, bamboo layers, laminated veneer lumber elements, and ribbed panels, have additionally shown promising mechanical and functional advantages.

Abbreviations

| | |
|---|---|
| Fₘₐₓ (N) | Maximum load (Newtons) |
| K_{m.global} (N/mm) | Spring stiffness (short: stiffness) |
| R² | Coefficient of determination |
| b (mm) | Beam width |
| h (mm) | Beam height |
| 1 (mm) | Beam length |
| a (mm) | Distance from load application |
| | point to support |
| l₁ (mm) | Measurement length of local |
| | modulus of elasticity |
| fₘ (N/mm²) | Flexural strength |
| fᵥ (N/mm²) | Shear strength |
| E_{m,g} (N/mm²) | Modulus of elasticity (global) |
| E_{m,1} (N/mm²) | Modulus of elasticity (local) |
| Minimum | |
| Maximum | |
| Mean Value | Mean value |
| COV | Coefficient of Variation |
| Standard Deviation | Standard deviation |
| m_{0,05,} mₘₑₐₙ acc. | 5% fractile value and mean |
| to EN 1435 | value of a property |

### REFERENCE LIST

2—Bamboo pole
4—Bamboo lamella
6—Bamboo rod B
8—Endless bamboo rod B
10—Bamboo layer B
12—Endless bamboo layer B
14—Star-shaped splitting knife
16—Drying chamber
22—Press force
24—Tongue and groove connection in longitudinal direction
26—General finger joint
28—Blank A
30—Blank B
31—Endless blank B
32—Saw
32A—Circular saw
33—Planing machine
36—Press device
38—CLB panel
42—Endless blank A
44—Bamboo layer A
46—Endless bamboo layer A
47—Two-layer endless bamboo layer
48—Multilayer bamboo rod A
50—Multilayer endless bamboo rod A
51—Multilayer endless bamboo rod A with staggered finger joints
51A—Multilayer endless bamboo rod A with staggered finger joints and wider cross-section
52—Endless CLB panel
54—5-layer endless CLB panel
55—Laminated veneer lumber, LVL
56—Endless CLB panel comprising insulation layer (sandwich element)
57—Insulation layer
58—Bamboo insulation foam
59—Wood-based panels (chipboard and plywood panels)
60—Dovetail-shaped wood-wood connection
60a—First part of wood-wood connection
60b—Second part of wood-wood connection
62—Ribbed two-layer bamboo layer
64—Ribbed multilayer CLB panel
66—Hollow box element with two-layer bamboo layers
68—Hollow box element with multilayer CLB plates
70—Cavity
72—Rib
74—Bamboo plantation
76—Lamella production
78—Production of blanks and endless blanks
79—Production of rods
80—Delivery of blanks and rods to further processing companies, glued timber products, and timber trade
81—Combo beam
82—T-beam
83—Combo T-beam
84—Double T-beam
85—Combo double T-beam
86—Ceiling element with T-beam
87—Ceiling element with double T-beam
d—Thickness
w—Width
l—Length
A—Distance between two consecutive finger joints

1. Bamboo blank (28, 30), especially for the creation of load-bearing structural elements,
characterized in that
the bamboo blank comprises a plurality of bamboo lamellae (4) arranged side by side parallel to the fibers and bonded together by means of an adhesive, wherein the material for the bamboo lamellae (4) originates from a giant bamboo species, the bamboo lamellae (4) are bonded to each other by a pressing pressure of 0.05-1.5 N/mm², and the bamboo lamellae (4) have a thickness (d) of at least 5 mm.

2. Bamboo blank (28, 30) according to claim 1,
characterized in that
the bamboo lamellae (4) have a width (w) between 20-70 mm and an average length (1) between 1000-6000 mm, wherein the bamboo blank (28, 30) is optionally calibrated at right angles.

3. Bamboo blank (31, 42) according to claim 1,
characterized in that
the bamboo blank (31, 42) comprises a first and a second bamboo blank (28, 30) according to one of the preceding claims, wherein the first and the second bamboo blanks (28, 30) each have two end faces,
wherein the first bamboo blank (28, 30) is joined to an end face of the second bamboo blank (28, 30) by means of a tongue and groove connection (24) with a pressing pressure between 0.05-0.3 N/mm².

4. Bamboo blank (28, 30) according to claim 1,
characterized in that
the bamboo lamellae (4) have a wood moisture content of 3-12%.

5. Bamboo blank (28, 30) according to claim 1,
characterized in that
the adhesive is a one-component adhesive comprising polyurethane adhesive (PUR) or the adhesive is a two-component adhesive, optionally comprising melamine-urea-formaldehyde adhesive (MUF).

6. Bamboo rod (6, 8, 48, 50, 51, 51A), especially for use as a load-bearing structural element, comprising a plurality of blanks (28, 30, 31, 42) according to claim 1,
characterized in that
the bamboo blanks (28, 30, 31, 42) have four elongated sides and two end faces, wherein a plurality of blanks (28, 30, 31, 42) are bonded to each other along one or more of their elongated sides by means of an adhesive and a pressing pressure of 0.05-1.5 N/mm².

7. Bamboo rod (6, 8, 48, 50, 51, 51A) according to claim 6,
characterized in that
the bamboo rod (6, 8, 48, 50, 51, 51A) has a width between 20-400 mm, a thickness (d) between 50-400 mm, and a length between 1000-6000 mm.

8. Bamboo rod (6, 8, 48, 50, 51, 51A) according to claim 6,
characterized in that
two or more bamboo blanks are connected to each other by force-fit connections (24), optionally by tongue and groove connections (24), through their end faces, wherein a distance (A) in the longitudinal direction between each two consecutive force-fit connections (24) is at least 0.3 m, and the bamboo rod has a length between 2000-30000 mm.

9. Bamboo rod (6, 8, 48, 50, 51, 51A) according to claim 6,
characterized in that
two or more bamboo blanks (42, 31) comprise tongue and groove connections (24) and are bonded to each other along one or more of their elongated sides by means of an adhesive and a pressing pressure of 0.05-0.3 N/mm²,
wherein the tongue and groove connections (24) of adjacent bamboo blanks (31, 42) are arranged offset from each other in the longitudinal direction.

10. Bamboo layer (10, 12, 44, 46), especially for use as a load-bearing structural element,
characterized in that
the bamboo layer (10, 12, 44, 46) comprises a plurality of bamboo blanks (28, 30, 31, 42) according to claim 1, wherein the bamboo blanks (28, 30, 31, 42) are arranged side by side parallel to the fibers and bonded to each other by means of an adhesive under a pressing pressure of 0.05-1.5 N/mm².

11. Bamboo layer (10, 12, 44, 46) according to claim 10,
characterized in that
the bamboo blanks (28, 30, 31, 42) are connected to each other in the longitudinal direction by force-fit connections (24, 26), optionally by tongue and groove connections (24, 26), wherein a distance (A) between each two consecutive force-fit connections (24, 26) is at least 0.3 m, wherein the bamboo layer (10, 12, 44, 46) has a width of 1000-3000 mm and a length of 2000-30000 mm.

12. Bamboo layer (10, 12, 44, 46) according to claim 10,
characterized in that
the bamboo blanks (28, 30, 31, 42) are bonded to each other along one or more of their elongated sides by means of an adhesive and a pressing pressure of 0.05-0.5 N/mm², wherein the tongue and groove connections (24) of adjacent bamboo blanks (28, 30, 31, 42) are arranged offset from each other in the longitudinal direction.

13. Cross-laminated timber element (38, 47, 52, 54) for use as a load-bearing structural element,
characterized in that
the cross-laminated timber element (38, 52, 54, 56) comprises a plurality of stacked and bonded bamboo layers (10, 12, 44, 46) according to claim 10.

14. Cross-laminated timber element (38, 52, 54) according to claim 13,
characterized in that
a fiber direction of the bamboo lamellae (4) of each bamboo layer (10, 12, 44, 46) is perpendicular to a fiber direction of the bamboo lamellae (4) of an adjacent bamboo layer (10, 12, 44, 46).

15. Cross-laminated timber element (38, 47, 52, 54) according to claim 13,
characterized in that
the bamboo layers (10, 12, 44, 46) are bonded to each other by a pressure of 0.05-0.8 N/mm², wherein the cross-laminated timber element (38, 47, 52, 54) has a thickness of 30-300 mm, a width of 500-5000 mm, and a length of 3000-18000 mm.

16. Cross-laminated timber element (38, 47, 52, 54) according to claim 13,
characterized in that
the cross-laminated timber element (38, 47, 52, 54) has a length of 10000-30000 mm and/or a width of 2000-6000 mm.

17. Cross-laminated timber element (38, 47, 52, 54) according to claim 13,
characterized in that
the adhesive comprises one of the following formaldehyde-free adhesives: amino resins based on glycolaldehyde, a lignin-based adhesive, a tannin-based adhesive, a starch-based adhesive, a soy protein-based adhesive, a furfural-based adhesive, a natural phenol-based adhesive, a polyvinyl acetate-based adhesive, a sugar derivative-based adhesive, an epoxy resin adhesive based on epoxidized plant oils, and/or a hydroxyfunctional polyester-based adhesive.

18. Sandwich panel (56) comprising a cross-laminated timber element (38, 47, 52, 54) according to claim 13,
characterized in that
at least one insulation layer (57) is arranged between two adjacent bamboo layers, wherein the bamboo layers are bamboo layers (10, 12, 44, 46), cross-laminated timber elements (38, 47, 52, 54), or a combination thereof,
wherein the insulation layer (57) comprises a wood foam optionally made from bamboo wood residues, wherein the insulation layer (57) has a density between 40 and 250 kg/m³, wherein the sandwich panel (56) has a width between 600-2000 mm, a thickness between 100-400 mm, and a length between 2000-18000 mm.

19. Ceiling or wall element (62, 64, 66, 68)
characterized in that
the ceiling or wall element (62, 64, 66, 68) comprises a plurality of bamboo layers (10, 12, 44, 46) comprising a plurality of bamboo blanks arranged side by side parallel to the fibres, and/or
cross-laminated timber elements (38, 47, 52, 54) comprising a plurality of stacked and bonded bamboo layers, and/or
a sandwich panel (56) comprising an insulation layer arranged between a bamboo layer, a cross-laminated timber element, or a combination thereof, wherein the plurality of bamboo layers or cross-laminated timber elements are bonded together and define a main plane directed by their bamboo lamellae, wherein the ceiling or wall element (62, 64, 66, 68) comprises one or more ribs (72),
wherein the ribs (72) are optionally arranged parallel to the orientation of the bamboo lamellae of the plurality of bamboo layers or cross-laminated timber elements, wherein the ceiling or wall element (62, 64, 66, 68) has a width between 600-2000 mm, a thickness between 100-400 mm, and a length between 2000-18000 mm.

20.-24. (canceled)

25. Method for producing a bamboo blank (28, 30, 31, 42), a bamboo rod (6, 8, 48, 50, 51, 51A), a beam element (81), a T-beam element (82, 83), a double T-beam element (84, 85), a bamboo layer (10, 12, 44, 46, 47), a cross-laminated timber element (38, 52, 54, 56), a ceiling element (62, 64, 66, 68, 86, 87), and/or a wall element (62, 64, 66, 68),
characterized in that
the method comprises the following steps:
Providing a plurality of bamboo lamellae from a giant bamboo species, wherein the bamboo lamellae have a thickness (d) of at least 5 mm,
gluing the plurality of bamboo lamellae (4) parallel to each other, wherein the gluing is performed under a pressure of 0.05-1.5 N/mm² to produce a bamboo blank,
optionally bonding the bamboo blanks to larger structural elements with tongue and groove connections, bonding parallel to the fiber direction, and/or cross-bonding, optionally with staggered tongue and groove joints.

26. (canceled)

27. (canceled)
